(19) United States
(12) Patent Application Publication
(10) Pub. No.: US 2008/0025733 A1
(43) Pub. Date: Jan. 31, 2008

(54) OPTICAL DIFFERENTIAL PHASE SHIFT KEYING RECEIVERS WITH MULTI-SYMBOL DECISION FEEDBACK-BASED ELECTRO-OPTIC FRONT-END PROCESSING

(75) Inventors: Moshe NAZARATHY, Haifa (IL); Yoav YADIN, Haifa (IL)

Correspondence Address: BROWDY AND NEIMARK, P.L.L.C.;624 NINTH STREET, NW, SUITE 300, WASHINGTON, DC, 20001-5303, US

(73) Assignee: Technion Research & Development Foundation Ltd., Technion City (IL)

(21) Appl. No.: 11/768,049

(22) Filed: Jun. 25, 2007

Related U.S. Application Data
(60) Provisional application No. 60/816,642, filed on Jun. 27, 2006.

(51) Int. Cl. H04B 10/06

(52) U.S. Cl. 398/209

(57) ABSTRACT

Novel differential-phase shift keying optical receivers are taught based on multi-symbol differential phase shift keying detection (DPSK) aided by decision feedback (DF) from the decision bits in earlier symbol intervals. In accordance with the invention, the DF is directed to an optical front-end comprising multiple Delay Interferometers (DIs) with multiple delays T, 2T, . . . , where T is the DPSK symbol duration. In one embodiment, the DF bitstream is applied to electronically switch the polarity of DI outputs prior to additive combination and hard detection. In other embodiments the DF is applied to active phase-shifting electrodes incorporated in the DIs. In additional embodiments the DF is applied to modified DI devices which not of the conventional Mach-Zehnder asymmetric two-arms type, but rather comprise either three or more arms with appropriate couplings, or two arms, one of which comprises a recirculating delay line with delay T. These embodiments comprise pairs of active phase-shifting electrodes to be activated by the DF. In other embodiments the teachings of this invention for DPSK with DF are combined with the amplitude-shift keying (ASK) modulation format, yielding improved Differential Phase Amplitude Shift Keying (DPASK) systems with decision feedback. The resulting receiver structures exhibit improved performance trade-offs between error-rate, transmission distance and bitrate, compared with conventional DPSK systems, yet are simpler to realize than prior art multi-symbol and/or DF-aided optical DPSK systems.

### FIELD OF THE INVENTION

The present invention relates to differential-phase shift keying optical receivers based on multi-symbol differential phase shift keying detection (DPSK) aided by decision feedback (DF) from the decision bits in earlier symbol intervals using optical front-end comprising multiple Delay Interferometers (DIs) with multiple delays.

### BACKGROUND OF THE INVENTION

The Differential Phase Shift Keying (DPSK) optical modulation format has recently emerged as the highest performance scheme for long-haul ultra-high bit-rate transmission.

The review paper [1] presents a tutorial review of the optical DPSK modulation format.

While not widely deployed yet, it is inevitable that the next generation of ultra high capacity, long-haul optical links will be predominantly DPSK-based, in conjunction with Wavelength Division Multiplexing (WDM).

The DPSK signaling format is widespread in electronic wireless communication. The technology and its advantages described in many digital communication textbooks. It consists of differentially phase modulating a carrier wave such that the information is carried in the phase differences. For example, in Binary DPSK (BDPSK), a logical one bit is encoded by changing the phase of the current transmitted symbol by 180 degrees relative to the phase of the previous symbol whereas a logical zero bit is encoded by transmitting the current symbol with the same phase as the previous one. The receiver then recovers the transmitted bits by comparing the phase of the current received symbol with that of the previous one. In quaternary DPSK (Q-DPSK) there is selection out of four values (0, 90, 180, 270 deg) for the phase differences. Each symbol then conveys two bits that set the phase difference between the current symbol and the previous one to one of these four values. Q-DPSK may be viewed as the multiplexing of two BDPSK links in quadrature (0, 180) and (90, 270). Higher-order M-ary DPSK using M possible phase states, may be similarly considered.

The application of the DPSK modulation format to optical transmission resorts to the same principle of operation as its electronic counterpart, but there are some optics-specific details: In the optical transmitter electro-optic modulators are typically used to affect the differential phase change. In the receiver the problem is that conventional photo-detectors are insensitive to the phase of the light, and can detect only its intensity, hence a method must be devised to translate phase differences between successive bits into intensity signals. To this end, the front-end of the optical DPSK receiver uses optical Interferometric structures, such as Mach-Zehnder Delay Interferometers (DI), typically realized as integrated-optic devices, for electro-optic processing of the received signal to generate optical intensity variations indicative of the differential phase-shift between successive symbols.

Some enhancements of the basic DPSK receivers, referred to as multi-symbol DPSK have been introduced in wireless electronic communication, [2], consisting of observing the received signal over a longer (>2 symbols) window, in effect processing not only the phase differences between successive pair of bits but also acting on the phase differences between pairs of bits spaced at 3, 4, . . . symbols apart.

The multi-symbol DPSK wireless detection techniques were recently ported to optical communication under the name “multi-chip DPSK” (“chips” being the regular baud intervals over which the phase stays constant) [3-7]. The usage of multi-symbol optical DPSK detection enhances link performance (improves the trade-off between distance, error-rate and bit-rate) and improves the immunity of the DPSK optical modulation format to optical link impairments such as non-linear phase distortion (PM to AM conversion due to the optical Kerr) effect, however the price incurred in exchange of these improvements is considerably higher receiver complexity. The optical receivers must now comprise considerably more complex interferometric and electronic soft-processing structures, in order to process observation windows longer than two symbols. It would be advantageous to find ways to reduce the realization complexity of the multi-chip DPSK receiver while retaining essentially the same performance advantage relative to conventional DPSK.

### DESCRIPTION OF THE PRIOR ART

Electronic (wireless) and optical DPSK were briefly introduced in the Background section of this invention. Here we first elaborate on the optical DI Interferometric structure 305 which is a basic building block in conventional binary or quaternary DPSK receiver 300.

A typical DI as used in a B-DPSK or Q-DPSK optical receiver (FIGS. 1, 2) consists of an asymmetric two-arm Mach-Zehnder interferometer, whereby the incoming DPSK modulated optical signal 321 is split, typically by means of an splitter 310, for example a Y-junction as seen in FIG. 1 and FIG. 2 or optical coupler as seen in FIG. 3, into two paths with optical path difference equal to T, the DPSK symbol period. In this figure, the difference in optical paths is depicted by a delay element T 323. As a result of the differential delay, at any given time the outputs of the two arms contain samples of the input optical signal spaced T apart in time. The two paths are made to optically interfere, by combining the outputs of the two optical delay lines either by means of an optical combiner with a single output port, typically a Y-junction in reverse, or preferably by means of an optical coupler 325 with two input ports and two output ports 337(+) and 337(−) respectively. The two output ports of such coupler are complementary, in the sense that when one output is high the other is low and vice versa. The output port(s) is/are equipped with photo-detector(s) 339(+) and 339(−), converting the optical intensity into electrical currents. In the case wherein the two arms are combined by a two-port optical coupler, balanced detection is used, whereby the electrical currents of the two photo-detectors are subtracted, with the difference of photo-currents constituting the balanced electrical output 340 of the DI.

Mathematically, the balanced DI photo-current is expressed in terms of the two optical field samples {tilde under (u)}ₖ, {tilde under (v)}ₖ at the output coupler input, which generate (up to an irrelevant constant) the following two optical fields samples {tilde under (u)}ₖ±{tilde under (v)}ₖ at the two coupler outputs. The coupler is then seen to generate the sum and difference of the two input fields at its two output ports, respectively called Σ and Δ ports. The balanced photo-current is the difference of the two photocurrents generated at each of the two output ports, in turn equal to the absolute squares of the two output field samples {tilde under (u)}ₖ±{tilde under (v)}ₖ:
iₖ∝|{tilde under (u)}ₖ|²−|{tilde under (v)}ₖ|²=|{tilde under (u)}ₖ+{tilde under (v)}ₖ|²−|{tilde under (u)}ₖ+{tilde under (v)}ₖ|²

Expanding the squares and simplifying yields
iₖ∝Re{tilde under (u)}ₖ{tilde under (v)}ₖ* (1)

Now, let {tilde under (r)}ₖ be the optical field sample received at the DI input. This sample is split into the two DI arms and is relatively delayed by one discrete time unit in the longer arm with relative delay T. Ignoring the inconsequential splitting amplitude factor and the common delay of the two arms, the two field samples at the ends of the two arms (i.e. at the two directional coupler inputs) are expressed as
{tilde under (u)}ₖ={tilde under (r)}ₖe^{jγ},
{tilde under (v)}ₖ={tilde under (r)}ₖ₋₁
where γ is the relative bias phase-shift imparted to the two arms (either by means of a separate bias electrode and/or by the geometry of the device and/or by thermal stabilization).

Substituting the last two expressions into (1) yields the balanced output of the DI as a function of the input field sample {tilde under (r)}ₖ into the DI:
iₖ∝Re{e^{jγ}{tilde under (r)}ₖ{tilde under (r)}ₖ₋₁*}. (2)

Control means, such as controlled phase retardation element 345 is further provided as mentioned above to appropriately bias the quasi-static differential phase γ between the two interferometer arms in order to attain the extremes of either maximum (constructive) or minimum (destructive) interference in the output port(s) of the combiner or coupler, depending on the relative phase of the two successive chips. For clarity, phase controller 345 is omitted in the following figures. E.g., assuming B-DPSK transmission, the proper differential phase bias setting for the two arms is γ=0. The B-DPSK balanced DI output at discrete-time k is denoted q_{T}[k], expressed (up to a constant) a
q_{T}[k]={tilde under (r)}ₖ{tilde under (r)}ₖ₋₁*

For the bias phase setting γ=0, when logical zero is transmitted, i.e. the two successive chips bear equal optical phases, then constructive interference is attained in the output port designated + above, (called the sigma port) whereas destructive interference results in the other port designated − above (labeled the delta port). The sigma port photocurrent is maximum whereas the delta port photocurrent is minimum (ideally zero, if everything is perfectly balanced). In case that logical “one” is transmitted, i.e. the phase of the current chip was switched by 180 relative to the phase of the previous chip, then the roles of the two ports are exchanged: The destructive interference is achieved at the sigma port, wherein the photocurrent is minimum whereas at the delta port photocurrent now attains a maximum. As the DI balanced electrical output consists of the difference of the sigma and delta port photocurrents, it is apparent that for logical one the current is positive whereas for logical zero the current switches to negative polarity. The B-DPSK detection is graphically described in FIGS. 3a and 3b, illustrated the propagation of two successive optical symbols through the DI device. Comparing the balanced photodetection arrangement, taking the difference of the sigma and delta ports photocurrent (397+ and 397− respectively), vs. a single ended DI, terminated in just a Y-junction combiner with a single photo-detector, it is shown that the balanced photodetection yields a performance advantage of about 3 dB.

FIG. 3a illustrate the optical phase is not changed between the bits 377a and 377b, thus light is constructively interferes at the Σ port, creating large signal at detector 379+, while at the same time light is destructively interferes at the Δ port, creating minimal signal at detector 379−. In contrast, FIG. 3b illustrate the optical phase is changed by 180 degrees between the bits 377′a and 377′b, thus light is constructively interferes at the Δ port, creating large signal at detector 379−, while at the same time light is destructively interferes at the Σ port, creating minimal signal at detector 379+. The resulting interferometer output signal 340, resulting from subtracting from subtracting the signal of detector 379− from that of detector 379+ is thus positive (negative) in FIG. 3a (3b) respectively.

The balanced or single-ended DI output is next applied to a slicer (decision device) outputting one bit indicating the sign of the input (e.g. realized by means of a D-Flip Flop, 399). The slicer then contains one (for B-DPSK, FIG. 1) or two (for Q-DPSK, FIG. 2) sign-decision devices.

A sign-decision device takes an analog waveform and samples it at the baud rate, outputting at each sample time (once in each chip interval) a logical bit indicative of the sign of the waveform at the sample time, namely logical one (zero) if the sign is positive (negative). Barring noise and other transmission impairments, the slicer output then recovers the transmitted bitstream.

Considering now Q-DPDK transmission, as a Q-DPDK modulated signal may be equivalently viewed as multiplexing of DPSK transmissions, the receiver structure may consist of two B-DPSK detection sub-blocks in quadrature: In the optical receiver front-end the incoming signal is split to feed two DI devices in quadrature, i.e. the difference between the differential phase biases of each DI is designed to be 90 degrees (actually the two differential phases of the two respective DIs are set to +/−45 degrees).

For Q-DPSK the optical receiver front-end comprises two DI devices (FIG. 2) biased at γ=±π/4, with electrical balanced outputs given by
q_{T}^{re}[k]=Re{e^{jπ/4}{tilde under (r)}ₖ{tilde under (r)}ₖ₋₁*},q_{T}^{im}[k]=Re{e^{-jπ/4}{tilde under (r)}ₖ{tilde under (r)}ₖ₋₁*} (3)

The respective bits detected in each chip interval at the outputs of the two DIs are collected into a bit pair pointing to one of the four differential phases (0, 90, 180, 270 degrees). It is then apparent that the bitrate of Q-DPSK is twice that of BDPSK, for the same baud (symbol) rate. FIG. 2, depicts a detection system 400 for detecting Q-DPSK coded optical signal arriving into input 412. The two interferometers 405+ and 405− include additional phase retardation means 407+ and 407− for retarding the optical phase by +45 (−54) degrees respectively. In this example, slicer 420 is a 2-bit output decision making device realized as two D-FF's 399.

Electronic and optical multi-symbol DPSK were already introduced in the background section of this invention. Here we elaborate on the receiver structures (FIGS. 4a, b, c, d, e) described in prior art in [3-7] for the optical realization of multi-symbol (or multi-chip) DPSK. The receiver front-end comprises multiple DIs, each of the conventional two-arm structure, however the differential delays between the two arms of the DIs are set to the symbol (chip) period T, and to integer multiples thereof. Let D be the window dimension (number of successive chips in the moving window). The higher D is, the better the performance.

To detect binary phase (B-DPSK), D−1 Delay Interferometers (DIs) with respective delays T, 2T, . . . , (D−1)T are required. For M>2 phase states, as say in quaternary phase (Q-DPSK) with M=4, the DI count must be doubled to 2(D−1), to provide both in-phase and quadrature DIs for each delay. E.g. for D=3, two (for DPSK) or four (for QPSK) DI(s) with delays T, 2T, are required. The DIs with delay 2T are used to detect the phase differences of chips that are separated by delays 2T, i.e. pairs of chips with one intervening chip in between. More generally, for D-chip DPSK, the DI(s) with delay nT, where n≦D−1 integer are used to detect the phase differences of chips separated by nT.

FIG. 4a schematically illustrates a system 400 for detecting a 3 chips 2 phases coded optical signal. Optical signal arrives at input 410. Splitter 420 divides the optical signal among the interferometers in interferometer section 430. Electrical signals from the interferometers enters the soft decision section 440 which processes these electrical signals to yield the multi-bit output 450 comprising 2 chips 2 bits output.

FIG. 4b elaborates some details of the soft decision section 440. In this figure, the weighting matrix 441 is illustrated as double (solid) line arrows representing non-inverted (inverted) signals to be summed by four analog summation means Σ.

FIG. 4c similarly illustrates a system receiving a 3 chips per block, 4 phases input and yielding a 2 chips, 4 bits output.

FIG. 4d similarly illustrates a system receiving a 4 chips per block, 2 phases input and yielding a 3 chips, 3 bits output.

FIG. 4e similarly illustrates a system receiving a 4 chips per block, 4 phases input and yielding a 3 chips, 6 bits output. The electrical balanced outputs of all the DIs are then combined in a soft-detection circuit consisting of a linear matrix of signed additions (additions and subtractions) applied to the electrical DI outputs. The linear soft-detection circuit is terminated in a “select-largest” block that points the output port of the signed additions matrix at which the electrical signal is the largest. The bits combination used to point to the largest output then forms the decision output for the D-symbols window. To recap the description of the multi-symbol DPSK receiver, the detection process starts in an optical front-end comprising several DIs followed by an electronic soft-processing circuit in which analog DI outputs are linearly processed in the analog electrical domain, then terminated in a “select-largest” circuit for hard-detection.

A reduction in the bit error rate (BER) floor by several orders of magnitude was shown to be attainable with such multi-symbol or multi-chip DPSK (MC-DPSK) receiver structures, relative to using standard DPSK receivers, especially over fiber optic channels affected by non-linear phase. Remarkably, even the lowest order 3 chip B-DPSK system (the least complex of the MC-DPSK schemes) already provides up to about two-orders of magnitude advantage in BER in the wake of the dominant non-linear phase noise transmission impairment.

Unfortunately, the price incurred for the improved performance is the overall receiver complexity. Of the various receiver subsystems, the optical front-end is the least problematic. While the usage of multiple DI devices does increase the cost of the system this is still tolerable, and does not pose additional opto-electronic performance challenges, as all the DI devices are essentially realized with the same technology, essentially differing just in their delays. Moreover it is feasible to incorporate additional DIs onto the same integrated-optic substrate, partially mitigating the cost and volume. Therefore, increasing the DI count in exchange for the improved performance seems like a reasonable trade-off, however, the main issue with the multi-chip differential phase format in its original form lies with the realization of the electronic high-speed soft-processing circuit. The implementation of MC-DPSK soft-detection circuitry using state-of-the-art mixed-signal electronic technology at 10-40-160 Gbps, which are the currently envisioned rates in the successive generations of optical transmission systems, and especially the realization of the “select-largest” circuit, turns out to be overly complex to implement with state-of-the art mixed signal electronics. While the linear add/subtract operations are still manageable by means of continuous-time current mode circuits, with the sampling performed after the summation, the “select largest” final stage is most challenging, as it requires an array of N(N−1)/2 pair-wise comparators (with N=M^{D-1}).

In a more recent publication [8] a simplified logic diagram was introduced for the soft decision circuit of multi-symbol BDPSK with D=3 chips, however the complexity of the soft decision circuit, while somewhat reduced, still remains high. Moreover, no obvious solution exists for Q-DPSK and for a longer observation window of D≧4 chips.

Another enhancement of DPSK that was explored in the electrical wireless communication literature [9-11], consists of multi-symbol DPSK with Decision Feedback (DF). The general application of the DF concept pertains to improving the quality of the current decision by considering the past receiver decisions to be correct, i.e. pretending those decisions represent the actually transmitted signals.

Decision feedback was recently ported to optical DPSK—in [12] the multiple optical delays are eliminated, i.e. just one or two delay interferometers with delay T equal to the symbol interval are necessary (no need for 2T, 3T, . . . delays), i.e. the optical front-end is identical to that of conventional optical DPSK requiring one DI for BDPSK and two DIs for Q-DPSK. While this reduces the receiver complexity on one hand, on the other hand the operation of those systems necessitates applying Decision Feedback (DF) to a very complex post-detection circuit comprising multiple high-speed electronic complex-valued multipliers, each of which comprising in turn four real-valued four quadrant multipliers. The multipliers are very hard to implement at high speed, mostly beyond of the state of the art of electronic processing, especially so when considering migration to higher transmission rates of 40 and 160 Gbps second.

### OTHER PUBLICATIONS

[1] A. H. Gnauck and P. J. Winzer, “Optical phase-shift-keyed transmission,” J. Lightwave Technol., 23, 115-30 (2005).
[2] D. Divsalar and M. K. Simon, “Multiple-symbol differential detection of MPSK,” IEEE Transactions on Communications, vol. 38, pp. 300-8, 1990.
[3] Moshe Nazarathy and Yoav Yadin, “Approaching coherent homodyne performance with direct detection low-complexity advanced modulation formats” Paper CThB5, Coherent Optical Technologies and Applications (COTA), Whisler, Canada, Jun. 28-30, 2006.
[4] M. Nazarathy and E. Simony, “Multichip differential phase encoded optical transmission,” Photonics Technology Letters, IEEE, vol. 17, pp. 1133-1135, 2005.
[5] Y. Yadin, A. Bilenca, and M. Nazarathy, “Soft Detection of Multichip DPSK Over the Nonlinear Fiber-Optic Channel,” Photonics Technology Letters, IEEE, vol. 17, pp. 2001-2003, 2005.
[6] M. Nazarathy and E. Simony, “Generalized Stokes Parameters Shift Keying,” Optics Letters, vol. 31, Feb. 15, 2006.
[7] M. Nazarathy and E. Simony, “Stokes space optimal detection of polarization and differential phase shift-keying modulation,” Journal of Lightwave Technology, accepted for publication.
[8] Xiang Liu, “Digital Implementation of Soft Detection for 3-Chip-DBPSK with Improved Receiver Sensitivity and Dispersion Tolerance,” in Proc. OFC 2006, Paper OTuI2.
[9] F. Edbauer, “Bit error rate of binary and quaternary DPSK signals with multiple differential feedback detection,” IEEE Trans. Com., 40, 457-460 (1992).
[10] F. Adachi et al., “Decision Feedback Multiple-Symbol differential detection for M-ary DPSK”, Electron. Lett., 29, 1385-1387 (1993).
[11] H. Leib, “Data-aided noncoherent demodulation of DPSK,” IEEE Trans. Com., 43, 722-725 (1995).
[12] S. Calabro et. al., “Improved detection of homodyne phase shift keying through multi-symbol phase estimation”, in Proc. ECOC2005, paper We4.P.118.
[13] Moshe Nazarathy and Yoav Yadin, “Approaching coherent homodyne performance with direct detection low-complexity advanced modulation formats” Paper CThB5, Coherent Optical Technologies and Applications (COTA), Whisler, Canada, Jun. 28-30, 2006 (accepted for publication).
[14] J. P. Gordon and L. F. Mollenauer, “Phase noise in photonic communications systems using linear amplifiers”, Opt. Lett., 15, 1351-1353 (1990).
[15] K.-P. Ho, “Asymptotic probability density of nonlinear phase noise,” Opt. Lett., vol. 28, no. 15, pp. 1350-1352 (2003)
[16] D. Yevick, “Multicanonical Communication System Modeling—Application to PMD Statistics”, Photon. Technol. Lett., Vol. 14, pp. 1512-1514, 2002
[17] M. Nazarathy and E. Simony, “Performance limits of multilevel DPSK,” Photonics Technology Letters, IEEE, vol. 17, pp. 2310-2312, 2005.
[18] E. Ciaramella, IEEE PTL, vol. 16, no. 9, 2004

### SUMMARY OF THE INVENTION

It is an aspect of the current invention to provide devices, methods and system using “self coherent detection” for detection of optical phase modulated signal. The optical signal itself, delayed at multiple units of the basic bit duration is used instead of locking a “local oscillator” laser to the carrier frequency. In contrast to Radio Frequency (RF) phase Modulation (PM), where local oscillators are commonly used and easily locked using phase locked loop, it is hard to optically implement such solution. The current invention provides increased sensitivity and reduction in errors by utilizing information in the signals at times removed from the currently detected bit by more than one bit duration.

It should be noted that in order to ease the propagating the “phase of the last detected bit” into the “optical phase retardation” in the “decision feedback” it is possible to code and decode the bitstream using “poly-delay” coding and decoding protocol. In this protocol, the value of a bit is determine by comparing the optical phase of the optical signal to the phase of the optical signal separated from him by an integer (N) number of bits instead of comparing the phase to the phase of the bit immediately preceding it. In the simples implementation, N=2, the even bits and the odd bits may be vied at two separate interleaving bitstreams. In all the equations and the drawings, the delay “T” should be replaced with a delay N*T wherein N is the bit-interleaving integer. In the case of N=2, an additional time delay of T available for the detection electronics, the feedback electronics and the electro-optical modulator(s) to react to a detected bit and to change the optical phase accordingly.

In accordance with the invention, there are provided differential phase shift keying (DPSK) optical receivers of improved performance using modified structures, based on the principles of multi-symbol DPSK detection and at the same time aided by decision feedback (DF), albeit at much reduced complexity relative to prior art realizations that are based on multi-symbol DPSK and/or DF.

In contrast to conventional optical DPSK receivers, and to prior art DF based optical DPSK receivers, the optical front-ends of the receivers according to an embodiment of the invention are extended to include multiple delay interferometers (DIs) and/or DIs with multiple (more than two) optically interfering arms, such that the differential delays between the arms are all integer multiples of the symbol duration T, i.e. the delays are T, 2T, . . . (D−1) T where D≧3 is the length of the sliding observation window in chips. DPSK receiver front-ends with multiple DIs with delays T, 2T, . . . for the multi-symbol processing of optical DPSK have appeared in prior art, however the combination of multiple DIs with delays T, 2T, . . . along with the application of DF, and the unique methods whereby the DF is applied to the front-ends provides the essential differentiation of the invention.

The usage of multiple DIs with delays T, 2T, . . . was shown to improve receiver performance by providing for the averaging power of a longer observation moving window comprising three or more successive symbols which improves receiver performance. In comparison, conventional DPSK corresponds to D=2, comprising just a single delay T, corresponding to a moving window of two successive symbols.

However, as practiced in prior art, front-end comprises multiple DI works in conjunction with very complex electronic soft-processing and decision circuitry. It follows that the performance advantage of multi-symbol DPSK is offset by the increased realization complexity.

In contrast, our invention combines DF-aided processing with the multiple DIs by unique methods to the effect of considerably reducing the electronic soft-processing and decision circuitry processing requirements. We note that prior art taught the usage of DF-aided processing, yet without the benefit of an optical front-end comprising multiple DIs as taught in this invention. The prior art DF-aided processing then requires the incorporation of very complex electronic processing comprising multiple four quadrant analog multipliers that are very difficult to implement at ultra high speeds or digital multipliers along with high speed analog to digital converters which are also very difficult to implement.

Three families of embodiments are disclosed in the invention.

In one family of embodiments, the electrical outputs of the said DI device or devices are combined by means of a novel low-complexity electronic soft-processing processing module, consisting of phase inversion or switching of DI output(s) under the control of the decision feedback bits and addition(s) prior to sign-based bit decisions. This circuit is far less complex than the soft-processing circuits used in prior-art optical multi-symbol DPSK. The decision feedback bitstream is applied to this module to electronically switch the polarities of the electrical outputs of DI that have delays 2T, 3T, . . . , prior to additive combination and sign detection. In these embodiments the electronic soft-processing is effectively reduced to controlled inversions (multiplications by ±1) of the electrical outputs of the DIs with delays 2T, 3T, . . . , under the control of the decision feedback bits along with summations of subsets of the controlled inverter outputs as well as the outputs of the DI(s) with delay T (which is/are not control-inverted).

In other embodiments of this family, the sequence of controlled inversions and additions is replaced by signed additions followed by DF-aided switching, such that the various outputs of the signed addition matrix are selected under the digital control of the DF bits. In all the embodiments, the simple slicer structure consisting of sign decisions is maintained as in conventional DPSK, e.g. just one sign decision is required for B-DPSK and two sign decisions are required for Q-DPSK. It follows that the requisite electronic processing is far less complex than the prior art versions using either multi-symbol DPSK or DF.

An alternative point of view accounting for the operation of the these embodiments is in terms of corrections to be applied to a conventional optical DPSK receiver which conventionally comprises one (for B-DPSK) or two (for Q-DPSK) main DIs with delay T. The DI(s) with longer delays 2T, 3T, . . . , switched or control-inverted under the control of the DF bits, is/are viewed as auxiliary to the main DI(s) with delay T, providing analog soft corrections to the said main DIs outputs. In effect, the corrected outputs synthesize a phase reference with lower phase noise than used in conventional DPSK.

In a second family of embodiments, the DF is applied to active phase-shifting electrodes incorporated of modified DIs, replacing the electronic inversions/switching of the first family of embodiments, with electro-optically inversion/switching, performed the optical DIs themselves.

In a third family of embodiments of the invention, the said multiple DI devices are replaced by integrated-optic circuit(s) realizing to modified DI devices which are no longer of the conventional Mach-Zehnder asymmetric two-arms type, but rather comprise either three or more arms with appropriate couplings, or two arms, one of which comprises a re-circulating delay line with delay T. These embodiments reduce the complexity of the optical front-end, requiring fewer interferometric devices. The disclosed devices either comprise multiple (three or more) interfering arms of appropriate delays and phase modulating electrodes or incorporating a re-circulating optical delay line (a little optically coupled ring) in a two-arm DI along with a pair of active phase modulating electrodes activated by the DF.

DF exploits the already extracted information in earlier bit decisions to improve the current bit decision. As surveyed in the prior art section, DF-aided detection, multiple delay interferometers or multiple delay interferometers with delays T, 2T, . . . for the multi-symbol processing of optical DPSK been used in prior art in DPSK have been disclosed for optical DPSK in prior art, however the essential novel elements of the invention include the application of Decision Feedback (DF) to the taught electro-optic receiver front-end integrated-optic structures, and the methods whereby DF is applied, as well as the disclosed multi-arm and re-circulating interferometric structures. Altogether these measures result in lower complexity higher performance DPSK receiver.

In the prior art systems the feedback is not applied to the electro-optic front-end in the novel fashion taught here, but is rather applied to post-detection high-speed electronic analog complex-valued multipliers that are difficult or impossible to realize at very high bitrates. Applying the DF to the receiver novel electro-optical front-end in accordance with the invention enables taking advantage of the ability of optical devices to outperform electronic devices in ultra-high speed signal processing, yielding improved performance relative to conventional DPSK, yet incurring reduced overall complexity relative to prior art DF and/or multi-symbol DPSK.

According to an aspect of the current invention, a differential phase shift keying (DPSK) optical transmission, distribution or networking system is provided comprising:

One or more optical DPSK transmitters;

optical transmission channels comprising optical fibers or free-space portions;

one or more optical receivers, wherein each of said receivers includes an interferometric optical front-end wherein the incoming optical signal is split over a multitude of paths and the paths are partitioned in groups with the optical paths in each group optically interfering due to combination by means of optical multiports with photo-detectors placed at the outputs of the optical multiports, with the photo-detectors feeding the inputs of a soft-processing electrical network, with the outputs of said network feeding hard decision circuits quantizing the electrical signals to generate output decision bits related to the bitstream applied to the said corresponding transmitter; wherein each pair of said optical paths has relative delays, equal to integer multiples T, 2T, 3T, . . . nT of T with n>2, where T is the symbol period of the transmitted DPSK signal; wherein means are provided to passively or actively bias the differential phases of the said optical paths of the said Interferometric front-end.

In some embodiments the hard decision bits are optionally passed through a digital processing circuit and either the processed or unprocessed bits are then applied to modulate or switch the said electrical multiport network, providing decision feedback to the soft-processing electrical network.

In some embodiments the interferometric front-end comprises active phase-shifting electrodes applied onto a subset of the optical paths; with the said output decision bits are optionally passed through a digital processing circuit and either the processed or unprocessed hard decision bits applied to a driver circuit the outputs of which are then applied to modulate the said optical paths by application of output drive signals to the said phase-shifting electrode.

In some embodiments the hard decision bits are optionally passed through a digital processing circuit; a subset of the processed or unprocessed hard decision bits is applied through a driver circuit to modulate the said optical paths by application of output drive signals to the said phase-shifting electrode, while the remaining resulting bits are applied to modulate or switch the said electrical multiport network, with both subsets of bits providing decision feedback to both the said interferometric front-end and the soft-processing electrical network.

In some embodiments the interferometric front-end comprises an initial splitter with its input port fed by the received optical signal, and with two or more output ports; two or more Mach-Zehnder delay interferometers; each said delay interferometer comprising an optical splitter having an input port coupled to one of the outputs of the initial splitter and having two output ports with each of the said two output ports feeding an optical path or delay line; with the outputs of the two optical delay lines feeding an optical combiner having two input ports and one or two output ports; with the one or the output ports of the optical combiner terminated in one or two photo-detectors; with the relative delay between the two said delay lines of each said delay interferometer being equal to integer multiples T, 2T, 3T, . . . nT of T with n>2, where T is the symbol period of the transmitted DPSK signal;

In some embodiments the hard decision bits are optionally passed through a digital processing circuit and either the processed or unprocessed bits are then applied to modulate or switch the said electrical multiport network of claim 1, providing decision feedback to the soft-processing electrical network.

In some embodiments the interferometric front-end comprises active phase-shifting electrodes applied onto a subset of the optical paths; with the said output decision bits are optionally passed through a digital processing circuit and either the processed or unprocessed hard decision bits applied to a driver circuit the outputs of which are then applied to modulate the said optical paths by application of output drive signals to the said phase-shifting electrode.

In some embodiments the hard decision bits are optionally passed through a digital processing circuit; a subset of the processed or unprocessed hard decision bits is applied through a driver circuit to modulate the said optical paths by application of output drive signals to the said phase-shifting electrode, while the remaining resulting bits are applied to modulate or switch the said electrical multiport network of claim 1, with both subsets of bits providing decision feedback to both the said interferometric front-end and the soft-processing electrical network

In some embodiments the interferometric front-end comprises an initial splitter with its input port fed by the received optical signal, and with two or more output ports; two or more Mach-Zehnder delay interferometers; each said delay interferometer comprising an optical splitter having an input port coupled to one of the outputs of the initial splitter and having two output ports with each of the said two output ports feeding an optical path or delay line; with the outputs of the two optical delay lines feeding an optical combiner having two input ports and one or two output ports; with the one or the output ports of the optical combiner terminated in one or two photo-detectors; with the relative delay between the two said delay lines of each said delay interferometer being equal to integer multiples T, 2T, 3T, . . . nT of T with n>2, where T is the symbol period of the transmitted DPSK signal;

In some embodiments the interferometric front-end comprises an initial splitter with its input port fed by the received optical signal, and with two or more output ports; two or more Mach-Zehnder delay interferometers; each said delay interferometer comprising an optical splitter having an input port coupled to one of the outputs of the initial splitter and having two output ports with each of the said two output ports feeding an optical path or delay line; with the outputs of the two optical delay lines feeding an optical combiner having two input ports and one or two output ports; with the one or the output ports of the optical combiner terminated in one or two photo-detectors; with the relative delay between the two said delay lines of each said delay interferometer being equal to integer multiples T, 2T, 3T, . . . nT of T with n>2, where T is the symbol period of the transmitted DPSK signal;

In some embodiments the interferometric front-end comprises an initial splitter with its input port fed by the received optical signal, and with two or more output ports; two or more Mach-Zehnder delay interferometers; each said delay interferometer comprising an optical splitter having an input port coupled to one of the outputs of the initial splitter and having two output ports with each of the said two output ports feeding an optical path or delay line; with the outputs of the two optical delay lines feeding an optical combiner having two input ports and one or two output ports; with the one or the output ports of the optical combiner terminated in one or two photo-detectors; with the relative delay between the two said delay lines of each said delay interferometer being equal to integer multiples T, 2T, 3T, . . . nT of T with n>2, where T is the symbol period of the transmitted DPSK signal;

In some embodiments the said soft-processing electrical network consists of subtracting each pair of electrical outputs of each Mach-Zehnder delay interferometer to generate a balanced electrical output; wherein controlled inverters are applied onto a subset of the balanced electrical outputs of the said delay interferometers, in order to switch the polarity of said electrical outputs under the decision feedback control of the output decision bits; a summing network additively combining the outputs of said optical inverters with a subset of said delay interferometer outputs; with the outputs of the said summing networks connected to the inputs of said hard decision circuits.

In some embodiments the teachings of this invention for DPSK with DF are combined with the amplitude-shift keying (ASK) modulation format, yielding improved Differential Phase Amplitude Shift Keying (DPASK) systems with decision feedback

The invention improves the trade-offs between Bit Error Rate (BER) transmission distance and transmission bitrate. The disclosed systems are more immune to non-linear fiber-optic transmission impairments, especially the non-linear phase noise stemming from the Gordon-Mollenauer effect [14,15]. The disclosed systems performance is also superior over that of conventional DPSK over linear optical channels (such as in free-space optical communication). The improved performance is attained while incurring a much lower price in realization complexity, compared with prior art, that introduced various forms of multi-chip (or multi-symbol) DPSK extension.

An aspect of the current invention provides a detector for detecting optical DPSK coded bitstream comprising: at least a first optical interferometer interfering optical signal indicative of at least one detected bit with optical signal indicative of a preceding bit and generating electronic signal; an electronic decision circuit receiving said electronic signal and determining a value of said at least one detected bit; and a feedback circuit modifying said generated electronic signal in response to determined value of at least one bit preceding said detected bit.

In some embodiments, said feedback circuit electronically modifies said generated electronic signal in response to determined value of at least one preceding detected bit.

In some embodiments, said feedback circuit modifies said generated electronic signal by changing optical phase retardation in at least one arm of said first optical interferometer.

In some embodiment said interferometer interfering optical signals indicative of said at least one detected bit with light indicative of at least two different preceding bits.

In some embodiment said interferometer comprises: at least three arms for interfering optical signals indicative of said at least one detected bit with light indicative of at least two different preceding bits; and at least two controlled optical phase modulators, wherein said optical phase modulators are controlled in response to values of said at least two different preceding bits.

In some embodiment optical interferometer comprises: a first arm conducting optical signal indicative of said detected bit; a second arm conducting optical signal indicative of optical signals of at least two different preceding bits; a first controlled optical phase modulator receiving signal from said feedback circuit and modifying relative phase of optical signals between said first and second arms; and a second controlled optical phase modulator receiving signal from said feedback circuit and modifying relative phase of optical signals of at least two different preceding bits.

In some embodiment said first and second controlled optical phase modulators are in said first and second arms respectively.

In some embodiment said first and second controlled optical phase modulators are in said second arm.

In some embodiment the detector comprises: a first arm conducting optical signal indicative of said detected bit; a second arm comprising a recursive delay line conducting optical signal indicative of bits preceding said detected bit.

In some embodiment the detector further comprises: a first controlled optical phase modulator receiving signal from said feedback circuit and modifying relative phase of optical signals between said first and second arms; and a second controlled optical phase modulator receiving signal from said feedback circuit and modifying relative phase of optical signals of said bits preceding said detected bit.

In some embodiment the detector said first and second controlled optical phase modulators are in said first and second arms respectively.

In some embodiment said first and second controlled optical phase modulators are in said second arm. In some embodiment the detector further comprises: at controlled optical phase modulator receiving signal from said feedback circuit and modifying phase of optical signal in said recursive optical delay line.

Another aspect of the invention is to provide a detection system for detecting optical DPASK coded bitstream comprising: an ASK detector; and a DPSK detector according to any embodiment of the current invention.

Another aspect of the invention is to provide a method for detecting optical coded bitstream comprising detecting optical DPSK coded bitstream comprising the steps of: optically interfering signal indicative of at least one detected bit with optical signal indicative of a preceding bit, generating electronic signal indicative of said interference; determining a value of said at least one detected bit based on said electronic signal; and modifying said generated electronic signal in response to determined value of at least one bit preceding said detected bit.

In some embodiment said step of modifying said generated electronic signal in response to determined value of at least one preceding detected bit is done electronically.

In some embodiment said step of modifying said generated electronic signal in response to determined value of at least one preceding detected bit is done by modifying relative phase of said interfering optical signals.

In some embodiment said method further comprising detecting ASK coded bitstream.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1-4 schematically illustrates a system for detecting coded optical signal as known in the art:

FIG. 1 schematically illustrates a system for detecting B-DPSK coded optical signal as known in the art.

FIG. 2 schematically illustrates a system for detecting Q-DPSK coded optical signal as known in the art.

FIGS. 3a and 3b illustrate the optical signals in the interferometer seen in FIG. 1.

FIGS. 4a-e schematically illustrates a system coded optical signal as known in the art.

FIGS. 5-20 schematically illustrates a system for detecting coded optical signal according to first family of embodiments of the current invention:

FIG. 5 depicts a top level of description of a receiver according to the current invention.

FIG. 6 schematically depict the slicer according to an embodiment of the current invention.

FIGS. 7a and 7b schematically depict the Interferometric Front-End (IFE); 7a for DF Q-DPSK (M=4, D=4), and 7b for DF B-DPSK (M=2, D=4)

FIG. 8 depicts some internal details of the Soft-Processor (SP) for the case of Q-DPSK (D=4, M=4) according to the current invention.

FIG. 9 depicts some internal details of the Soft-Processor (SP) for the case of B-DPSK (D=4, M=2) according to the current invention.

FIG. 10a illustrate some internal details of CI 920 according to an embodiment of the current invention.

FIG. 10b illustrate some internal details of CCI 820 according to an embodiment of the current invention.

FIG. 11 depicts the QPSK complex constellation symbol, FIG. 11a for 45 deg rotated QPSK Signal constellation and decision regions; and FIG. 11a for un-rotated QPSK Signal constellation and decision regions.

FIG. 12 depicted the operation of element QCR.

FIG. 13a depicts a truth table digitally representing sᵢₙ{tilde under (m)}=sₒᵤₜ.

FIG. 13a depicts a truth table digitally representing the conjugation of a QPSK constellation symbol in the Gray Code.

FIG. 14 depicts some internal details of the DFL for Q-DPSK according to an embodiment of the current invention.

FIG. 15 exemplifies the block diagram of a specific Q-DPSK system (M=4) for the particular value of D=3 chips according to an embodiment of the current invention.

FIG. 16 illustrating some details of DFL for B-DPSK according to an embodiment of the current invention.

FIG. 17 depicts a specific embodiment for M=2 (B-DPSK), D=3 according to an embodiment of the current invention.

FIG. 18 depicts a specific embodiment for M=2 (B-DPSK), D=4 according to an embodiment of the current invention.

FIG. 19 depicts an alternative embodiment for B-DPSK using CIs according to an embodiment of the current invention.

FIG. 20a schematically depicts the operation of 180° electrical hybrid.

FIGS. 20b-d depicts realizations of 180° electrical hybrid, employing summing amplifiers, differential amplifiers, summing junctions or with 180 deg phase-shifters.

FIG. 21 shows a graph of BER vs. transmitted optical power: 2-chip (conventional) DPSK and 3-chip MC-DPSK (dashed), compared to decision feedback based receivers (DF-MC-DPSK) with 3 and 4 chips (solid), showing improvement of the Q-factor for the 3-chip schemes at the minimum BER point is 18 dB.

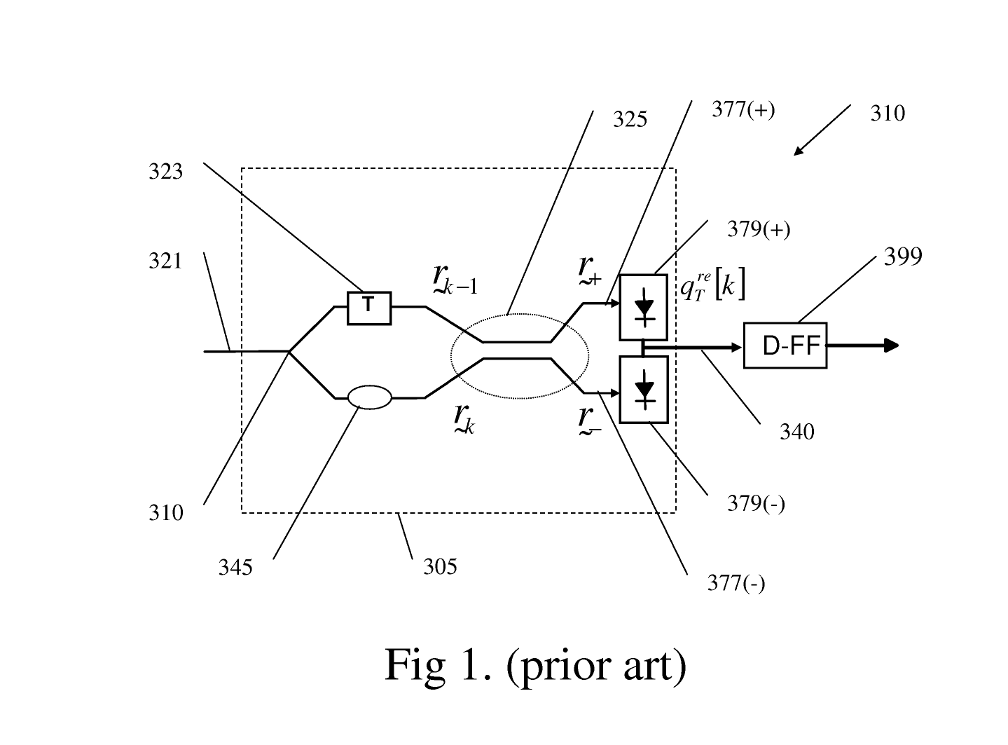

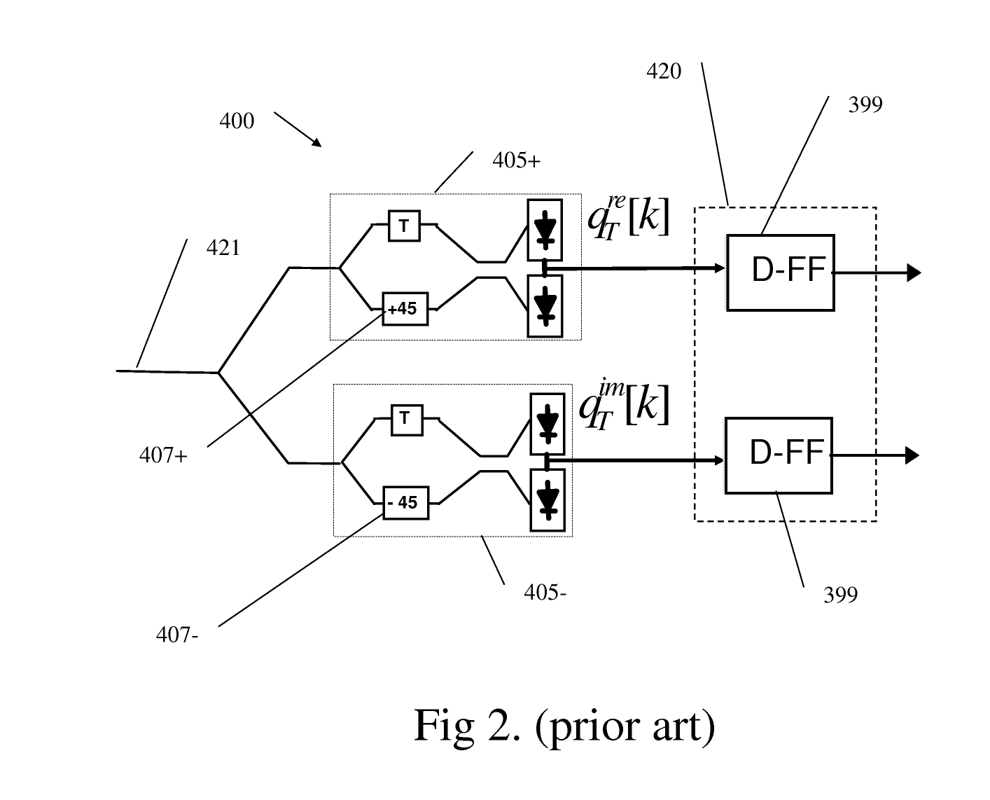

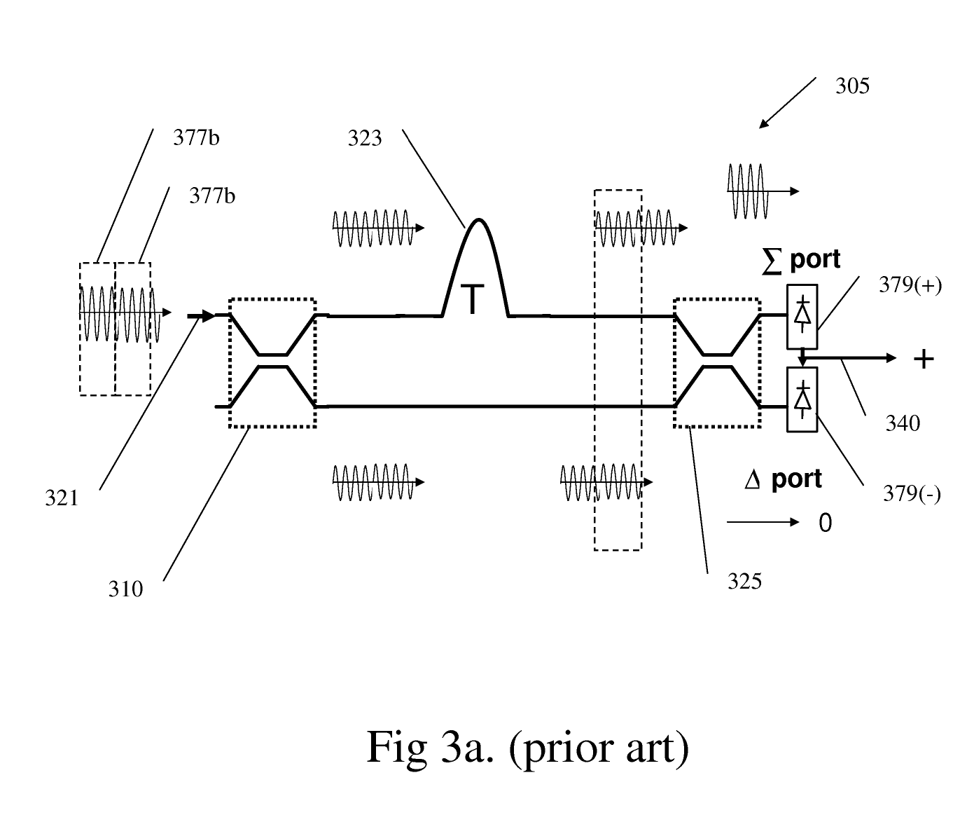

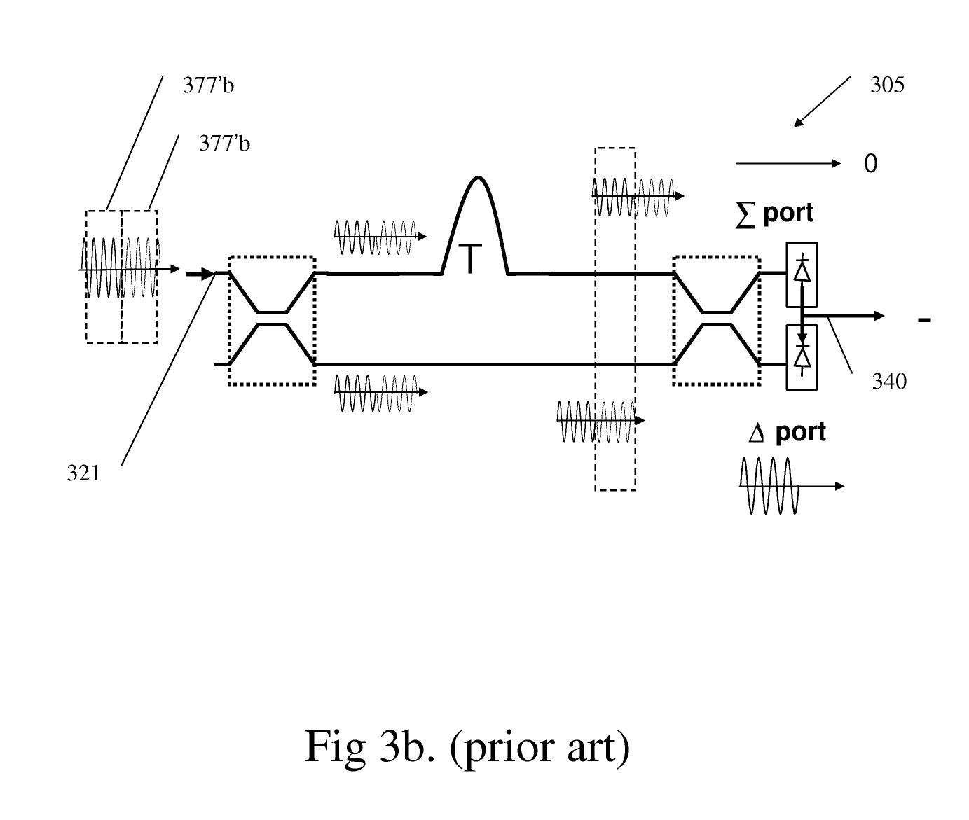

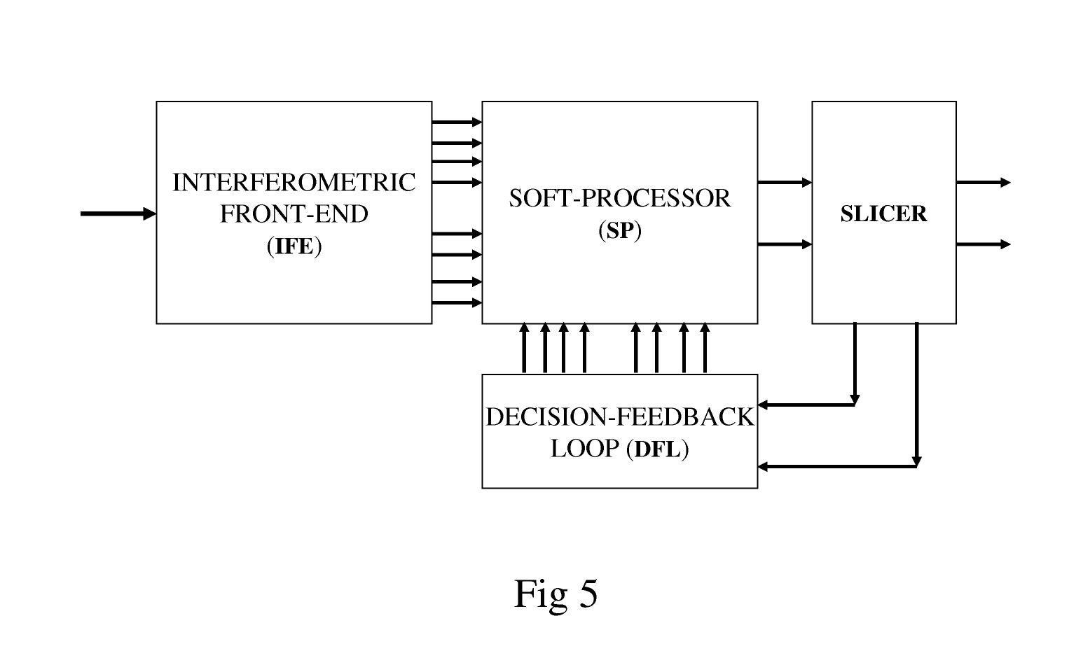

FIGS. 5-21 schematically illustrates a system for detecting coded optical signal according to second family of embodiments of the current invention:

FIG. 22 schematically illustrates a system for detecting coded optical signal for 3-chip B-DPSK with (D,M)=(3,2) according to the current invention.

FIG. 23 schematically illustrates a system for detecting coded optical signal for 3-chip Q-DPSK with (D,M)=(3,4) according to the current invention.

FIG. 24 schematically illustrates a system for detecting coded optical signal for 5-chip B-DPSK with (D,M)=(5,2) according to the current invention.

FIGS. 25-28 schematically illustrates a system for detecting coded optical signal according to third family of embodiments of the current invention:

FIG. 25 schematically depicts a system for detecting optical signal for D=3 chips Q-DPSK according to the third family of embodiments of the current invention.

FIG. 26 schematically depicts a details of IPC device for detection of D=5 chips optical signal according to the third family of embodiments of the current invention.

FIG. 27 schematically depicts a system for detection of D=5 chips Q-DPSK optical signal according to the third family of embodiments of the current invention.

FIG. 28 schematically depicts a system for detection of D=5 chips B-DPSK optical signal according to the third family of embodiments of the current invention.

FIGS. 29-32 schematically illustrates a system for detecting coded optical signal according to fourth family of embodiments of the current invention:

FIG. 29 schematically depicts a system for detection optical signal with an interferometer using one voltage controlled phase retardation means in line with, and affecting all the delayed optical branches, and a second voltage controlled phase retardation means in line with the non-delayed branch, according to the fourth family of embodiments of the current invention.

FIG. 31 schematically depicts a system for detection optical signal with an interferometer having one voltage controlled phase retardation means in line with, and affecting all the delayed optical branches, and a second voltage controlled phase retardation means in line with but positioned after the delays, according to the fourth family of embodiments of the current invention.

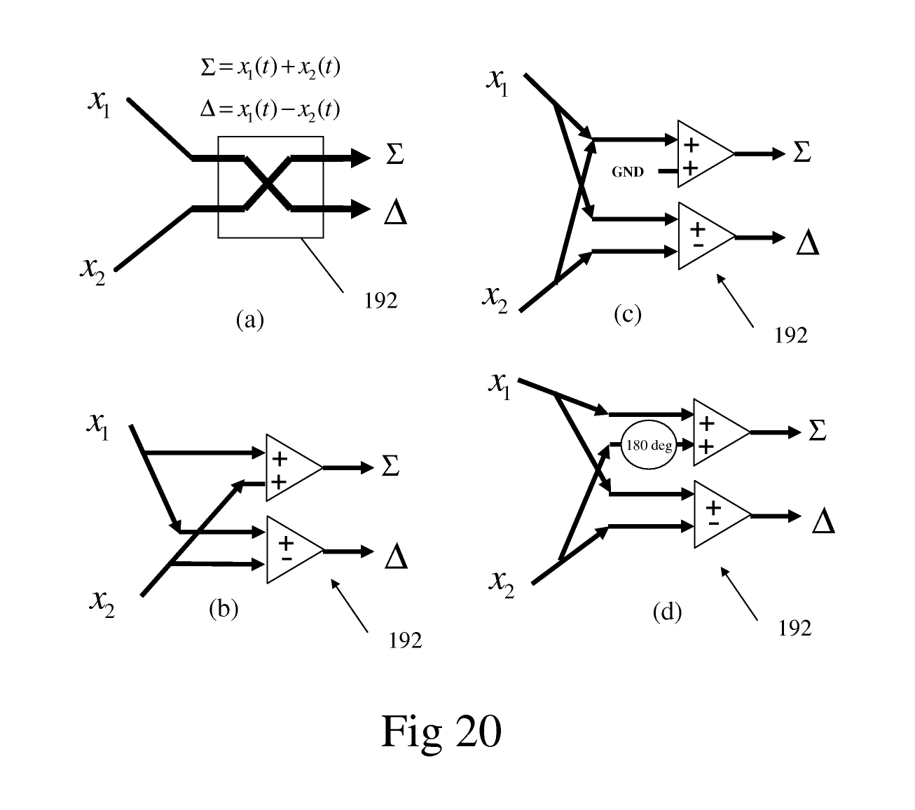

FIG. 20 schematically depicts the digital circuit to generate rotation increment for the embodiments of FIGS. 29 and 31 according to the current invention.

FIG. 32 presents an equivalent block diagram for the system of FIGS. 29-31, for analysis purposes.

FIGS. 33-41 schematically illustrates a system for detecting coded optical signal according to fifth family of embodiments of the current invention:

FIG. 33 schematically depicts a system for detecting coded optical signal with an interferometer having a recirculation ring and two phase modulators, one in each branch of an interferometer, according to an embodiment of the current invention.

FIG. 34 schematically depicts a system for detecting coded optical signal with an interferometer having a recirculation ring and two phase modulators, both in line, yet one before and one after the recirculation ring, according to another embodiment of the current invention.

FIG. 35 schematically depicts a system for detecting coded optical signal with an interferometer having a recirculation ring and one phase modulators modulating light in the recirculation ring, according to another embodiment of the current invention.

FIG. 36 schematically depicts a system for detecting coded optical signal with an interferometer having a recirculation ring and one phase modulator modulating light in the recirculation ring, according to another embodiment of the current invention.

FIG. 37 models the optically coupled ring and defines the pertinent parameters.

FIG. 38 represent a mathematical equivalent block diagram of embodiments of FIG. 33.

FIG. 39 represent a mathematical equivalent block diagram of embodiments of FIG. 35.

FIG. 40 depicts the geometric relationships of the phase-noise of the conventional reference vs. the improved reference according to the current invention.

FIG. 41 depicts a plot of equation 55 showing the relationship between effective number of chips and recirculator loss, indicating that a high effective number of chips is attainable in a device according to the embodiment of the current invention.

FIG. 42 schematically illustrates a system for detecting coded optical signal, combining DPSK and ASK optical coding methods according to sixth family of embodiments of the current invention.

### DETAILED DESCRIPTION OF THE INVENTION

Before explaining at least one embodiment of the invention in detail, it is to be understood that the invention is not limited in its application to the details of construction and the arrangement of the components set fourth in the following description or illustrated in the drawings. The invention is capable of other embodiments or of being practiced or carried out in various ways. Also, it is to be understood that the phraseology and terminology employed herein is for the purpose of description and should not be regarded as limiting.

In discussion of the various figures described herein below, like numbers refer to like parts.

The drawings are generally not to scale.

For clarity, non-essential elements were omitted from some of the drawings.

In accordance with the invention, differential phase shift keying optical transmission systems of improved performance are taught. (Multi)Point to (Multi)point and/or wavelength-division multiplexed embodiments are also taught based on underlying point-to-point embodiments. Point-to-point single-wavelength embodiments of the invention comprise a conventional DPSK transmitter, a conventional fiber-optic or free-space optical link and one of multiple novel optical receiver embodiments compatible with the prior art DPSK optical transmitters.

In accordance to the invention we introduce improved DPSK receivers. The taught receivers are characterized by two parameters M and D, where M is the number of phase states (M-ary DPSK, in particular M=2, i.e. B-DPSK and M=4, i.e. Q-DPSK) and D is the window dimension (number of successive chips in the moving window), as explained in the prior art section.

Notice that in this exemplary embodiments, only low values of D, say D=3, 4, 5, are of interest, and only the values M=2, 4 respectively corresponding to B-DPSK and Q-DPSK, are of interest in these embodiments, as the complexity rises with increasing D and M. However, the current invention may be extended to larger valued of D.

At the top level of description, the taught receiver comprises the following modules: The Interferometric Front-end (IFE), the Soft-Processor (SP), the Slicer, and a Decision Feedback loop (DFL) module, with appropriate interconnections between these modules (FIG. 5). The IFE contains more complex Interferometric structure than in conventional DPSK known in the art. The SP applies analog processing to the electrical outputs of the IFE, generating analog decision variables to be input into the Slicer wherein bit decisions are generated. The IFE is controlled by feedback from the decision bits, via the DFL, which may contain some discrete-time digital processing, or may degenerate to a trivial module just passing the decision bits from the slicer straight to the IFE.

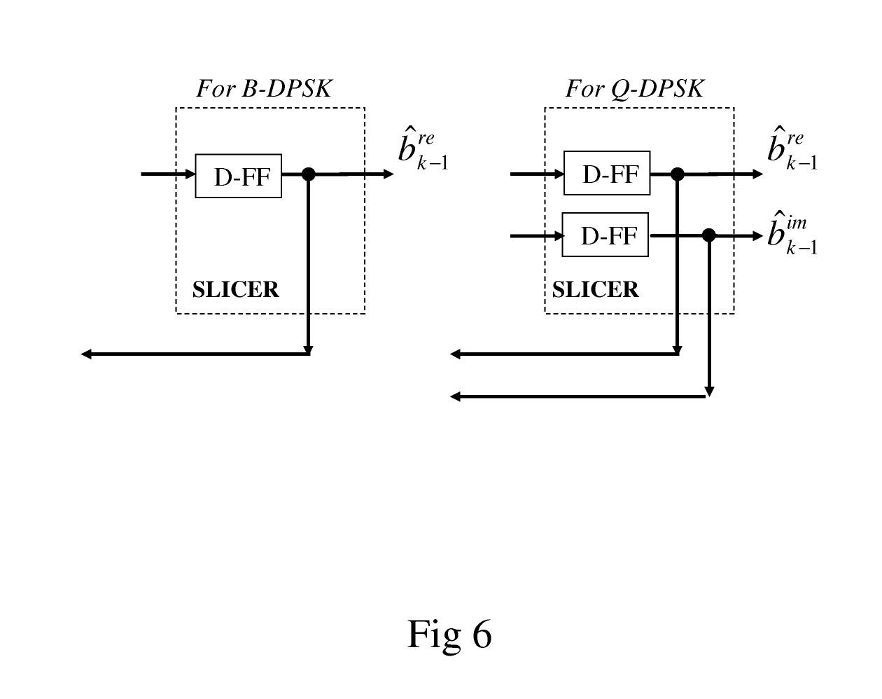

Detailing here the slicer (FIG. 6), for all the embodiments of the taught invention this module is in fact identical to that of a conventional DPSK system, also comprising one (two) sign-decision device(s) for (B-DPSK (Q-DPSK). For a conventional DPSK receiver the Slicer is directly fed by the outputs of the optical front-end which contains just D−1=1 or 2(D−1)=2 DIs (for conventional DPSK D=2). The slicer then respectively consists of just one or two sign-decision devices (for B-DPSK/Q-DPSK), as explained in the Prior Art Section. This is in fact an advantage of the current invention, as the slicer is no more complicated than a conventional slicer, unlike the case of prior art multi-chip DPSK where the slicer is quite hard to realize as explained in the Prior Art section.

### A FIRST FAMILY OF EMBODIMENTS

The Interferometric Front-End (IFE)

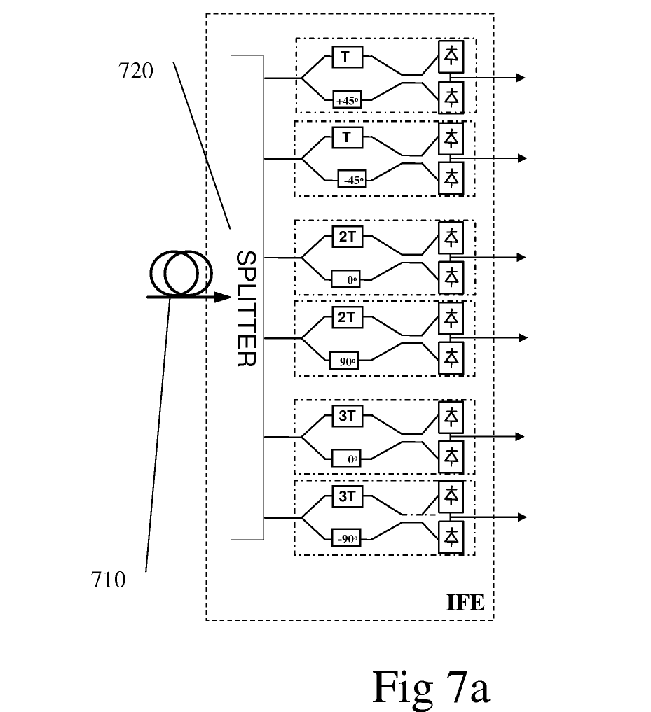

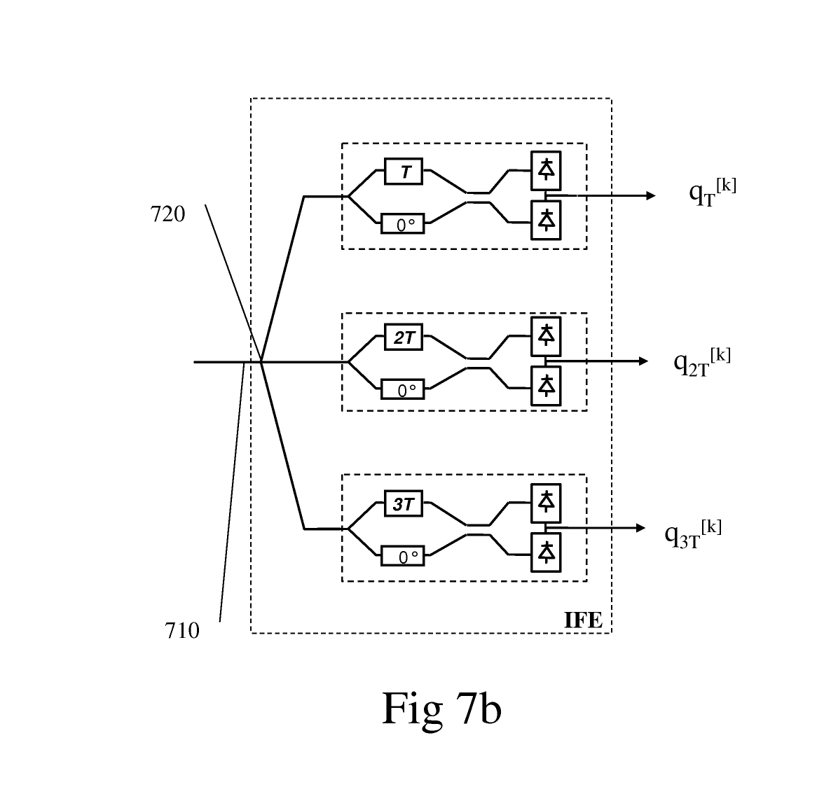

In these embodiments according to the current invention, the interferometric front-end (FIGS. 7a and 7b) comprises at least two Delay Interferometers (DIs), with all the DIs have conventional asymmetric Mach-Zehnder structure, using balanced optical detection (two photodiodes on the two ports of the output coupler of the DI, with the difference of photodiode currents providing the DI electrical output) as used in prior optical DPSK detection (see prior art section).

However unlike conventional DPSK, wherein the DIs delay equal the chip duration T (a “chip” being the regular baud interval over which the phase of the transmitted optical signal stays constant), in this family of embodiments of the invention, at least two of the DIs have respective delays of at least two varieties, say T and 2T.

Notice that in other schemes such as polarization multiplexing the main delay is set to 2T to begin with as two tributaries of polarization symbols are interleaved with each other. Such polarization multiplexing system would be extended in our invention to have DIs with delays, 2T, 4T, 6T, . . . .

The overall collection of DIs in the IFE then has differential delays T, 2T, . . . (D−1)T.

As illustrated in FIG. 7a, for M=2, i.e. for B-DPSK, there is just one DI for each of the delays T, 2T, . . . (D−1)T, i.e. the B-DPSK front-end comprises a total of D−1 DIs.

For M>2, and in particular for the M=4 case of interest (Q-DPSK) depicted in FIG. 7b, there are two DIs for each delay, i.e. a total of 2(D−1) DIs. The pair of DIs corresponding to each delay are in quadrature, i.e. one is the “in-phase” DI and the other is the “in-quadrature” DI: The two differential phase biases between the two arms of each of the two quadrature DIs differ by 90°. For the two “main” DIs with delay T, the respective differential phase biases are set to ±45°. For the D−2 pairs of “auxiliary” DIs with delays 2T, 3T, (D−1)T the differential phase biases of the in-phase DIs are set to 0° while the differential phases of the in-quadrature DIs are set to 90°. In contrast, for M=2, i.e. for B-DPSK, the differential phases of each of the D−1 DIs are all set to 0°.

The multiple DIs in the front-end are all fed from the input fiber 710 (typically the output of an optical pre-amplifier) by means of a multi-port passive optical splitter 720, splitting the optical input line D−1 ways for B-DPSK and 2(D−1) ways for Q-DPSK.

It is also possible that the DIs or subsets of them be integrated onto a single integrated-optic substrate, which might also include the input optical splitter.

The balanced electrical outputs of all the DIs provide the output of the IFE module.

It is also possible to implement the DIs in the IFE using different physical embodiments than integrated optic waveguide structures with splitters, two asymmetric arms and combiners. E.g. similarly to [18] as scheme is described, whereby the received DPSK optical signal is split into orthogonal polarization states and delay one polarization more than the other using a birefringent element such and then beat the signals together using a polarization beam splitter. Such a device essentially implements a DI in the polarization domain. The family of embodiments described here all pertains to any possible physical realization of the DI function.

Soft-Processor (SP)—Top Level:

The SP provides electronic-post detection processing of the DI outputs. The inputs to this module are the electrical outputs of the IFE (the DI outputs) as well as the outputs of the Decision Feedback Loop (DFL) module (the decision bits which possibly undergo some digital processing in the DFL). The SP generates one (two) electrical output(s) in the case of B-DPSK (Q-DPSK), which is(are) used as input(s) to the Slicer.

Slicer:

In this family of embodiments of the invention, it is the one or two output(s) of the soft-processor (for B-DPSK/Q-DPSK respectively) leading to decision device(s). The decision bit(s) provide the information output(s) of the slicer, namely the estimates \hat{b}ₖ₋₁^{re} (and for Q-DPSK also \hat{b}ₖ₋₁^{im}) of the transmitted bit(s) delayed by one discrete-time unit. The information bits are also split to provide the auxiliary output(s) feeding the DFL.

Soft-Processor (SP)—Detail:

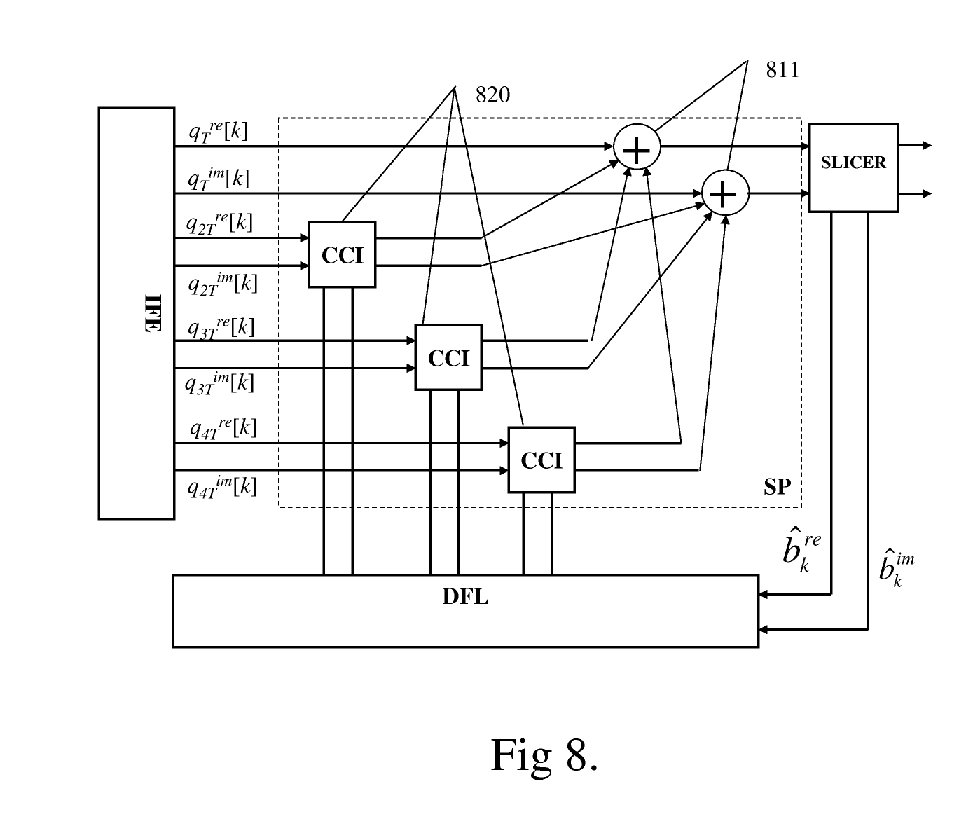

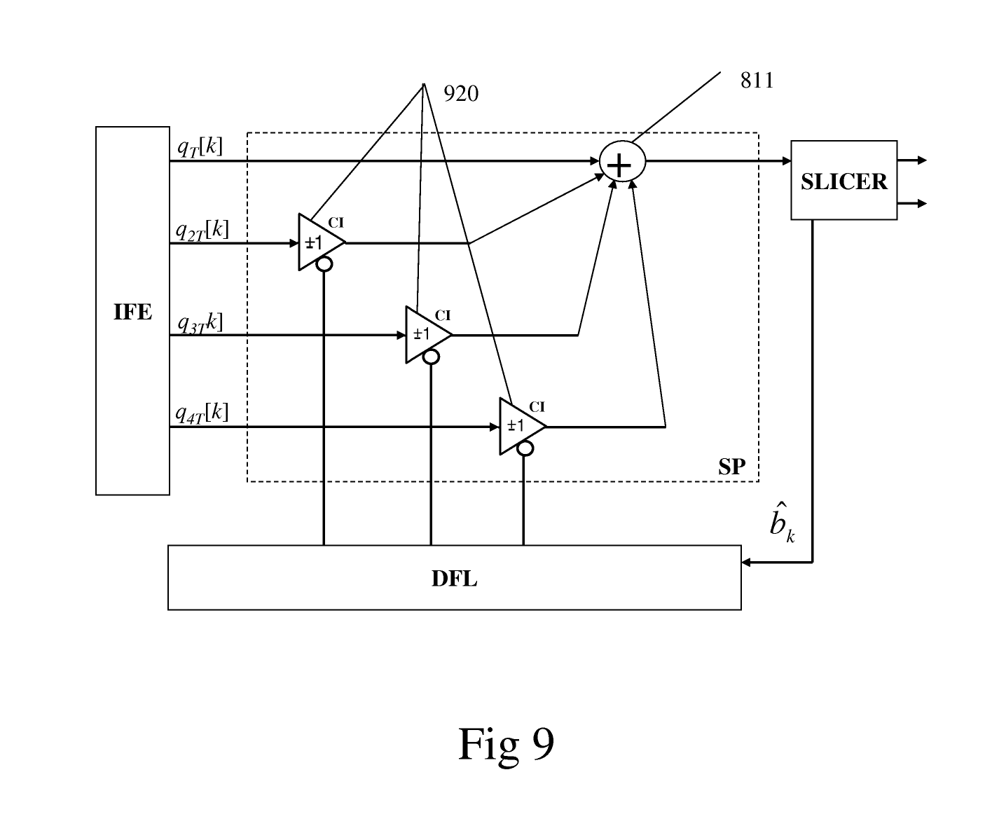

Returning to examine the internals of the Soft-Processor (SP) (FIGS. 8, 9), this module has analog inputs coinciding with the outputs of the IFE, as well as digital inputs coinciding with the outputs of the decision feedback loop.

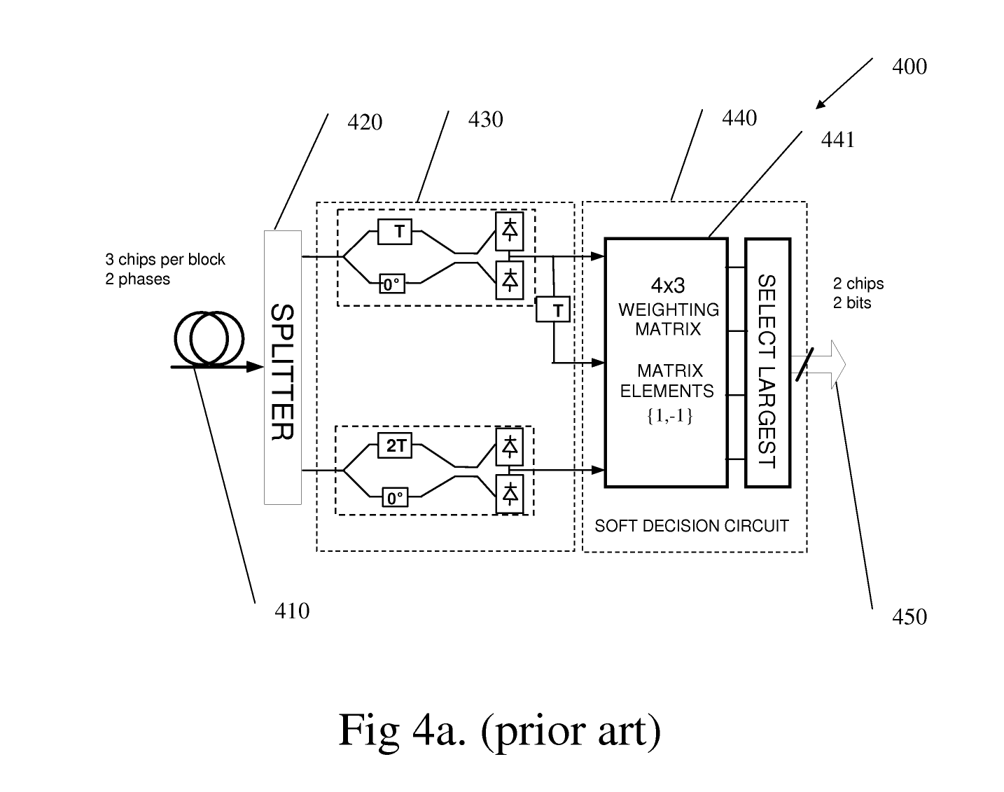

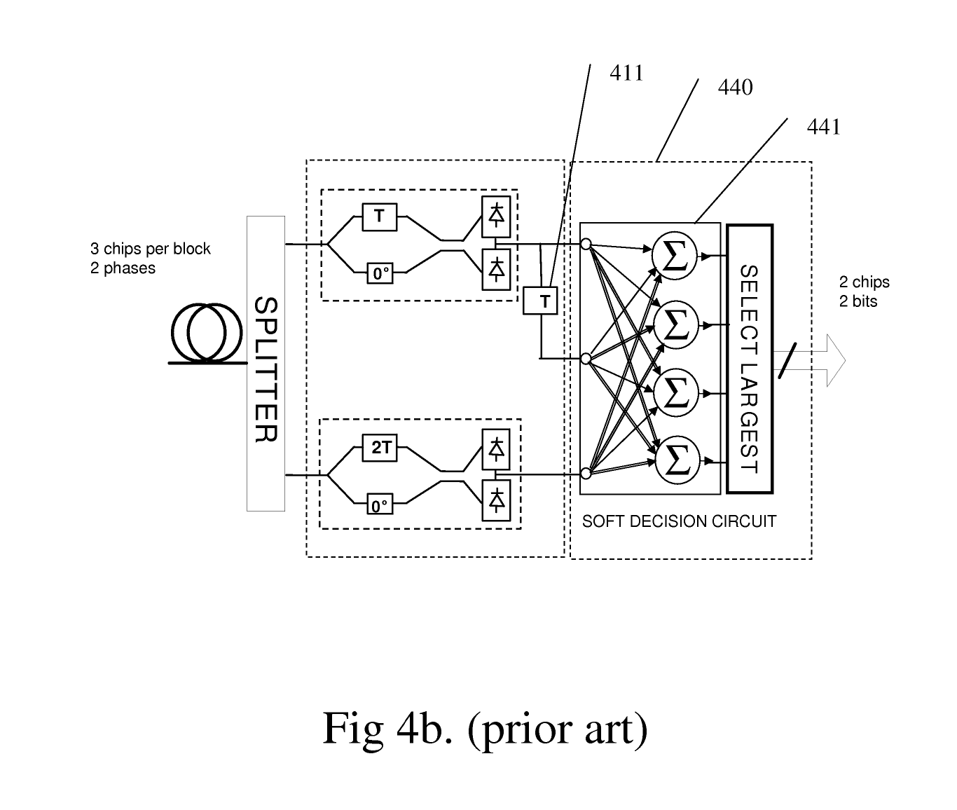

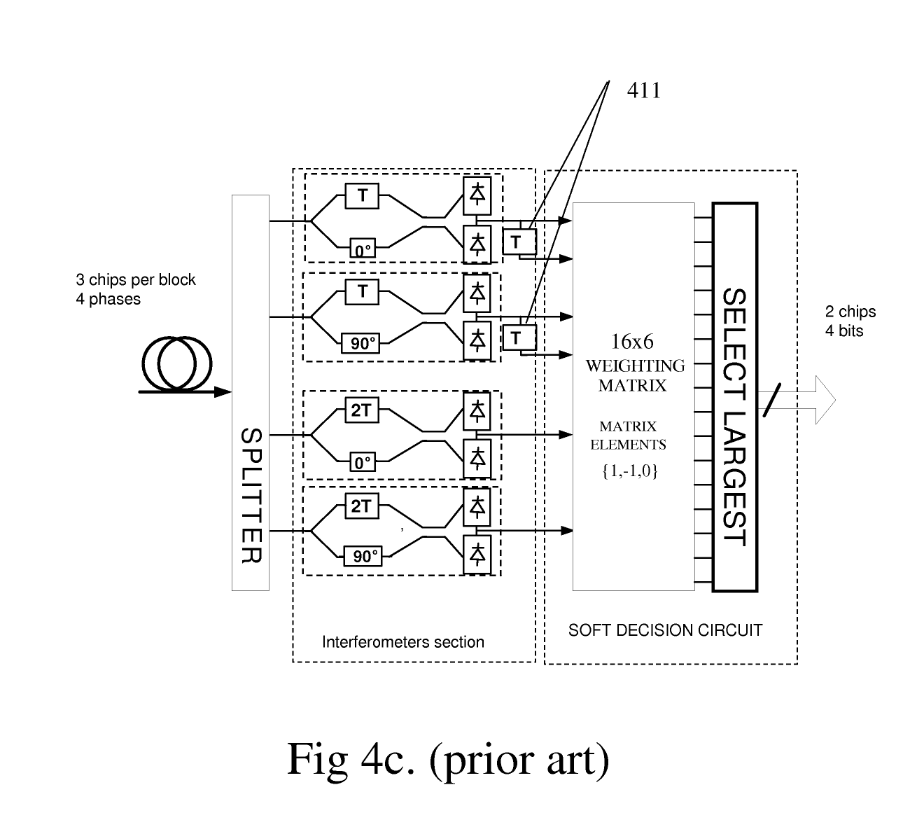

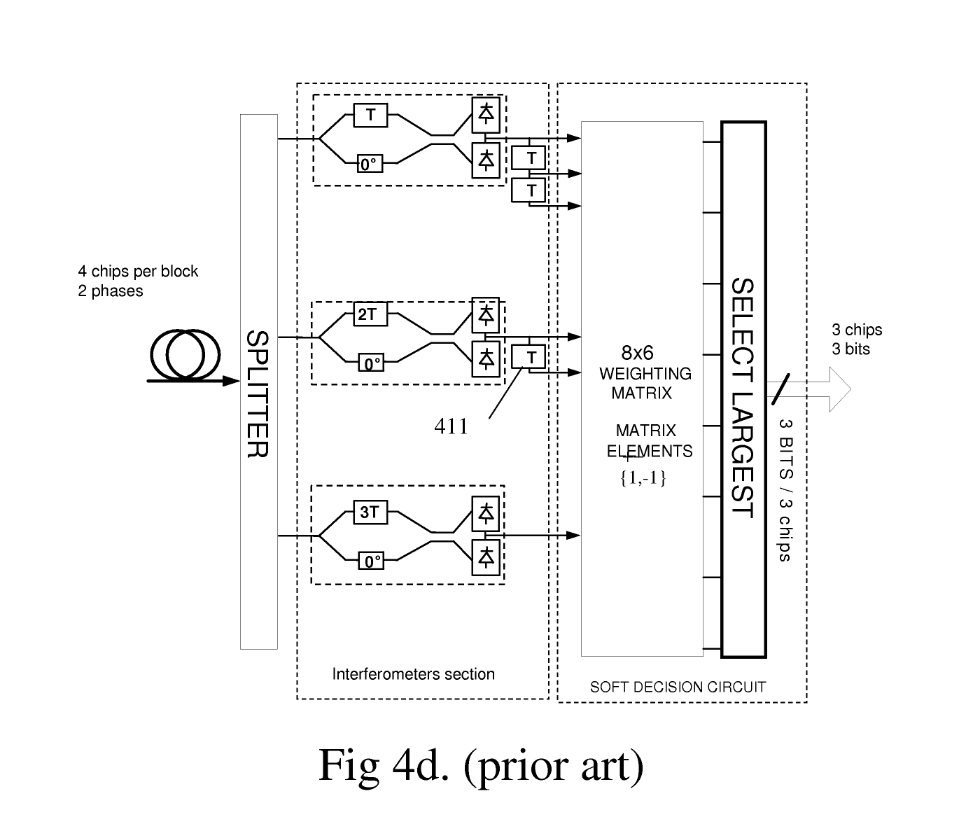

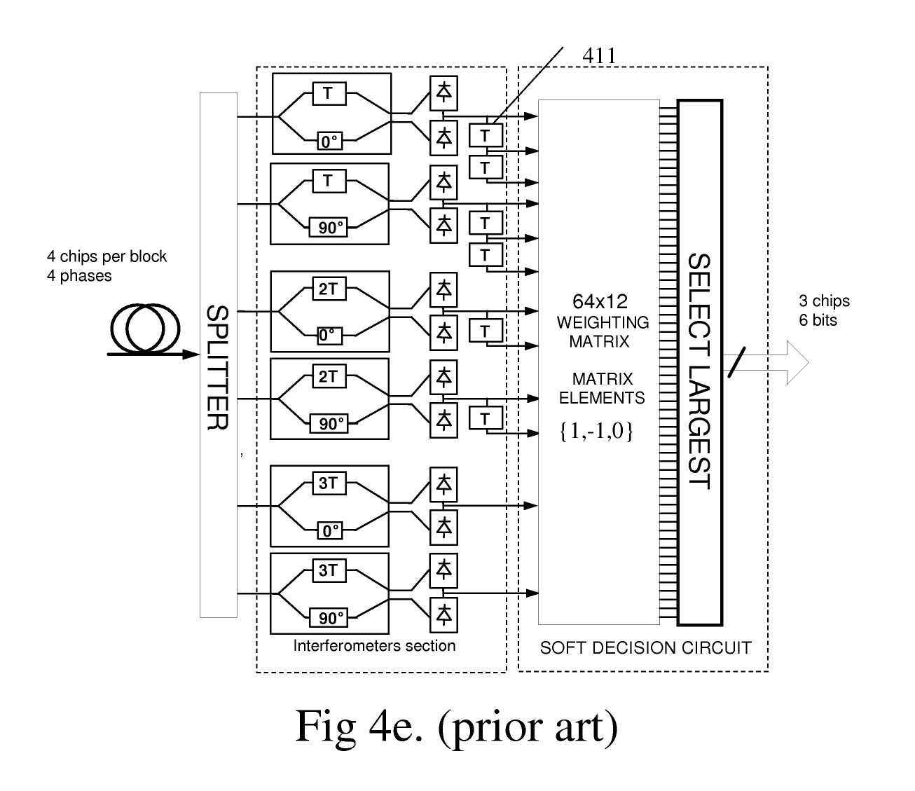

FIG. 8 depicts some internal details of the Soft-Processor (SP) the case for Q-DPSK (D=4, M=4), while FIG. 9 depicts the case for B-DPSK (D=4, M=2). Note that in this figures the electronic delays 411 seen in FIGS. 4a-4e were omitted.

For B-DPSK, the list of analog inputs to the SP is
{q′_{T}^{re}[k],q′_{2T}^{re}[k],q′_{3T}^{re}[k], . . . q′_{(D-1)T}^{re}[k]}

For Q-DPSK the list of analog inputs to the SP is
{q′_{T}^{re}[k],q_{T}^{im}[k],q′_{2T}^{re}[k],q′_{2T}^{im}[k],q′_{3T}^{re}[k],q′_{3T}^{im}[k], . . . , q′_{(D-1)T}^{re}[k],q′_{(D-1)T}^{im}[k]}
consisting of the outputs of both the in-phase and the in-quadrature DIs for each delay. Here q_{mT}^{re}[k],q_{mT}^{im}[k] denote the balanced outputs at discrete-time k of the in-phase and in-quadrature DIs with differential delay mT between the two arms of each device, for m=2, 3, . . . D−1. Notice that all the DIs are phase-biased at ±45° respectively, i.e. use a 45° rotated Q-DPSK constellation as denoted by the prime in q′_{mT}^{re}[k], q′_{mT}^{im}[k]. See eq. (3) (with T replaced by mT) for an expression of the DI outputs in terms of the optical field samples at the DI inputs.

The SP comprises one or two (respectively applicable for B-DPSK/Q-DPSK) analog adders 811. The adder(s) is (are) fed by balanced outputs of the “main” DI(s) defined as that or those with delay T 411, i.e. by the signal(s) q′_{T}^{re} (or {q′_{T}^{re},q′_{T}^{im}}) as well as by the output(s) of one or more mixed-signal circuits (of different structures in the respective B-DPSK and Q-DPSK cases) respectively called Controlled Inverters (CI) 920 and Complex-Controlled inverters (CCI) 820. It is the output(s) of the adder(s) that provide the overall output(s) of the soft-processor (fed into the sign-decision devices of the slicer). The input(s) to the adders are the output(s) of the main DIs with delay T, as well as the outputs of CIs or CCIs.

Controlled and Complex Controlled Inverters:

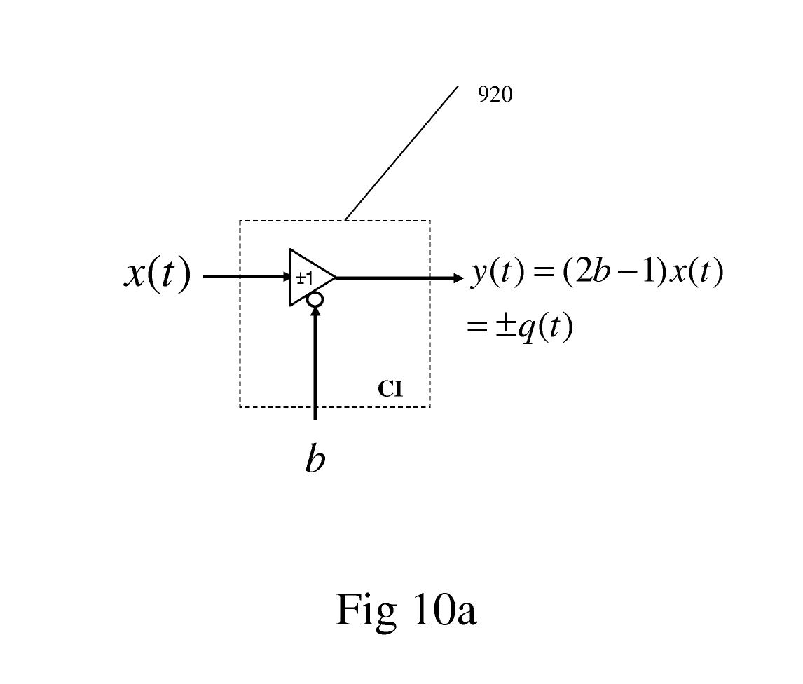

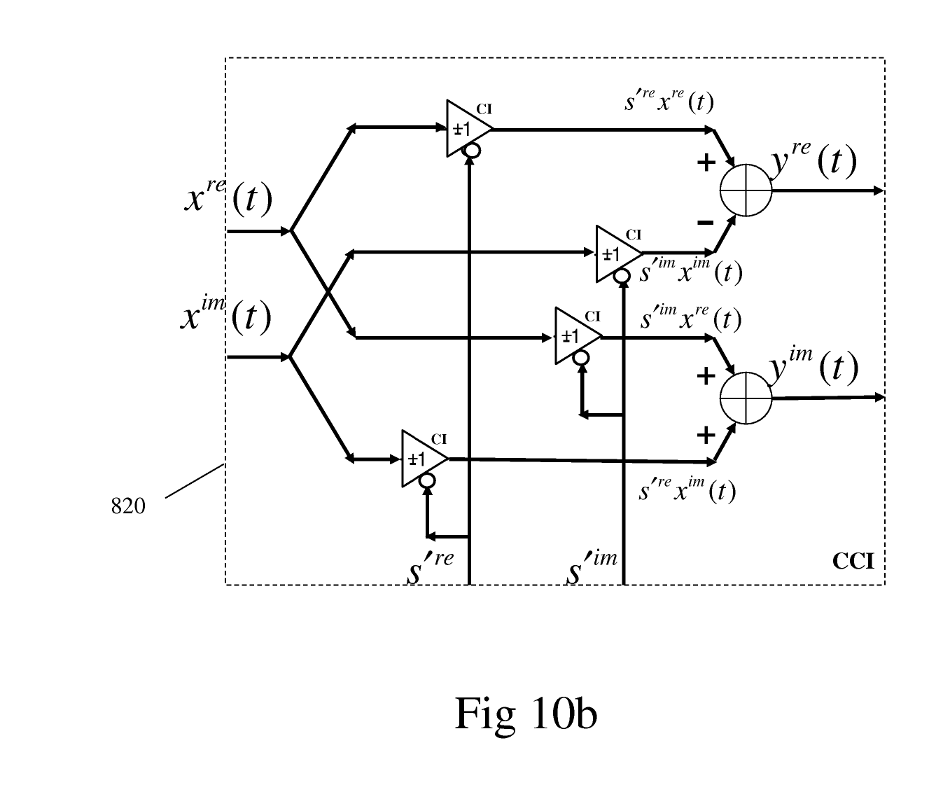

FIG. 10a illustrate some internal details of CI 920 according to an embodiment of the current invention. A CI 920 is a mixed-signal device essentially effecting multiplication by +/−1 of its analog input, as controlled by a control bit input: Let x(t) be the CI analog input, then its analog output is y(t)=sx(t) with s=1−2bε{+1,−1} where bε{0,1} is the control bit, i.e. the CI switches the polarity of its analog input when the control bit is 1 and leaves the polarity unchanged when the control bit is 0

FIG. 10b illustrate some internal details of CCI 820 according to an embodiment of the current invention. A CCI is a mixed-signal module comprising four CIs interconnected such as to perform a multiplication of a complex-valued input analog waveform {tilde under (x)}(t)=x^{re}(t)+jx^{im}(t) against the QPSK complex constellation symbol {tilde under (s)}ε{1,j,−1,0−j} where j=\sqrt{−1}. The two-wire analog input to the CCI is then a pair of signals {x^{re}(t),x^{im}(t)} representing the complex valued {tilde under (x)}(t) (complex numbers are denoted by an undertilde). The control digital input to the CCI consists of two bits {b^{re},b^{im}} uniquely representing a complex symbol out of a 45°-rotated QPSK complex constellation e^{jπ/4}{1,j,−1,j}, with the digital encoding following the Gray Code (whereby two adjacent constellation points differ by just one bit), e.g. {tilde under (s)}′=e^{jπ/4} [symbol] 00, {tilde under (s)}′=je^{jπ/4} [symbol] 10, {tilde under (s)}′=−e^{jπ/4} [symbol] 11, {tilde under (s)}′=−je^{jπ/4} [symbol] 01.

A notational convention of this disclosure is that a prime on s denotes the rotation of the constellation by 45°, i.e. s′εe^{jπ/4}{1,j,−1,−j} as opposed to an un-rotated QPSK complex constellation sε{1,j,−1,−j}. In QPSK work is convenient to transition to 45°-rotated QPSK complex constellation symbols {tilde under (ŝ≡{tilde under (ŝe^{jπ/4}, since in the original symbols the real and imaginary parts are tri-valued {0,−1,+1}, whereas the rotated symbols have real and imaginary parts that are bipolar, i.e. equal to ±1, up to an inconsequential factor of \sqrt{2}.

Let {y^{re}(t),y^{im}(t)} denote two-wire analog output of the CCI module. In complex notation we may then describe the CCI input-output mapping as
y^{re}(t)+jy^{im}(t)={tilde under (y)}(t)=\sqrt{2}{tilde under (s)}′{tilde under (x)}(t)=[\sqrt{2}s^{re}x^{re}(t)−\sqrt{2}s′^{im}x^{im}(t)]+j[\sqrt{2}s′^{im}x^{re}(t)+\sqrt{2}s′^{re}x^{im}(t)] i.e.
y^{re}(t)=\sqrt{2}s′^{re}x^{re}(t)−\sqrt{2}s′^{im}x^{im}(t)
y^{im}(t)=\sqrt{2}s′^{im}x^{re}(t)+\sqrt{2}s′^{re}x^{im}(t)
where it was convenient to absorb in the gain factor \sqrt{2}, since \sqrt{2}s′^{re}, \sqrt{2}s′^{im}ε{−1,+1} with these antipodal ±1 elements, describing the real and imaginary parts of the 45°-rotated complex constellation symbols, uniquely related to control bits {b^{re}, b^{im}} by
{\sqrt{2}s′^{re},\sqrt{2}s′^{im}}={2b^{re}−1,2b^{im}−1}ε{−1,+1}

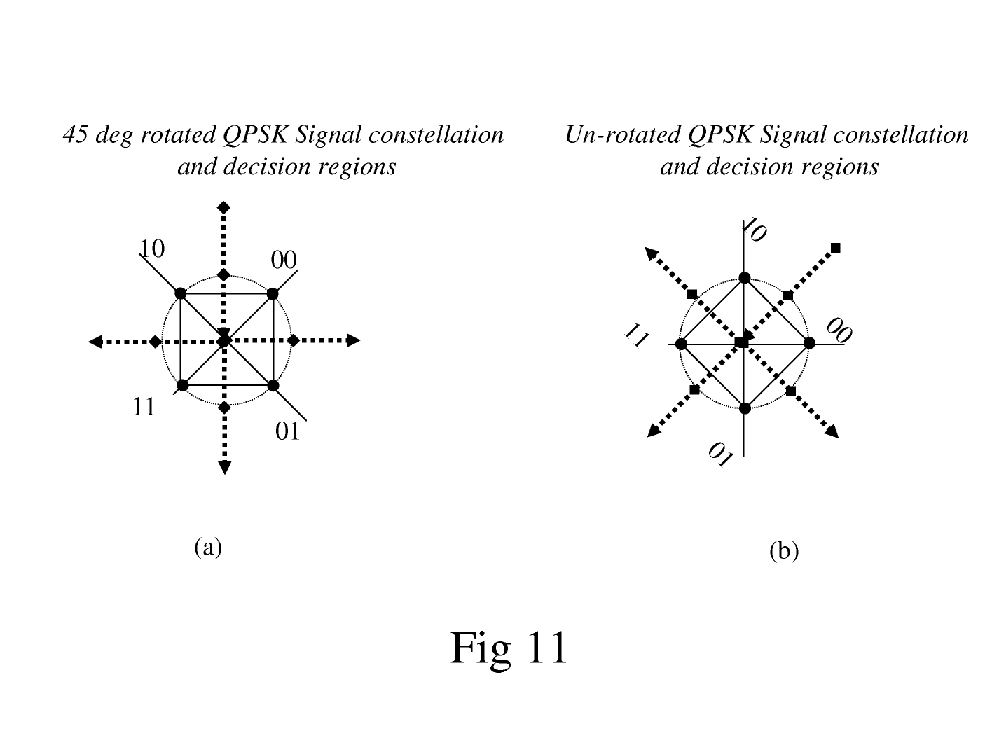

FIG. 11 depicts the QPSK complex constellation symbol, FIG. 11a for 45 deg rotated QPSK Signal constellation and decision regions; and FIG. 11a for un-rotated QPSK Signal constellation and decision regions.

It is apparent that each pair of bits is uniquely associated with a QPSK complex constellation symbol (FIG. 11). It is readily verified that taking {b^{re},b^{im}} in sequence to cycle through the Gray Code, {00,10,11,01} we get the \sqrt{2}s′^{re}+j\sqrt{2}s′^{im} cycling through the Q-DPSK constellation

$$\{ 1 , j , - 1 , - j \} {ⅇ}^{jπ / 4} = \{ \frac{1 + j}{\sqrt{2}} , \frac{- 1 + j}{\sqrt{2}} , \frac{- 1 - j}{\sqrt{2}} , \frac{1 - j}{\sqrt{2}} \} .$$

The first bit of the Gray code indicates the sign of the real part of the constellation point whereas the second bit of the Gray code indicates the sign of the imaginary part of the constellation point, with the bit 0 indicating positive sign and the bit 1 indicating negative sign. Notice that this is consistent the four CIs comprising the CCIs being designed such that each CI effects a sign inversion when its control bit is 1, and it leaves the sign unchanged when its control bit is 0.

It is important to note that the Gray Code representations of sε{1,j,−1,−j} and of the 45°-rotated symbol s′≡se^{jπ} are identical:
{tilde under (s)}=1 [symbol] 00 [symbol] {tilde under (s)}′≡e^{jπ/4}
{tilde under (s)}=j [symbol] 10 [symbol] {tilde under (s)}′≡je^{jπ/4}
{tilde under (s)}=−1 [symbol] 11 [symbol] {tilde under (s)}′≡−e^{jπ/4}
{tilde under (s)}=−j [symbol] 01 [symbol] {tilde under (s)}′≡−je^{jπ/4}

This indicates that if we may generate the Gray code representation of {b^{re}, b^{im}} un-rotated symbol {\sqrt{2}s^{re},\sqrt{2}s^{im}}={1−2b^{re},1−2b^{im}} and directly apply this pair of control bits to the CCI, even though we are actually interested in evaluating the complex product {tilde under (x)}(t){tilde under (s)}′ of {tilde under (x)}(t)=x^{re}(t)+jx^{im}(t) with a 45°-rotated complex constellation symbol, {tilde under (s)}′=\sqrt{2}s′^{re}+j\sqrt{2}s′^{im}

The Soft-Processing Function—Generation of Decision Statistics Linear in the DI Outputs:

At this point let us state the overall soft-processing function of the SP module: The objective is to generate one or two decision variables at the outputs of the one or two adders, expressible as certain linear combination(s) of the analog inputs to the soft-processor (the DI outputs). The coefficients of the linear combinations, i.e. the weights of each of the DI outputs in the linear combinations are always +/−1, valued, as determined as Boolean functions of a moving window of the decision feedback bitstream as worked out by the logic controller in the DFL (in some cases the sign +/−1 applied to each DI output is directly determined by a single particular bit of the decision feedback, i.e. the DFL is trivial).

SP Operation as Additive Correction onto the Main DI Outputs:

In particular, the one or two main DIs with delay T, corresponding to a conventional DPSK system, are always weighted by unity in the linear combinations forming the decision variables. This last mentioned characteristic leads to a pragmatic interpretation of the operation of this family of embodiments: Let us partition the set of multiple DIs of the DFE in this family of embodiments into the one or two “main” DIs with delay T vs. the “auxiliary” DIs with longer delays (2T, . . . (D−1)T). The action of soft-processor may then be viewed as an analog additive correction applied to the output(s) of “main DI(s) of to a conventional DPSK system. As derived in the Theory of Operation subsection below, these correction(s) are equivalent to the estimation of a cleaner (lower phase noise) phase reference out of the longer D-chip observation window. The additive correction(s) applied onto the output(s) of the main DI(s) is (are) generated as particular linear combination(s), namely signed additions (additions and subtractions) of the outputs of the auxiliary DIs, with weights +/−1 determined by Boolean functions of the DF bitstream. At discrete-time k, the inputs to the Boolean function determining the weighting coefficients are the previous bit decisions bₖ₋₁^{re}, bₖ₋₂^{re}, . . . b_{k-(D-2)}^{re} for B-DPSK (and also bₖ₋₁^{im}, bₖ₋₂^{im}, . . . b_{k-(D-2)}^{im} for Q-DPSK). Conceptually, and possibly also in the implementation itself, we generate the corrective linear combinations, using CI or CCI modules fed by outputs of the auxiliary DIs.

In order to describe the array of CI or CCI modules used to feed the two adders generating the decision variables, let us introduce a mathematical description of these variables (the validity of which is derived in the Theory of Operation Section). Distinguishing between the Q-DPSK and B-DPSK cases, we start with the more complex Q-DPSK case.

The Soft-Decision Decision Variables and the Decision Law (for Q-DPSK):

The SP module of the taught receiver processes out of the DI outputs improved complex-decision variable of the form of eqs. (32) and (33) derived further below in the Theory of Operation section, repeated here for convenience:

$$\begin{matrix}{{V}_{∼}}_{k}^{′} = {q}_{T}^{′} [ k ] + {q}_{2 T} [ k ] {\hat{{s}_{∼}}}_{k - 1}^{*} {ⅇ}^{jπ / 4} + {q}_{3 T} [ k ] {\hat{{s}_{∼}}}_{k - 2}^{*} {\hat{{s}_{∼}}}_{k - 1}^{*} {ⅇ}^{jπ / 4} + \\ {q}_{4 T}^{′} [ k ] {\hat{{s}_{∼}}}_{k - 3}^{*} {\hat{{s}_{∼}}}_{k - 2}^{*} {\hat{{s}_{∼}}}_{k - 1}^{*} {ⅇ}^{jπ / 4} + … \\ = {q}_{T}^{′} [ k ] + {q}_{2 T} [ k ] {\hat{{s}_{∼}}}^{*} [ k - 2 , k - 1 ] {ⅇ}^{jπ / 4} + \\ {q}_{3 T} [ k ] {\hat{{s}_{∼}}}^{*} [ k - 3 , k - 1 ] {ⅇ}^{jπ / 4} + …\end{matrix}$$

or in terms of real and imaginary parts
{tilde under (V′)}ₖ^{re}=q′_{T}^{re}[k]+Δ{tilde under (V)}′ₖ^{re},{tilde under (V′)}ₖ^{im}=q′_{T}^{im}[k]+Δ{tilde under (V)}′ₖ^{im} (4)
where
Δ{tilde under (V)}′ₖ^{re}=Re{q_{2T}[k]{tilde under (ŝ*[k−2,k−1]e^{jπ/4}}+Re{q_{3T}[k]{tilde under (ŝ[k−3,k−1]e^{jπ/4}}+ . . .
Δ{tilde under (V)}′ₖ^{im}=Im{q_{2T}[k]{tilde under (ŝ*[k−2,k−1]e^{jπ/4}}+Im{q_{3T}[k]{tilde under (ŝ[k−3,k−1]e^{jπ/4}}+ . . .(5)

Here, as before q′_{T}^{re}[k],q′_{T}^{im}[k] denotes the respective balanced electrical outputs of the main in-phase and in-quadrature balanced DIs of delay T (with phase biases ±45°), and q_{mT}^{re}[k],q_{mT}^{im}[k] denote the respective balanced electrical outputs of the auxiliary in-phase and in-quadrature balanced DIs of delay T delays mT, with m=2, 3, . . . , D−1, (with phase biases 0°, 90° i.e. un-rotated) i.e. each pair of quadrature DIs is associated with a complex-valued output. Notice that the main DI outputs are 45°-rotated, as in conventional Q-DPSK, however for the auxiliary DIs we use un-rotated versions, with q_{mT}^{re}[k],q_{mT}^{im}[k] representing the outputs of two DIs with delay mT, in quadrature, the first one biased at 0° differential phase-shift, while the second one is biased at 90° differential phase-shift.

It is apparent that the linear combination Δ{tilde under (V)}′ₖ^{re},Δ{tilde under (V)}′ₖ^{im} represent the corrections to be applied to the main DI outputs q′_{T}^{re}[k],q_{T}^{im}[k] based on the auxiliary DI outputs. In eq. 2 we also introduced the (45°-rotated and conjugated) complex rotation increments
{tilde under (ŝ′*[n,k]={tilde under (ŝₙ₊₁*{tilde under (ŝₙ₊₂* . . . {tilde under (ŝₖ*e^{jπ/4},n<k,
describing the rotation of the DPSK symbols in the interval [n,k] as
{tilde under (ŝ′*[k−2,k−1]={tilde under (ŝₖ₋₁*e^{jπ/4},
{tilde under (ŝ′*[k−3,k−1]={tilde under (ŝₖ₋₂*{tilde under (ŝₖ₋₁*e^{jπ/4},
{tilde under (ŝ′*[k−4,k−1]={tilde under (ŝₖ₋₃*{tilde under (ŝₖ₋₂*{tilde under (ŝₖ₋₁*e^{jπ/4}, etc.(6)

Here {tilde under (ŝₖε{1,j,−1,−j} denotes the complex constellation form of the decision on the QPSK transmitted symbol.

It is apparent that the corrections to the main DI outputs are linear combinations of the auxiliary DI outputs, with coefficients determined by the complex-rotation increments of the complex-decisions.

The slicer Revisited:

It is the complex decision variable {tilde under (V)}′ₖ={tilde under (V)}′ₖ^{re}+j{tilde under (V)}′ₖ^{im}, i.e. the pair {{tilde under (V)}′ₖ^{re},{tilde under (V)}′^{im}} that is generated by the SP (the outputs of the two adders). These outputs are provided by the outputs of the soft-processor unit, leading to the Slicer, or more precisely, it is the slicer that samples the two analog signals on the SP output wires and generates the two samples {tilde under (V)}′ₖ^{re}, {tilde under (V)}′ₖ^{im}. The sampler then makes sign decisions upon these samples:
{\hat{b}ₖ^{re},\hat{b}ₖ^{im}}={1+sgn{tilde under (V)}′ₖ^{re},1+sgn{tilde under (V)}′ₖ^{im}}/2 (7)a
i.e. the slicer generates a pair of decision bits that are respectively 1,0, depending on whether {tilde under (V)}′ₖ^{re}, {tilde under (V)}′ₖ^{im} are ±1. The two bitstreams {\hat{b}ₖ^{re},\hat{b}ₖ^{im}} represent the output of the receiver, and are also tapped to provide the two inputs to the Decision Feedback Loop (DFL). An alternative form to write the decision law is

$${\hat{{s}_{∼}}}^{′} = \frac{sgn {{V}_{∼}}^{′ re} + j sgn {{V}_{∼}}^{′ im}}{\sqrt{2}} ∈ \{ 1 , j , - 1 , - j \} {ⅇ}^{jπ / 4} \qquad ( 8 ) b$$

where {tilde under (ŝ′ [symbol] {\hat{b}ₖ^{re},\hat{b}ₖ^{im}} is a complex decision symbol out of the 45°-rotated complex constellation.
The Soft-Processing (SP) Revisited:

Eqs. (4), (5), (7) are derived in the Theory of Operation section. Here, assuming their validity, we verify that the wiring diagrams of FIG. 9 for B-DPSK and FIG. 8 for Q-DPSK indeed implement these expressions.

Starting with the more complex (but higher performance) Q-DPSK embodiment:

For conventional Q-DPSK eqs. (5) reduce to {tilde under (V)}′ₖ^{re}=q′_{T}^{re}[k], {tilde under (V)}′ₖ^{im}=q′_{T}^{im}[k], i.e. the decision variables are the two outputs of the main DIs. For DF multi-chip Q-DPSK the main DI outputs must be additively corrected by linear combinations of the auxiliary DIs as given eqs. (5), rewritten as

$$Δ {V}^{re} ≡ {\sum }_{m = 2}^{D - 1} Re \{ {q}_{mT} [ k ] {\hat{{s}_{∼}}}^{*} [ k - m , k - 1 ] {ⅇ}^{jπ / 4} \}$$

$$Δ {V}^{im} ≡ {\sum }_{m = 2}^{D - 1} Im \{ Re \{ {q}_{mT} [ k ] {\hat{{s}_{∼}}}^{*} [ k - m , k - 1 ] {ⅇ}^{jπ / 4} \} \}$$

The summand signals Re{q_{mT}[k]{tilde under (ŝ′[k−m,k]}, Im{{tilde under (q)}_{mT}[k]{tilde under (ŝ′[k−m,k]}, for m=2, 3, . . . , D−1 in these additive corrections, are realized in FIG. 8 as the signals on the two output wires of a CCI module with analog inputs given by the real and imaginary parts of {tilde under (q)}_{mT}[k], i.e. it is the outputs {q_{mT}^{re}[k],q_{mT}^{im}[k]} of the two DIs with delay mT that feed each CCI module. The CCI digital control inputs are the real and imaginary parts of {tilde under (ŝ*[k−m,k−1]e^{jπ/4}, i.e. [Re{{tilde under (ŝ*[k−m,k−1]e^{jπ/4}},Im{{tilde under (ŝ*[k−m,k−1]e^{jπ/4}}]. Notice that these are antipodal (bipolar signals) that may encoded as a bit pair generated by the digital controller of the DFL module as explained further below.

As m=2, 3, . . . , D−1, number of CCI devices is D−2. The two outputs of each CCI are separately routed to the two adders, as shown: The one adder fed by q′_{T}^{re}[k], receives all the real parts of the CCI outputs, whereas the other adder, fed by q′_{T}^{im}[k] q′_{T}^{re}[k], receives all the imaginary parts of the CCI outputs. The adders then generate two analog signals, the samples of which are

$${{V}_{∼}}_{k}^{re} = {{q}_{∼}}_{T}^{′ re} [ k ] + {\sum }_{m = 2}^{D - 1} Re \{ {q}_{mT} [ k ] {{\hat{s}}_{∼}}^{*} [ k - m , k - 1 ] {ⅇ}^{jπ / 4} \} \\ {{V}_{∼}}_{k}^{im} = {{q}_{∼}}_{T}^{′ im} [ k ] + {\sum }_{m = 2}^{D - 1} Im \{ {q}_{mT} [ k ] {{\hat{s}}_{∼}}^{*} [ k - m , k - 1 ] {ⅇ}^{jπ / 4} \} \qquad ( 9 )$$

The implementation of FIG. 8 for general D, then comprises D−2 CCI modules, labeled m=2, 3, . . . , D−1, with the m^{-th} CCI fed by the two outputs {q_{mT}^{re}[k],q_{mT}^{im}[k]} of the m-th pair of DIs and by the control bits {b^{re}[k−m,k],b^{im}[k−m,k]} corresponding to the bipolar signals [Re{{tilde under (ŝ*[k−m,k−1]e^{jπ/4}},Im{{tilde under (ŝ*[k−m,k−1]e^{jπ/4}}] as generated by the DFL digital logic.

Decision Feedback Loop (DFL):

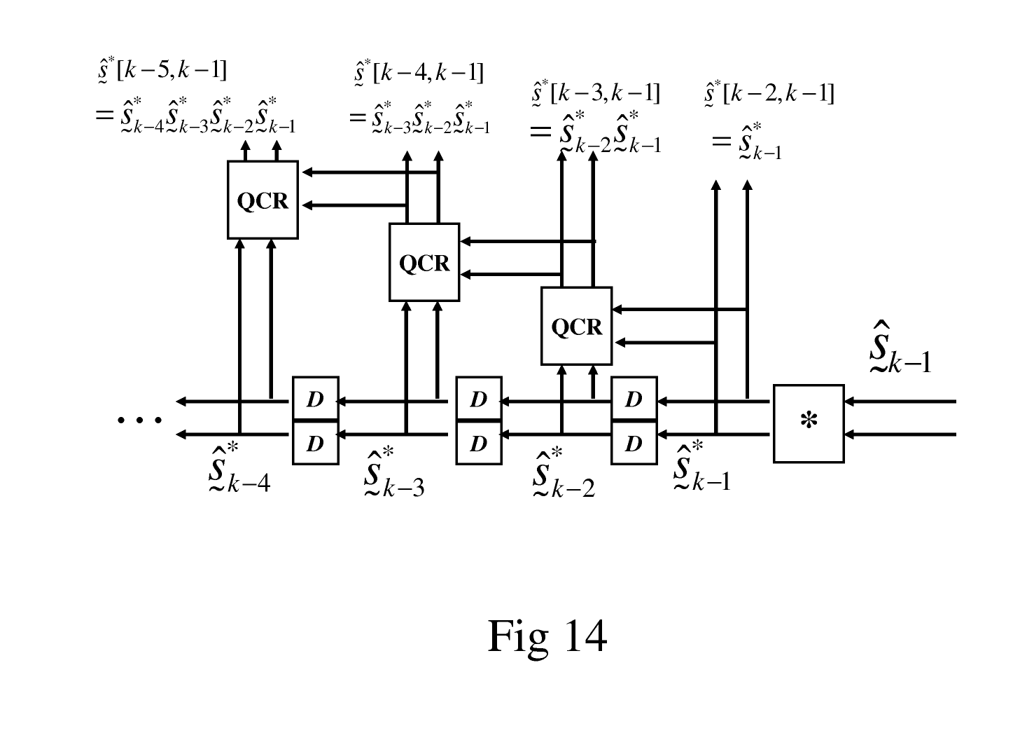

FIG. 14 depicts some internal details of the DFL according to an embodiments of the current invention.

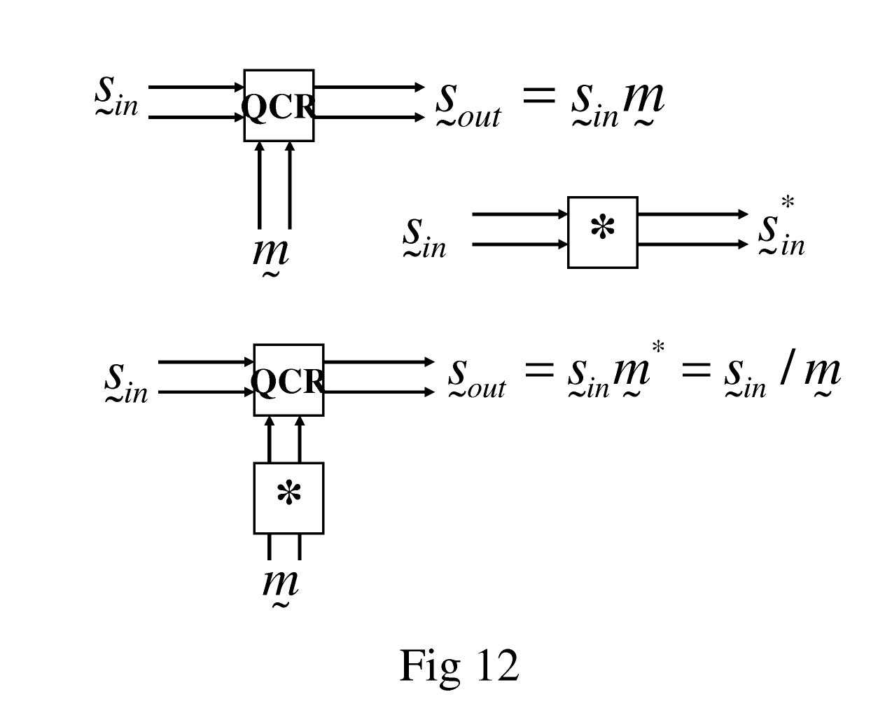

FIG. 12 depicted the operation of element QCR and D denotes a delay.

The DFL is fed by decision bitstreams {\hat{b}ₖ^{re},\hat{b}ₖ^{im}} in the Q-DPSK case (FIG. 14) and by a single bitstream {\hat{b}ₖ} in the B-DPSK case. The role of the DFL is to digitally process the decision feedback converting it into a form suitable for application to the SP.

Q-DPSK: Treating here the Q-DPSK case, the DFL generates the bit-pair representations corresponding to the following complex rotation increments [Re{{tilde under (ŝ*[k−m,k−1]e^{jπ/4}},Im{{tilde under (ŝ*[k−m,k−1]e^{jπ/4}}], m=1, 2, . . . D−1 which are applied as inputs into the CCI modules of the SP.

Generally, complex-valued 45°-rotated and conjugated rotation increments over the interval [n,k] may be expressed as

$$\begin{matrix}\begin{matrix}{{\hat{s}}_{∼}}^{′ *} [ n , k ] = {\prod }_{l = n + 1}^{k} {{\hat{s}}_{∼}}_{l}^{*} {ⅇ}^{jπ / 4} \\ = {\{ {\prod }_{l = 1}^{k} {{\hat{s}}_{∼}}_{l} \}}^{*} \{ {\prod }_{l = 1}^{n} {{\hat{s}}_{∼}}_{l} \} {ⅇ}^{jπ / 4} \\ = {s}^{*} [ 0 , k ] s [ 0 , n ] {ⅇ}^{jπ / 4} \\ = {ⅇ}^{jπ / 4} s [ 0 , n ] / s [ 0 , k ]\end{matrix} \\ where & ( 10 ) \\ s [ 0 , k ] ≡ {\prod }_{l = 1}^{k} {{\hat{s}}_{∼}}_{l} , or {s}^{*} [ 0 , k ] ≡ {\prod }_{l = 1}^{k} {{\hat{s}}_{∼}}_{l}^{*} & ( 11 )\end{matrix}$$

is the cumulative rotation from time zero up to time k, which may be recursively generated by repeated multiplication:
{tilde under (ŝ[0,k]={tilde under (ŝ[0,k−1]{tilde under (ŝₖ.(12)

From eqs. (10), (12) the generic rotation increment may be expressed as
{tilde under (ŝ*[k−m,k−1]={tilde under (ŝ*[0,k−1]{tilde under (ŝ[0,k−m]={tilde under (ŝ[0,k−m]/{tilde under (ŝ[0,k−1]
with
{tilde under (ŝ[0,k−1]={tilde under (ŝ[0,k−2]{tilde under (ŝₖ₋₁
(eq. 11 delayed by one discrete-time unit).

To this end {tilde under (ŝ[0,k−1] must be generated by feedback to a multiplier via a one unit delay (denoted by D) then delayed by m in order to generate {tilde under (ŝ[0,k−m]. We then conjugate {tilde under (ŝ[0,k−1] and multiply by the delayed version {tilde under (ŝ[0,k−m] or equivalently we divide {tilde under (ŝ[0,k−m] by {tilde under (ŝ[0,k−1].

However, such a digital hardware implementation of these equations would require too many elements and in this family of embodiment we prefer to implement the rotation increments non-recursively, as described below, which is more efficient. In fact we shall use expressions similar to (10)-(12) in other families of embodiments, with these expressions realized electro-optically.

Returning now to the electronic realization of the DFL, we must generate first few rotation increments as given in eq. (6).

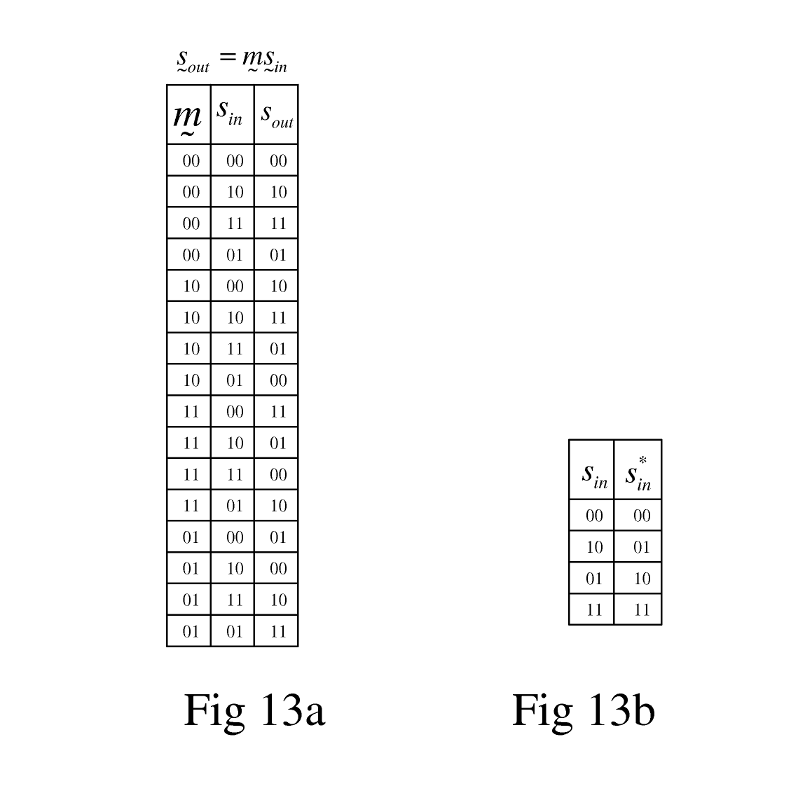

It is apparent that a basic building block required for the generation of the rotation increments is the QPSK Constellation Rotator (QCR) (FIG. 12) implementing the complex multiplication {tilde under (s)}ᵢₙ{tilde under (m)}={tilde under (s)}ₒᵤₜ where {tilde under (s)}ᵢₙ,{tilde under (s)}ₒᵤₜ,{tilde under (m)}ε{1,j,−1,−j} all belong to an (un-rotated) QPSK constellation, essentially the four-element rotation group. All of the complex symbols of the four-element rotation group are uniquely represented by the Gray codewords out of the list {00, 01, 11, 10}, therefore we may build the QCR multiplier in terms of the respective Gray code digital representations of the input, output and the multiplication factor. The QCR is then a digital combinational device with four inputs (the two pairs of bits corresponding to {tilde under (s)}ᵢₙ,{tilde under (m)}) and two outputs (the pair of bits corresponding to so {tilde under (s)}ₒᵤₜ) In fact the multiplication is implemented as a cyclic right-shift of the Gray Code list {00, 10, 11, 01}, with the step size of the shift determined by {tilde under (m)}. We then have the following truth table (FIG. 13) digitally representing sᵢₙ{tilde under (m)}=sₒᵤₜ. It is also useful to develop the truth table for the conjugation of a QPSK constellation symbol in the Gray Code (FIG. 13). Just the elements 10 and 01 (corresponding to ±j) get mapped into each other, whereas (00, 11) (corresponding to ±1) remain unchanged.

FIG. 13a depicts a truth table digitally representing sᵢₙ{tilde under (m)}=sₒᵤₜ.

FIG. 13a depicts a truth table digitally representing the conjugation of a QPSK constellation symbol in the Gray Code.

Note: Another possibility is to convert the Gray Code to regular binary code, and effect the rotation within the four-element group as addition-modulo 4, then convert back to Gray Code, as it turns out that the Gray Code is a more natural representation of the rotation increments in these systems, whereas the rotation is more naturally represented as modulo-4 addition. In our system, the conversion from Gray to regular binary code would be performed at the inputs and outputs of the DFL, with the rotations within the DFL executed in regular binary code.

It is also useful to directly write a truth-table (and to construct an appropriate device, for example by hard wiring) for the divider within the modulo-4 group {1,j,−1,−j} in the Gray representation (omitted).

Else the divider may be implemented as a QCR multiplier with a complex-conjugator on one of the arms, corresponding to the divisor (FIG. 12).

Now that we have covered the building blocks, we consider the overall embodiment of the Q-DPSK DFL, as shown in FIG. 14, making use of an arrangement consisting of a delay line and QCR multipliers, in order to generate the collection of successive rotation increments, {tilde under (ŝₖ₋₁*, {tilde under (ŝₖ₋₂*{tilde under (ŝₖ₋₁*, {tilde under (ŝₖ₋₃*{tilde under (ŝₖ₋₂*{tilde under (ŝₖ₋₁*, . . . by an arrangement of delay line and non-recursive multipliers. These products form the outputs of the DFL module, feeding the CCIs in the SP module.

By now we have the full Q-DPSK receiver description of the main modules (DFI, SP, DFL, Slicer), their internals as well as their interconnects.

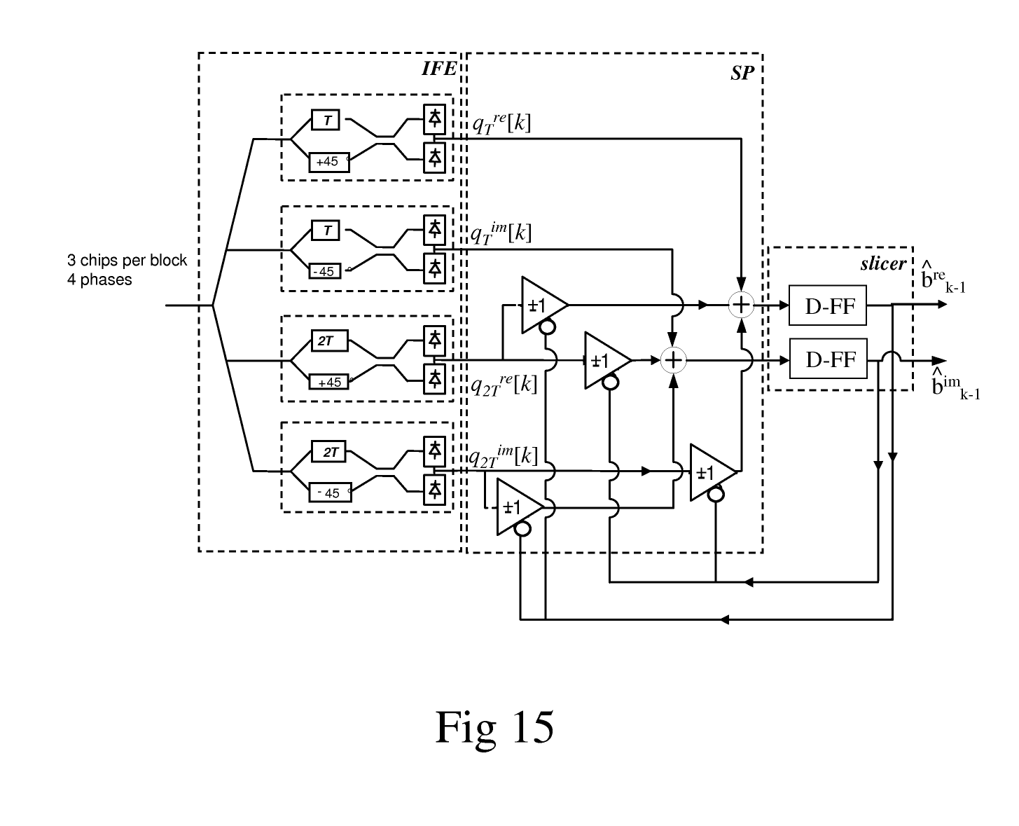

FIG. 15 then applies these structures to exemplify the general description by presenting the block diagram embodiment of a specific Q-DPSK system (M=4) for the particular value of D=3 chips.

It remains to describe in detail the B-DPSK case, which is simpler to implement.

B-DPSK Embodiments of the First Family:

For B-DPSK there is no need to effect 45° rotations in either the DIs or in the generation of rotation symbols in the DFL. All DIs have phase biases 0°, the B-DPSK constellation is now real, consisting of the symbols s=±1, and we must now generate (see the theory of operation section) the decision variable
Vₖ=q_{T}[k]+ΔV(13)
as the output q_{T}[k] of the main DI, additively corrected by a term linear in the outputs of the auxiliary DIs of longer delays:

$$\begin{matrix}Δ V = {\sum }_{m = 2}^{D - 1} \{ {\prod }_{l = 1}^{m - 1} {\hat{s}}_{k - m + l} \} {q}_{mT} [ k ] \\ = {q}_{2 T} [ k ] \hat{s} [ k - 2 , k - 1 ] + {q}_{3 T} [ k ] \hat{s} [ k - 3 , k - 1 ] + \\ {q}_{4 T} [ k ] \hat{s} [ k - 4 , k - 1 ] + … + {q}_{mT} [ k ] \hat{s} [ k - m , k - 1 ] + \\ … + {q}_{( D - 1 ) T} [ k ] \hat{s} [ k - ( D - 1 ) , k ]\end{matrix} \qquad ( 14 )$$

Finally, the decision bit is obtained by making a sign decision on the decision variable (13), formally expressed as
\hat{b}ₖ=1+sgnVₖ.

The rotation increment is given in this case, by real-valued multiplications:
ŝ[k−m,k−1]=sₖ₋ₘ₊₁s_{k-m+2 . . .} sₖ₋₁ (15)

As all the symbols are bipolar, sₖ=±1, the multiplications within the group {−1,1}, generating the rotation increments, are isomorphic with additions modulo 2, with the correspondence between unipolar bits bε{0,1} and bipolar symbols sε{−1,+1} being s [symbol] b:0 [symbol] +1, 1 [symbol] −1.

This means that we may use Boolean circuits: the multiplier sₒᵤₜ=msᵢₙ is reduces to a modulo-2 addition bₒᵤₜ=bₘ⊕bᵢₙ or XOR gate. Now the rotation increment of eq. (15) simply corresponds to the parity of the bits in the interval [k−m,k−1]:
ŝ[k−m,k−1] [symbol] bₖ₋ₘ₊₁⊕bₖ₋ₘ₊₂⊕ . . . ⊕bₖ₋₁

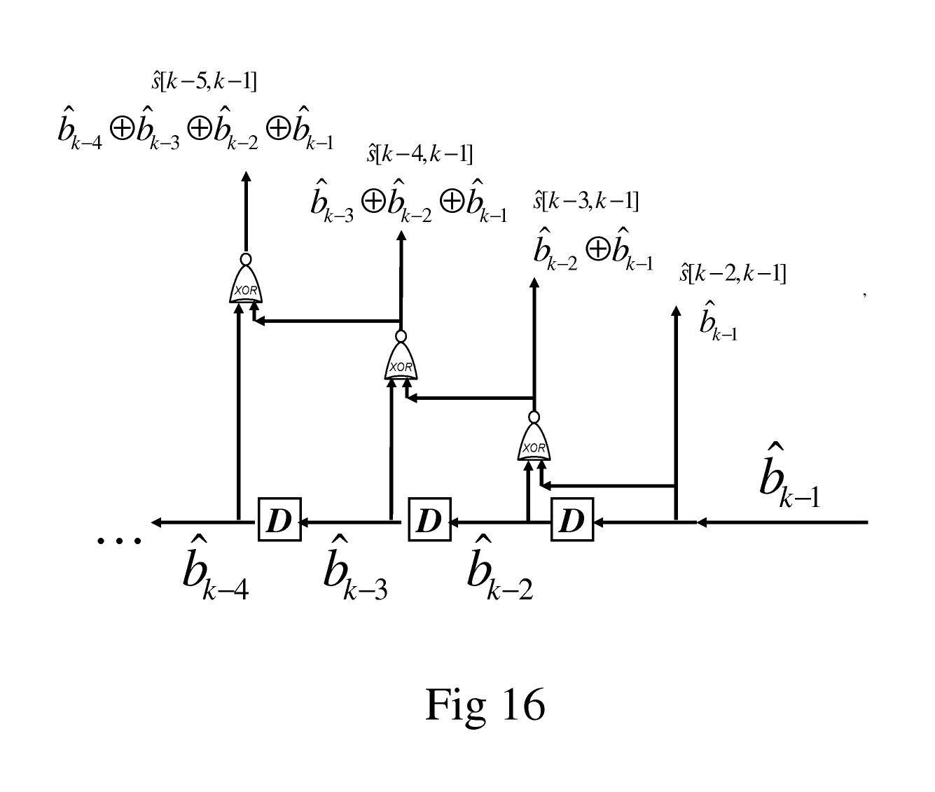

FIG. 16, illustrating the DFL for B-DPSK, comprising the generation of rotation increments, which is the essential functionality of the DFL.

In this figure the outputs of the DFL, namely the rotation increments, are alternatively labeled as unipolar bits (b-notation) and as bipolar symbols (s-notation), consistent with the correspondence between the two representations.

As for the B-DPSK SP FIG. 9), the CCIs of the Q-DPSK embodiments, are now replaced by real-valued CIs, effecting the multiplications q_{mT}[k]ŝ[k−m,k−1], where ŝ[k−m,k−1]=±1, as generated by the DFL. There is now a single adder performing the summations indicated in eq. (13), (14) by summing up the main DI output q_{T}[k] with an additive correction ΔV consisting of the sum of all the CI outputs, each generating the products q_{mT}[k]ŝ[k−m,k−1]=±q_{mT}[k].

The decision variable may also be expressed as
Vₖ=q_{T}[k]±q_{2T}[k]±q_{3T}[k] . . . ±q_{(D-1)T}[k] (16)
with the signs ± determined by the rotation increments in the DFL.

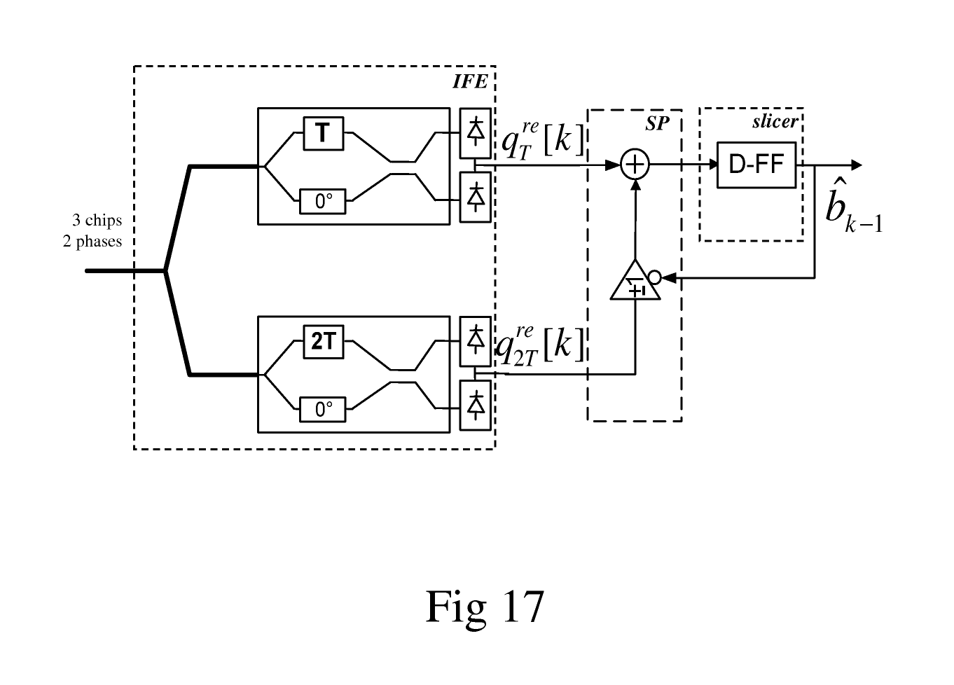

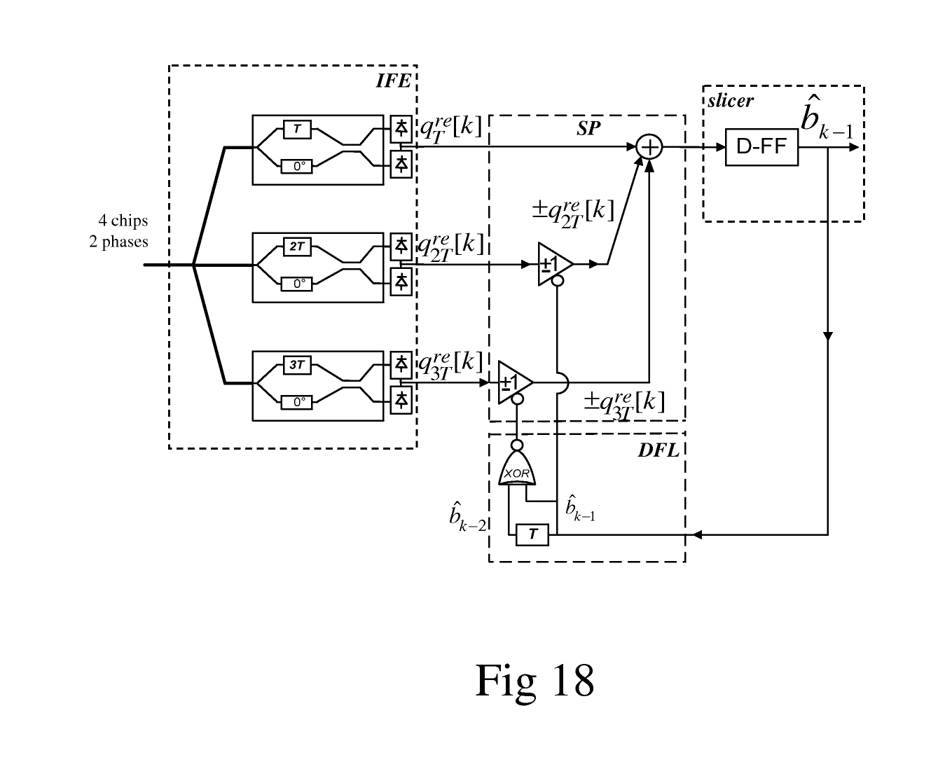

Specific embodiments for M=2 (B-DPSK) and D=3, 4 are shown in FIGS. 17, 18 respectively. It is apparent that B-DPSK D=3(4) chips we now require just 2(3) DI devices in the DFE module, and single addition and one (two) controlled inverter(s) in the SP module, a single sign-decision in the slicer module, and the DFL is trivial for D=3 (degenerates to just a through wire) and is very simple for D=4 (just a XOR gate and a delay).

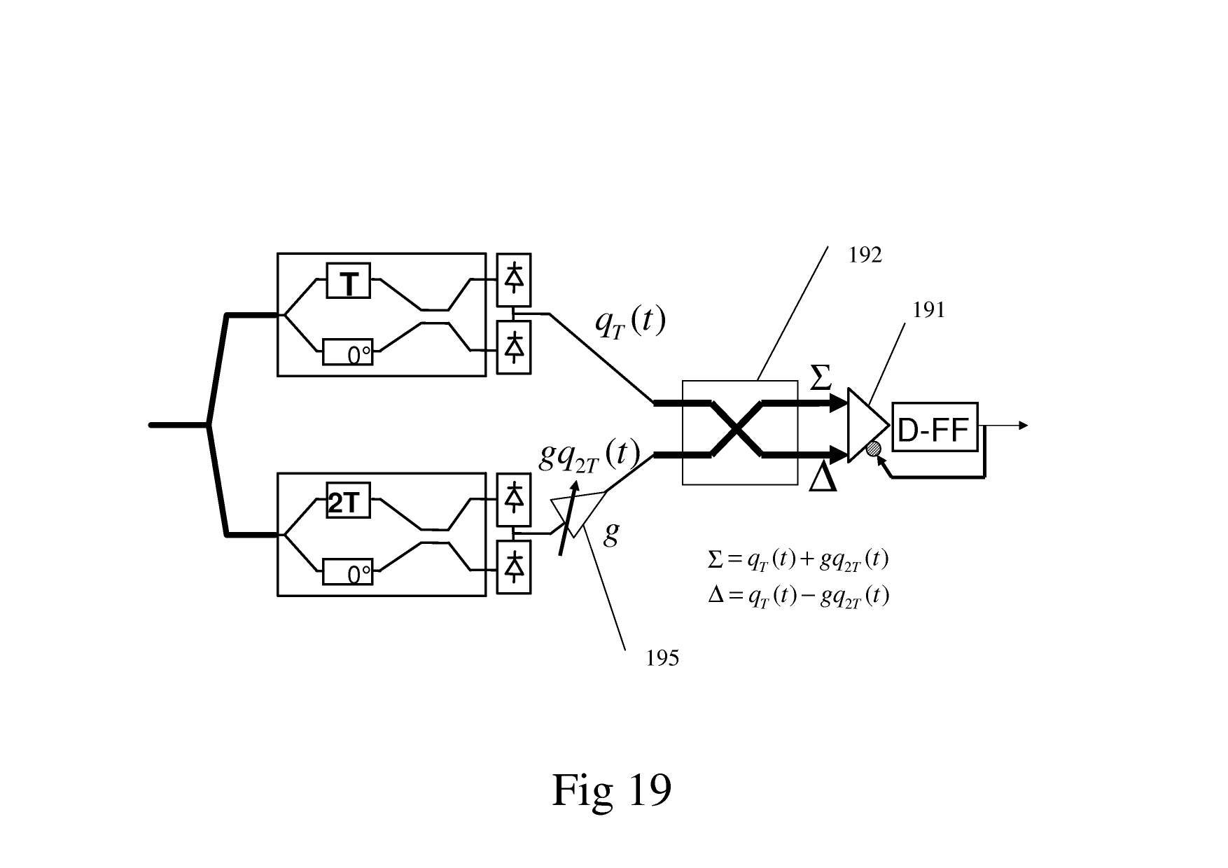

An alternative embodiment using CIs for B-DPSK is shown in FIG. 19. In this scheme the CI is replaced by a two-state RF switch 191 selecting one of the analog inputs and routing it to the output under the control of one bit. The two-state switch is preceded by a 180° electrical hybrid 192, as detailed in FIG. 20—this is an electrical or electronic two-port device implementing the linear transformations
Σ=x₁(t)+x₂(t),Δ=x₁(t)−x₂(t) (17)

Such RF device may be realized passively as this is a well-known component in RF and microwave prior art. However, it might be difficult to realize a 180° electrical hybrid over a very broad band starting at DC. Instead the ultra-broadband hybrid it may be effectively realized by a pair of broadband amplifiers, in various connectivity arrangements, as shown schematically in FIG. 20a, is realized as seen in figures 20b-d, employing summing amplifiers, differential amplifiers, summing junctions or with 180 deg phase-shifters. These embodiments of the 180° electrical hybrid are just specific examples, multiple other implementations may exist for the two-port characteristics of eq. (17).

To see why the implementation of FIG. 19 equivalent to that of FIG. 17, notice that as we switch between Σ,Δ, under the control bit, we provide OUT=x₁(t)±x₂(t)=x₁(t)+sx₂(t), where s=±1. In our case x₁=q_{T}^{re}[k] and x₂=q_{2T}^{re}[k], implementing
Vₖ=q_{T}[k]±q_{2T}[k]=q_{T}[k]+sq_{2T}[k]
which evidently implements eq. (16).

In the embodiment of FIG. 19 it is useful to implement Shortest Propagation Delays, feeding the output of the D-FF to the control of the RF-switch and feeding the RF switch into the D-FF. This improves the quality of the decision feedback.

Also indicated in the FIG. 19 is a tunable gain/attenuation 195, affecting gain/attenuation “g” to the signal q_{2T}(t), which might be useful to optimize performance. The extra gain can make up for some delay which is a fraction of a chip. Dispersion and other effects call for different than unity g-factor.

Theory of Operation—for the First Family of Embodiments

The DF concept as used in DPSK wireless communications [9-11] consists of improving the quality of the current decision using past receiver decisions, which are assumed correct, i.e. pretending that those decisions represent the actually transmitted signals.

Our DF optimal receiver, motivated by the improved quality reference, may be shown to be mathematically equivalent with the seemingly different abstract receiver structures of [9-11] derived from entirely different considerations, however the improved reference phase estimation interpretation and ensuing integrated-optics realizations are our novel contributions. It does not follow from prior art electronic works on decision feedback how to build a direct detection optical receiver, since in wireless communication one has access to the phase of the electro-magnetic wave, whereas in optics the phase information is not detectible by direct detection. Although the usage of delay interferometers to this problem might be suggested by their emergence in conventional DPSK, it is not obvious at all how to use delay interferometers in the context of decision feedback. One approach was taken in [12]. In our invention here we take a different approach, introducing additional delay interferometers, but simplifying the post-detection electronics.

As discussed in [13], the noise variance of the DPSK Phase Difference (PD) decision statistic is the sum of phase noise variances in the two adjacent symbols—the information and reference have the same SNR, degrading self-homodyne by about 3 dB relative to homodyne PSK. In principle, if a precise estimate of the phase of the last symbol reference were available, the performance of DPSK would coincide with that of coherently detected (homodyne) PSK, since the variance of the phase noise difference would be cut in half, as one of the two terms in this difference is now rendered perfect. By feeding back the previous, mostly correctly decoded, signals, a better phase reference is extracted and effectively used to improve upon the conventional noisy phase of the previous (reference) symbol. In essence, the reference symbol phase estimate, generated out of previous observations and decision feedback, better approximates the perfect Local Oscillator (LO) available in actual coherent detection. Such improved phase detection scheme would in principle be more immune against any source of phase noise, be it the phase noise induced by the additive optical amplifier Amplified Spontaneous Emission (ASE), the laser phase noise of the optical source, or the non-linear phase noise induced in the fiber link by the Gordon-Mollenauer effect. These intuitive statements are formalized by formulating a Maximum Likelihood (ML) decision law, maximizing the following decision variable over the transmission index a:

$$α = {arg max }_{α} {w}_{k}^{( α )} \\ where \qquad ( 18 )$$

$$\begin{matrix}{w}_{k}^{( α )} ≡ & Re \{ {r}_{∼ k} {{R}^{*}}_{∼ k - 1} {ⅇ}^{- j Δ {μ}_{k}^{( α )}} \} \\ = & Re \{ {r}_{∼ k} {{R}^{*}}_{∼ k - 1} {{s}^{*}}_{∼ k} \} \\ = & \vert {r }_{∼ k} \vert \vert {R }_{∼ k - 1} \vert cos ( ∠ {r }_{∼ k} , ∠ {R }_{∼ k - 1} - {Δμ}_{k}^{( α )} ) ,\end{matrix} \qquad ( 19 )$$

$$\begin{matrix}{{R}_{∼}}_{k - 1} ≡ {\sum }_{m = 1}^{D - 1} {ⅇ}^{j {\sum }_{l = 1}^{m - 1} □ Δ {\hat{μ}}_{k - m + l}} {{r}_{∼}}_{k - m} \\ = {\sum }_{m = 1}^{D - 1} {\prod }_{l = 1}^{m - 1} {\hat{{s}_{∼}}}_{k - m + l} {{r}_{∼}}_{k - m} \\ = {\sum }_{m = 1}^{D - 1} \hat{s} [ k - m , k - 1 ] {{r}_{∼}}_{k - m}\end{matrix} \qquad ( 20 )$$

Here Δμₖ^{(α)}=μₖ−μₖ₋₁−2π/Mα, 0≦α≦M−1 are the transmitted Phase Differences (PDs) defining complex information symbols, {tilde under (s)}ₖ≡e^{jΔμ}^{ₖ}^{^{(α)}} are complex rotation symbols describing the relative rotations of the transmission phasors in each symbol interval, {tilde under (r)}ₖ={tilde under (A)}ₖe^{jθ}+{tilde under (n)}ₖ is the received noisy sample in the k-th chip, with θ the carrier phase offset, {tilde under (n)}ₖ is circular Gaussian additive noise of variance 2σ², and the noiseless sample at discrete time k is recursively expressed as

$$\begin{matrix}{{A}_{\sim}}_{k} = {A}_{s} {ⅇ}^{{jμ }_{k}} \\ = {A}_{s} {ⅇ}^{j ( Δ {μ}_{k}^{( α )} + {μ}_{k - 1} )} \\ ≡ {{s}_{\sim}}_{k} {{A}_{\sim}}_{k - 1}\end{matrix} \qquad ( 21 )$$

Δ\hat{μ}_{μ-m+l} are prior decisions on the phases, {tilde under (R)}ₖ₋₁ is a reference phasor generated in terms of prior observations {tilde under (r)}ₖ₋ₘ and prior decisions {tilde under (ŝₖ₋ₘ₊ₗ that are fed back into the current decision. It is these formulas that are embodied in the DF MC-DPSK optimal receiver block diagram embodiments.

For D=2 {tilde under (R)}ₖ₋₁ reduces to the regular DPSK reference, {tilde under (r)}ₖ₋₁, i.e. the statistic wₖ^{(α)} reduces to the DPSK one. For D=3, 4, 5 the reference (4) amounts to:
(D=3): {tilde under (R)}ₖ₋₁={tilde under (r)}ₖ₋₂{tilde under (ŝₖ₋₁+{tilde under (r)}ₖ₋₁
(D=4): {tilde under (R)}ₖ₋₁={tilde under (r)}ₖ₋₃{tilde under (ŝₖ₋₂{tilde under (ŝₖ₋₁+{tilde under (r)}ₖ₋₂{tilde under (ŝₖ₋₁{tilde under (r)}ₖ₋₁ (22)
(D=5): {tilde under (R)}ₖ₋₁={tilde under (r)}ₖ₋₄{tilde under (ŝₖ₋₄{tilde under (ŝₖ₋₃{tilde under (ŝₖ₋₂{tilde under (ŝₖ₋₁+{tilde under (r)}ₖ₋₃{tilde under (ŝₖ₋₂{tilde under (ŝₖ₋₁+{tilde under (r)}ₖ₋₂{tilde under (ŝₖ₋₁+{tilde under (r)}ₖ₋₁

We note that (1) is reminiscent of a coherent detection cross-term for {tilde under (r)}ₖ, with LO {tilde under (R)}ₖ₋₁ which reduces to {tilde under (r)}ₖ₋₁ for conventional DPSK. For D>2 it is possible to prove that ∠{tilde under (R)}ₖ₋₁ coincides with the optimal ML estimate for the noiselessly received phase of the k−1-th reference chip, providing a better estimate than ∠{tilde under (r)}ₖ₋₁ (the noisy phase of the previous chip, used as self-homodyne reference in standard DPSK).

To intuitively understand the phase estimate improvement, notice that the received phasors {tilde under (r)}ₖ₋ₘ,{tilde under (r)}ₖ₋ₘ₊₁, . . . , {tilde under (r)}ₖ₋₁ cumulatively accrue the phases of prior decisions at k−m+1,k−m+2, . . . , k−1, such that these phasors are all rotated in approximate alignment with {tilde under (r)}ₖ₋₁ (only perturbed by the phase noise), hence the signal amplitude is coherently reinforced to ∝D−1, whereas the noise contributions add up on an rms basis ∝\sqrt{D−1}. Indeed, taking the expectation of eq. (20) while assuming correct feedback:

$$〈 {{R}_{∼}}_{k - 1} 〉 ≡ {\sum }_{m = 1}^{D - 1} {\prod }_{l = 1}^{m - 1} {{s}_{∼}}_{k - m + l} {{A}_{∼}}_{k - m} .$$

Now, using eq. (21) we have

$${\prod }_{l = 1}^{m - 1} {{s}_{∼}}_{k - m + l} {{A}_{∼}}_{k - m} = {s}_{∼} [ k - m , k - 1 ] {{A}_{∼}}_{k - m} = {{A}_{∼}}_{k - 1} , \\ yielding \\ 〈 {{R}_{∼}}_{k - 1} 〉 = {\sum }_{m = 1}^{D - 1} {{A}_{∼}}_{k - 1} = ( D - 1 ) {{A}_{∼}}_{k - 1} \qquad ( 23 )$$

It is apparent the signal amplitude component of the reference is coherently reinforced to D−1 times the noiseless phasor {tilde under (A)}ₖ₋₁ (the mean of the regular DPSK reference) whereas the noise contributions add up on an rms basis ∝\sqrt{D−1}. Hence, in the asymptotic limit D→∞, the (rms) SNR of the reference evolves as O(\sqrt{D}) tending to a perfectly clean effective optical LO, equivalent to a local oscillator (LO) in coherent PSK homodyne, i.e. DF MC-DPSK performance tends to coherent homodyne for a sufficiently large number of chips.

In summary, the DF MC-DPSK technique amounts to emulating coherent detection while avoiding the complexity of an actual LO laser and associated optical Phase-Locked Loop (PLL). To attain effective coherent homodyne behavior, it suffices to directly detect multiple interferometer outputs with delays spanning a longer observation window, and to soft-process these outputs aided by decision feedback, in effect opto-electronically synthesizing the coherent reference.

The Theory of Operation of the First Family of Embodiments:

We now show how the theoretical optical decision law outlined above maps onto the opto-electronic receiver structures embodied in the first family of embodiments.

Distinguishing between B-DPSK and Q-DPSK, we commence with the Q-DPSK case:

Q-DPSK Theory of Operation:

The decision statistic (19) in the decision law (18) may be equivalent expressed as
wₖ^{(α)}≡Re{e^{jπ/4}{tilde under (r)}ₖ{tilde under (R)}ₖ₋₁*e^{-j(Δμ}^{ₛ}^{^{(α)}}^{+π/4)}}=Re{{tilde under (V)}ₖe^{-jΔμ′}^{ₖ}^{^{(α)}}}=|{tilde under (V)}ₖ|cos(∠{tilde under (V)}ₖ−Δμ′ₖ^{(α)}), (24)
where we multiplied (19) by e^{jπ/4} and its inverse, defined 45°-rotated constellation angles Δμ′ₖ^{(α)}=Δμₖ^{(α)}+π/4, and introduced a complex decision variable

$$\begin{matrix}{{V}_{∼}}_{k}^{′} = {ⅇ}^{jπ / 4} {{r}_{∼}}_{k} {{R}_{∼}}_{k - 1}^{*} \\ = {ⅇ}^{jπ / 4} {{r}_{∼}}_{k} {\sum }_{m = 1}^{D - 1} {\hat{s}}^{*} [ k - m , k - 1 ] {{r}_{∼}}_{k - m}^{*} \\ = {\sum }_{m = 1}^{D - 1} {{s}_{∼}}^{*} [ k - m , k - 1 ] {ⅇ}^{jπ / 4} {{r}_{∼}}_{k} {{r}_{∼}}_{k - m}^{*}\end{matrix} \qquad ( 25 )$$

It is the real and imaginary parts {tilde under (V)}′ₖ^{re},{tilde under (V)}′ₖ^{im} of the decision variable {tilde under (V)}′ₖ that are generated on the two output wires of the SP module. These two decision statistics are expressible as
{tilde under (V)}′ₖ^{re}=Re{{tilde under (r)}ₖ{tilde under (R)}ₖ₋₁*e^{jπ/4}},{tilde under (V)}′^{im}Im{{tilde under (r)}ₖ{tilde under (R)}ₖ₋₁*e^{jπ/4}}=Re{{tilde under (r)}ₖ{tilde under (R)}ₖ₋₁*e^{-jπ/4}} (26)
where the last expression for {tilde under (V)}′^{im} is more amenable to opto-electronic generation by a DI with −45° phase offset.

The 45° offset enables simplifying the decision law (18) based on the decision statistic (24):

$$\begin{matrix}\hat{α} = {arg max}_{α} {w}_{k}^{( α )} \\ = {arg max}_{α} cos ( ∠ {{V}_{\sim}}_{k}^{′} - Δ {μ}_{k}^{′ ( α )} ) \\ = {arg min}_{α} \vert ∠ {{V}_{\sim}}_{k}^{′} - Δ {μ}_{k}^{′ ( α )} \vert\end{matrix} \qquad ( 27 )$$

As Δμ′ₖ^{(α)}ε{π/4,π/2+π/4,π+π/4,3π/2+π/4}, correspond to the bisectors of each of the four quadrants, the decision boundaries now correspond with the axes of the complex plane, and the decision law of eq. (27) amounts to determining which quadrant the vector {tilde under (V)}ₖ falls in, which may be based on the sign of the real and imaginary parts of {tilde under (V)}ₖ. The receiver estimate of the transmitted rotation symbol is then

$${\hat{{s}_{∼}}}_{k}^{′} = \frac{1}{\sqrt{2}} [ sgn Re {{V}_{∼}}_{k}^{′} , sgn Im {{V}_{∼}}_{k}^{′} ] \qquad ( 28 )$$

In digital form, the decided-upon complex Q-DPSK constellation symbol {tilde under (ŝ′ₖ is represented as a pair of decision bits \hat{b}ₖ^{re}, \hat{b}ₖ^{im}, formally obtained from the decision variable by

$$[ {b}_{k}^{re} , {b}_{k}^{im} ] = \frac{1}{2} [ sgn {{V}_{∼}}_{k}^{′re} + 1 , sgn Im {{V}_{∼}}_{k}^{′im} + 1 ] ,$$

expressing the fact that we perform sign decisions on {tilde under (V)}′ₖ^{re}{tilde under (V)}′ₖ^{im}.

Now the complex decision variable (25), may be further related to the outputs of the DIs in the IFE section:

$$\begin{matrix}{{V}_{∼}}_{k}^{′} = {\sum }_{m = 1}^{D - 1} {{s}_{∼}}^{*} [ k - m , k - 1 ] {ⅇ}^{jπ / 4} {{r}_{∼}}_{k} {{r}_{∼}}_{k - m}^{*} \\ = {ⅇ}^{jπ / 4} {{r}_{∼}}_{k} {{r}_{∼}}_{k - 1}^{*} + {\sum }_{m = 2}^{D - 1} {{s}_{∼}}^{*} [ k - m , k - 1 ] {ⅇ}^{jπ / 4} {{r}_{∼}}_{k} {{r}_{∼}}_{k - m}^{*} \\ = {q}_{T}^{′} [ k ] + {\sum }_{m = 1}^{D - 1} {{s}_{∼}}^{*} [ k - m , k - 1 ] {ⅇ}^{jπ / 4} {q}_{mT} [ k ]\end{matrix} \qquad ( 29 )$$

where the complex decision variable
q′_{T}[k]=e^{jπ/4}{tilde under (r)}ₖ{tilde under (r)}ₖ₋₁*=Re{e^{jπ/4}{tilde under (r)}ₖ{tilde under (r)}ₖ₋₁*}+jRe{e^{-jπ/4}{tilde under (r)}ₖ{tilde under (r)}ₖ₋₁*}=q′_{T}^{re}[k]+jq′_{T}^{im}[k]
is formed in terms of the conventional Q-DPSK in-phase and in-quadrature DI outputs q′_{T}^{re}[k],q′_{T}^{im}[k] (with these DIs phase-biased at ±45°) and similarly, we form complex decision variables corresponding to the longer delay DIs:

$$\begin{matrix}{q}_{mT} [ k ] ≡ {{r}_{∼}}_{k} {{r}_{∼}}_{k - m}^{*} \\ = Re \{ {{r}_{∼}}_{k} {{r}_{∼}}_{k - m}^{*} \} + j Im \{ {{r}_{∼}}_{k} {{r}_{∼}}_{k - m}^{*} \} \\ = Re \{ {{r}_{∼}}_{k} {{r}_{∼}}_{k - m}^{*} \} + j Re \{ {ⅇ}^{- jπ / 2} {{r}_{∼}}_{k} {{r}_{∼}}_{k - m}^{*} \} \\ = {q}_{mT}^{re} [ k ] + j {q}_{mT}^{im} [ k ]\end{matrix} \qquad ( 30 )$$

where, according to eq. (2) (with delay mT rather than T) q_{mT}^{re}[k],q_{mT}^{im}[k] are the balanced outputs of two DIs this time with phase-biases 0° and −90° respectively, and we further absorbed the e^{-jπ/4} into the complex rotation increments by introducing −45° rotated versions
ŝ′[k−m,k−1]≡{tilde under (s)}[k−m,k−1]e^{-jπ/4}={tilde under (s)}ₖ₋ₘ₊₁{tilde under (s)}ₖ₋ₘ₊₂ . . . {tilde under (s)}ₖ₋₁e^{-jπ/4}
or +45° rotated conjugated versions of the rotation increments:
{tilde under (s)}′*[k−m,k−1]≡{tilde under (s)}*[k−m,k−1]e^{jπ/4}={tilde under (s)}ₖ₋ₘ₊₁*{tilde under (s)}ₖ₋ₘ₊₂* . . . {tilde under (s)}ₖ₋₁*e^{jπ/4}

Now, singling out the first term in the summation in (29) we express the complex decision variable as
{tilde under (V)}′ₖ=q′_{T}[k]+Δ{tilde under (V)}′ₖ
where

$$\begin{matrix}Δ {{V}_{∼}}_{k}^{′} ≡ {\sum }_{m = 1}^{D - 1} {{\hat{s}}_{∼}}^{′ *} [ k - m , k - 1 ] {q}_{mT} [ k ] \\ = {q}_{2 T} [ k ] {{\hat{s}}_{∼}}_{k - 1}^{*} {ⅇ}^{jπ / 4} + {q}_{3 T} [ k ] {{\hat{s}}_{∼}}_{k - 2}^{*} {{\hat{s}}_{∼}}_{k - 1}^{*} {ⅇ}^{jπ / 4} + \\ {q}_{4 T}^{′} [ k ] {{\hat{s}}_{∼}}_{k - 3}^{*} {{\hat{s}}_{∼}}_{k - 2}^{*} {{\hat{s}}_{∼}}_{k - 1}^{*} {ⅇ}^{jπ / 4} + …\end{matrix}$$

then the function of the SP to generate

$$\begin{matrix}{{V}_{∼}}_{k}^{′} = {q}_{T}^{′} [ k ] + {q}_{2 T} [ k ] {\hat{{s}_{∼}}}_{k - 1}^{*} {ⅇ}^{jπ / 4} + {q}_{3 T} [ k ] {{\hat{s}}_{∼}}_{k - 2}^{*} {{\hat{s}}_{∼}}_{k - 1}^{*} {ⅇ}^{jπ / 4} + \\ {q}_{4 T}^{′} [ k ] {{\hat{s}}_{∼}}_{k - 3}^{*} {{\hat{s}}_{∼}}_{k - 2}^{*} {{\hat{s}}_{∼}}_{k - 1}^{*} {ⅇ}^{jπ / 4} + … \\ = {q}_{T}^{′} [ k ] + {q}_{2 T} [ k ] {{\hat{s}}_{∼}}^{*} [ k - 2 , k - 1 ] {ⅇ}^{jπ / 4} + \\ {q}_{3 T} [ k ] {{\hat{s}}_{∼}}^{*} [ k - 3 , k - 1 ] {ⅇ}^{jπ / 4} + …\end{matrix} \qquad ( 31 )$$

or in terms of real and imaginary parts
{tilde under (V)}′ₖ^{re}=q′_{T}^{re}[k]+Δ{tilde under (V)}′ₖ^{re},{tilde under (V)}′ₖ^{im}=q′_{T}^{im}=q′_{T}^{im}[k]+Δ{tilde under (V)}′ₖ^{im} (32)
where (using Re{{tilde under (z)}*}=Re{{tilde under (z)}}, Im{{tilde under (z)}*}=−Im{{tilde under (z)}})
Δ{tilde under (V)}′ₖ^{re}=Re{q_{2T}[k]{tilde under (ŝ*[k−2,k−1]e^{jπ/4}}+Re{q_{3T}[k]{tilde under (ŝ*[k−3,k−1]e^{jπ/4}}+ . . .
Δ{tilde under (V)}′ₖ^{im}=Im{q_{2T}[k]{tilde under (ŝ*[k−2,k−1]e^{jπ/4}}+Im{q_{3T}[k]{tilde under (ŝ*[k−3,k−1]e^{jπ/4}}+ . . .(33)
i.e. eq. (32) indicates that decision variables {tilde under (V)}′ₖ^{re}, {tilde under (V)}′ₖ^{im} output by the SP consist of the outputs q′_{T}^{re}[k],q′_{T}^{im}[k] of the main DIs additively corrected by terms (eq. (33)) generated from the outputs of the auxiliary DIs as processed via the CCI modules, with the m-th CCI module being fed by DI outputs q_{mT}^{re}[k],q_{mT}^{im}[k] as well as by the (digital representations of) {tilde under (ŝ*[k−m,k−1], as explained in the Detailed Description section.

Next consider the theory of operation of the first family of embodiments for B-DPSK.

B-DPSK Theory of Operation:

In this case there is no need to apply the 45° rotation offset, which was used to reduce the Q-DPSK decision to sign decisions. In this case, the decision statistic (19) in the decision law (18) may be equivalently expressed as
wₖ^{(α)}≡Re{{tilde under (r)}ₖ{tilde under (R)}ₖ₋₁*e^{-jΔμ}^{ₖ}^{^{(α)}}}=Re{{tilde under (V)}ₖsₖ^{(α)}*}={tilde under (V)}ₖ^{re}sₖ^{(α)}, (34)
where Δμₖ^{(α)}ε{0,π}, i.e. sₖ^{(α)}=e^{jΔμ}^{ₖ}^{^{(α)}}=±1 and from (25) we express {tilde under (V)}ₖ as

$$\begin{matrix}{{V}_{∼}}_{k} ≡ {{r}_{∼}}_{k} {{R}_{∼}}_{k - 1}^{*} \\ = {{r}_{∼}}_{k} {\sum }_{m = 1}^{D - 1} {{\hat{s}}_{∼}}^{*} [ k - m , k - 1 ] {{r}_{∼}}_{k - m}^{*} \\ = {\sum }_{m = 1}^{D - 1} {{\hat{s}}_{∼}}^{*} [ k - m , k - 1 ] {{r}_{∼}}_{k} {{r}_{∼}}_{k - m}^{*} \\ = {\sum }_{m = 1}^{D - 1} {{\hat{s}}_{∼}}^{*} [ k - m , k - 1 ] {q}_{mT} [ k ]\end{matrix}$$

with q_{mT}[k] the output of the m-th DI, given by (30). As the rotation symbols are now real, ŝε{−1,+1}, we may drop the conjugation signs and the designations of complex variables, expressing the real part of {tilde under (V)}ₖ as

$$\begin{matrix}{{V}_{∼}}_{k}^{re} ≡ Re {{r}_{∼}}_{k} {{R}_{∼}}_{k - 1}^{*} \\ = {\sum }_{m = 1}^{D - 1} \hat{s} [ k - m , k - 1 ] {q}_{mT}^{re} [ k ]\end{matrix}$$

It is apparent that only the real part of {tilde under (V)}ₖ is a relevant decision statistic, generated in terms of just the in-phase DI outputs q_{mT}^{re}[k], as follows:

$$\begin{matrix}{{V}_{∼}}_{k}^{re} = {\sum }_{m = 1}^{D - 1} \hat{s} [ k - m , k - 1 ] {q}_{mT}^{re} [ k ] \\ = {q}_{T} [ k ] + \hat{s} [ k - 2 , k - 1 ] {q}_{2 T}^{re} [ k ] + \hat{s} [ k - 3 , k - 1 ] {q}_{3 T}^{re} [ k ] + …\end{matrix} \qquad ( 35 )$$

Using the form (34) of the decision statistic, the decision law (18) then reduces to a simple sign decision on the variable {tilde under (V)}ₖ^{re}:
ŝ=sgn{tilde under (V)}ₖ^{re}=±1,
formally corresponding to the decision bit

$$\hat{b} = \frac{\hat{s} + 1}{2} = \frac{sgn {{V}_{∼}}_{k}^{re} + 1}{2} ∈ \{ 0 , 1 \}$$

BER Performance and Error Propagation

To determine the Bit-Error-Rate (BER) we may adopt the analysis [9] under correct feedback, adapting it to our notation (for binary phase, M=2, and any window size D):
BER=Q[s₋,s₊]−0.5exp[−(s₊²+s₋²)/2]I₀[s₋s₊]
s_{±}≡(\sqrt{D−1}±1)s/2,ρ≡Aₛ/σ, (36)

This formula pertains to a linear AWGN channel, in our context an optically amplified beat noise limited channel neglecting fiber non-linearity. It may be shown that in the limit of large D, the MC-DPSK BER expression (36) indeed closes the gap to the coherent homodyne, BER, Q[ρ].

The combination of inline-amplifier noise and the Kerr nonlinearity induces additional phase-noise, an effect named after Gordon-Mollenauer [14,15], manifested in an impairment in differential phase detection due to the excess noise in both the received k-th chip and the phase reference derived from the previous k−1-th chip. As multi-chip DF-aided detection was shown here to “quiet down” the reference phase, it is expected that its positive impact will be even more pronounced for nonlinear transmission, yielding an even larger improvement over standard 2-chip DPSK detection relative to that obtained over linear optical channels, as modeled in (36).

A key assumption underlying (36) is that the feedback is based on correct decisions. While correct feedback improves the BER performance compared to MC-DPSK, erroneous feedback might result in error propagation, by triggering additional subsequent errors following an initial error under correct feedback. We modeled the error propagation effects by Monte-Carlo split-step Fourier simulations, repeatedly evaluating (3) and recording the number of detection errors and their positions. The simulated system comprised 40 fiber spans, with each span fully dispersion-compensated at its end. The amplifier gain was 23 dB and noise figure 6 dB. Fiber dispersion was 4 ps/nm/km, the nonlinear coefficient was taken as γ=1.4 W⁻¹km⁻¹. The simulated bit pattern consisted of an 8-bit pseudo-random bit sequence. The error histograms remarkably indicate that errors predominantly tend to appear in pairs, whereas single errors or more than two successive errors rarely occur, i.e. error propagation resulted in the doubling of the error rate compared to the case of perfect DF.

The BER performance for an optical fiber communication system, having 30 span sections separated with 20 dB amplifier gain (other parameters as before) were determined using, the multi-canonical Monte-Carlo method [16] for estimating low error probabilities. The OSNR at the optimal input power of −4 dBm was 16 dB. The error probability for each bit in the pattern was separately examined using standard 2-chip DPSK, 3-chip MC-DPSK, as well as the 3 and 4 chip DF-MC-DPSK detection schemes. For DF-MC-DPSK, correct feedback was assumed in all simulations. The tiny effect of incorrect feedback was accounted for by doubling the obtained error rate (on a linear scale), as explained above.

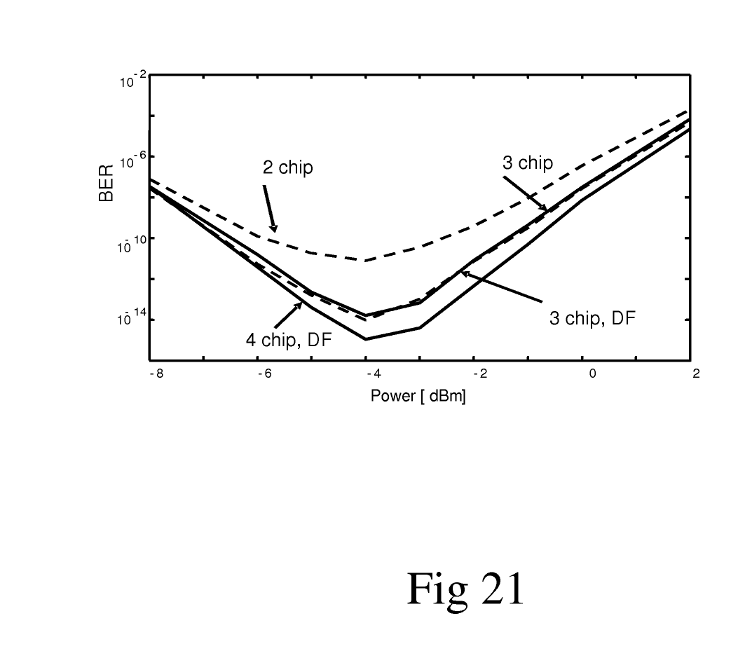

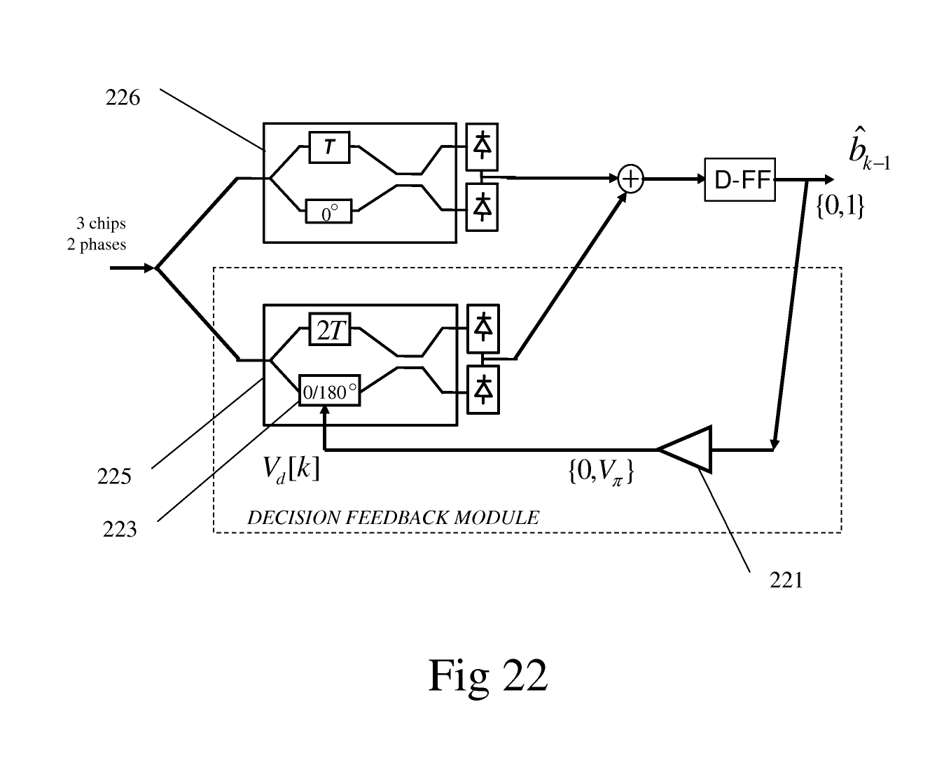

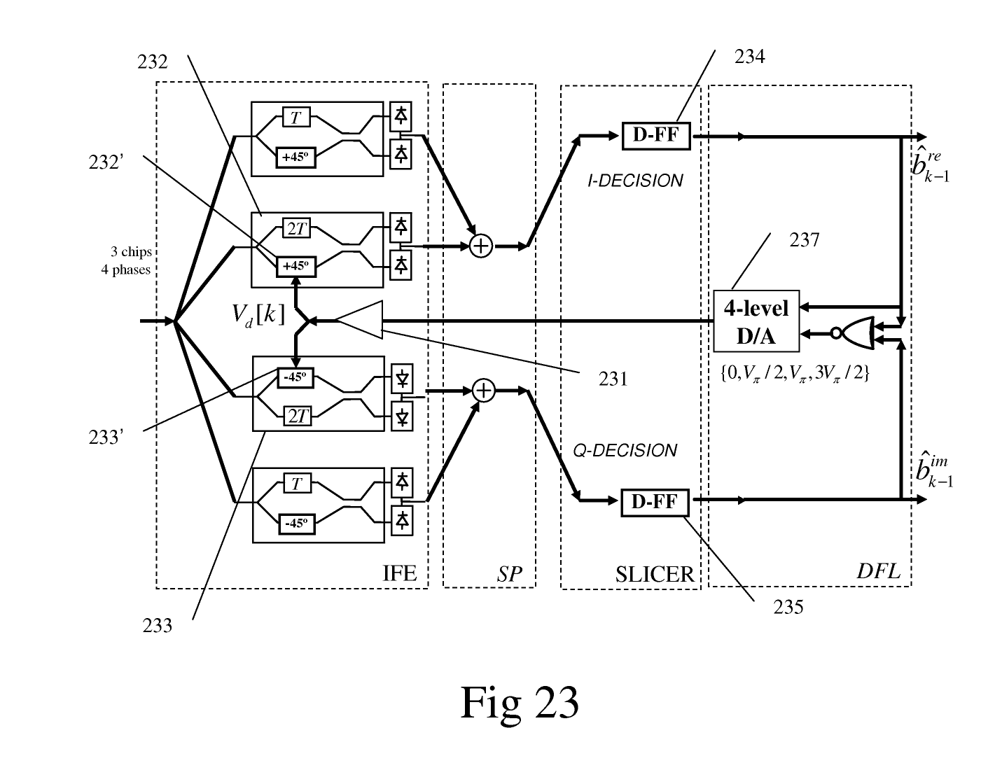

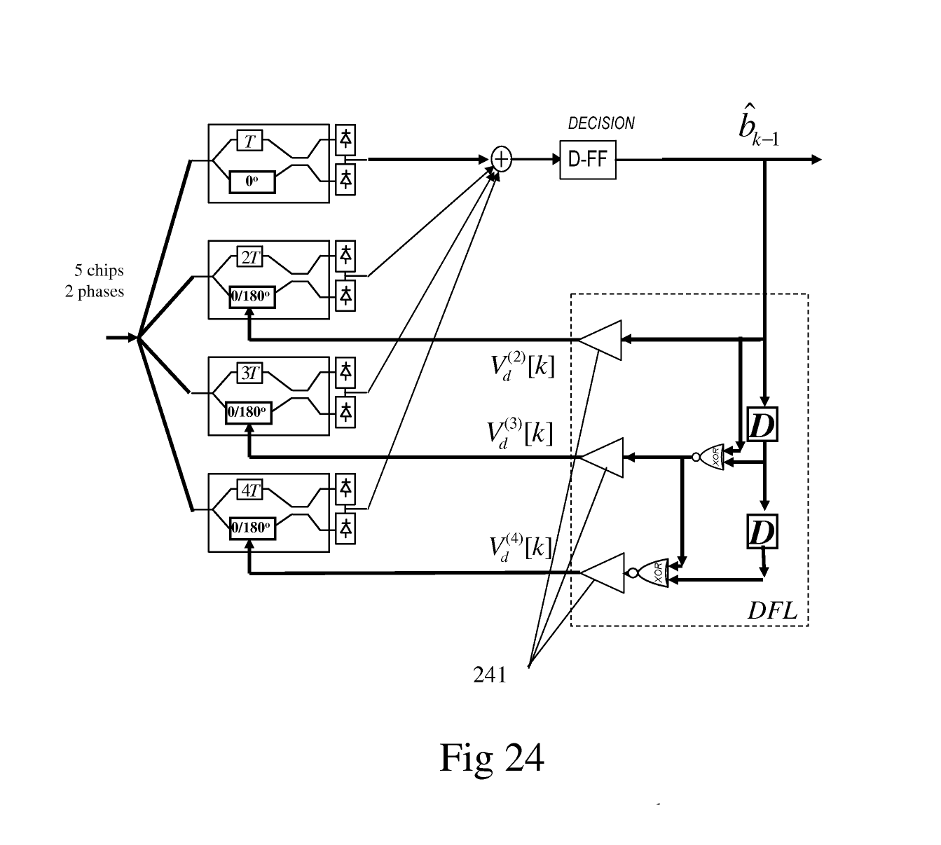

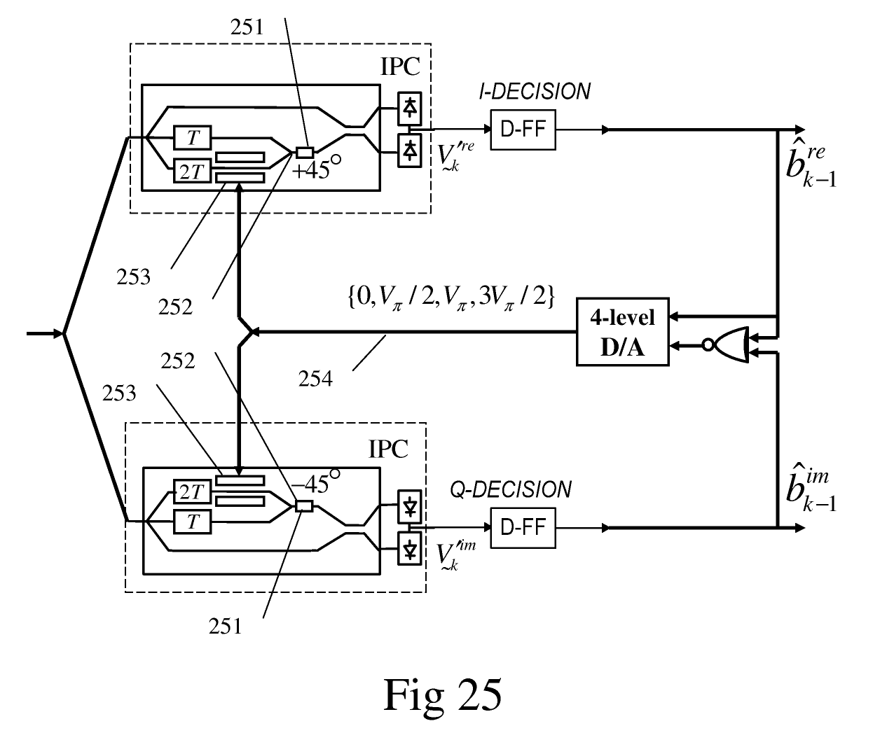

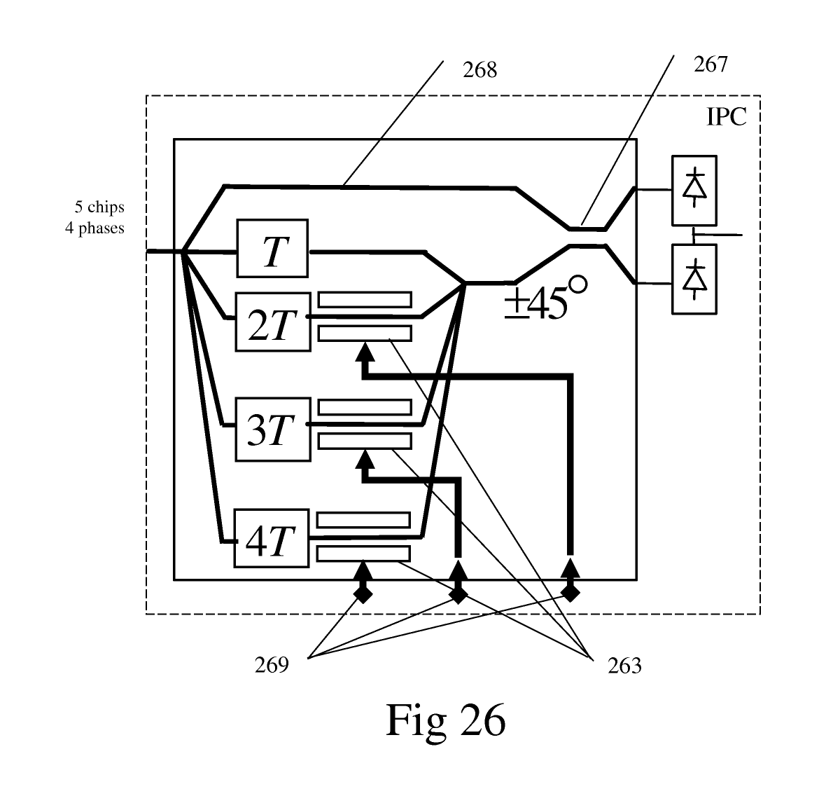

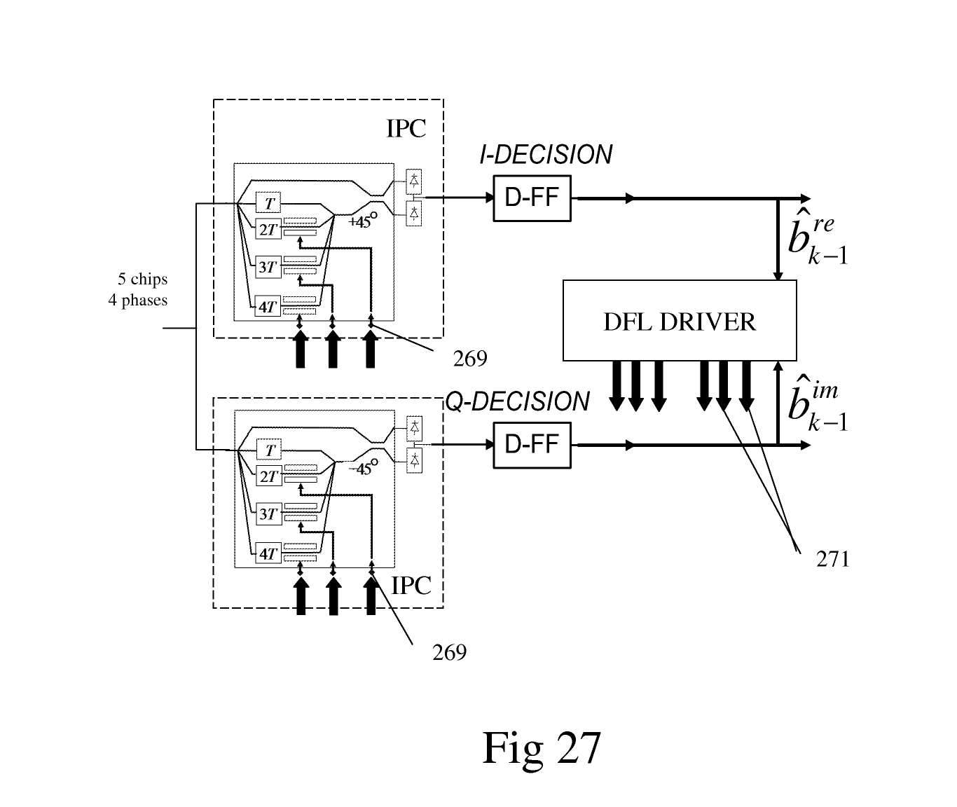

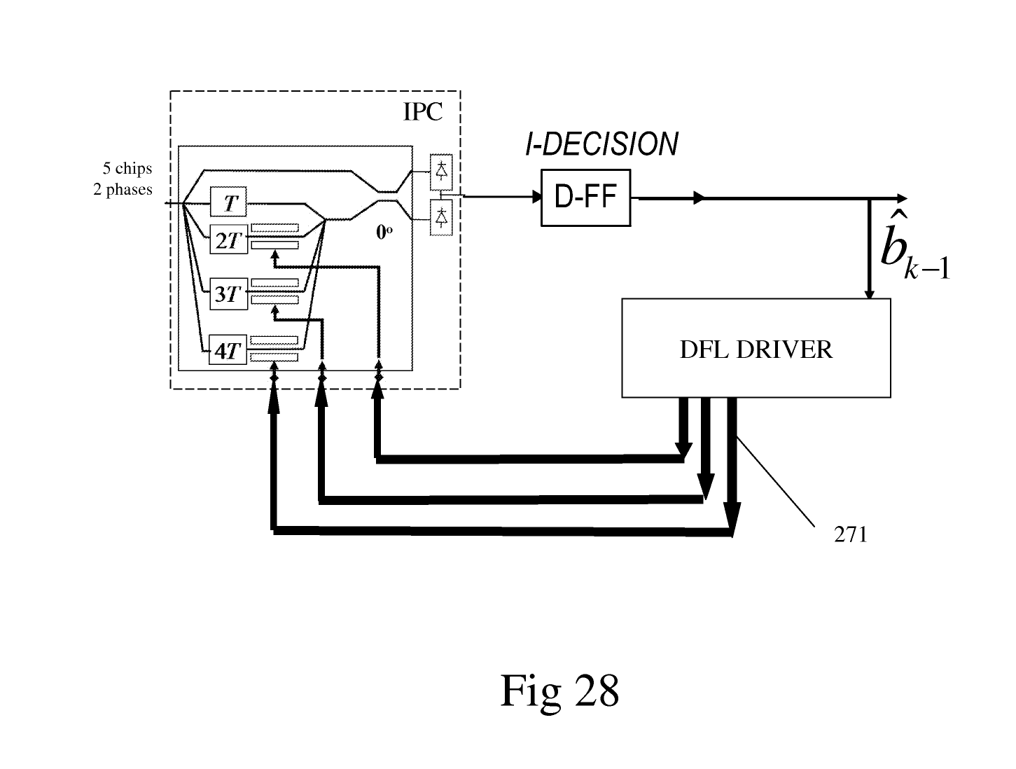

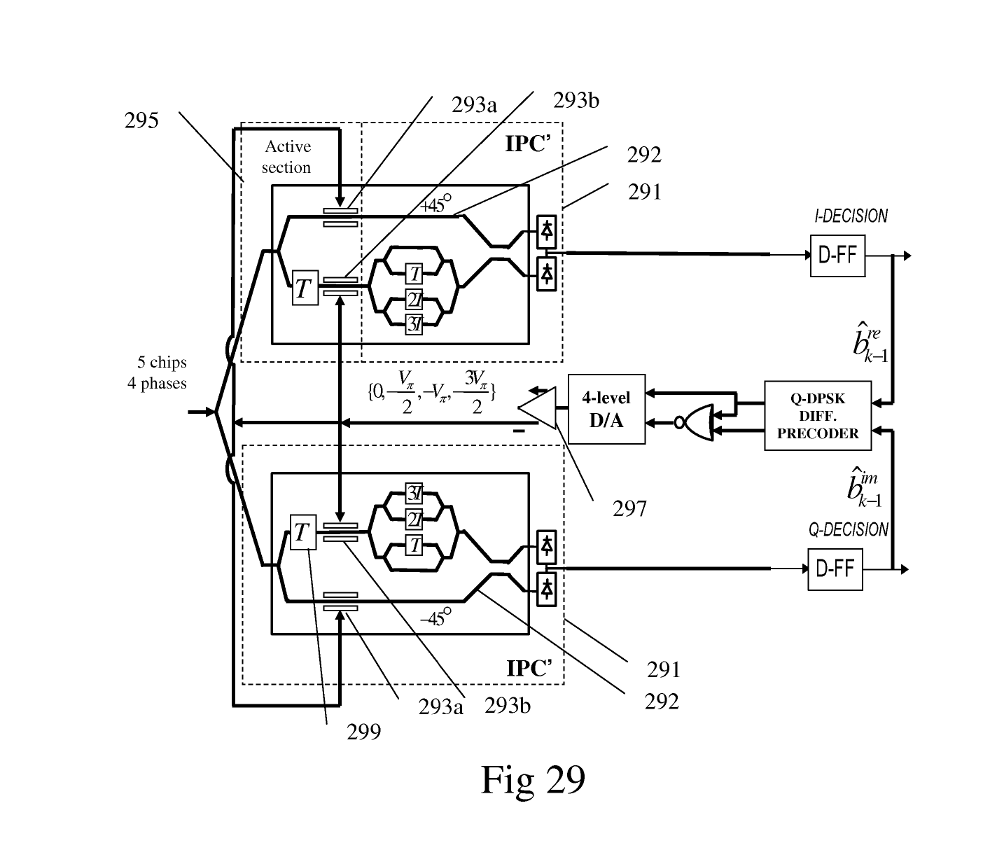

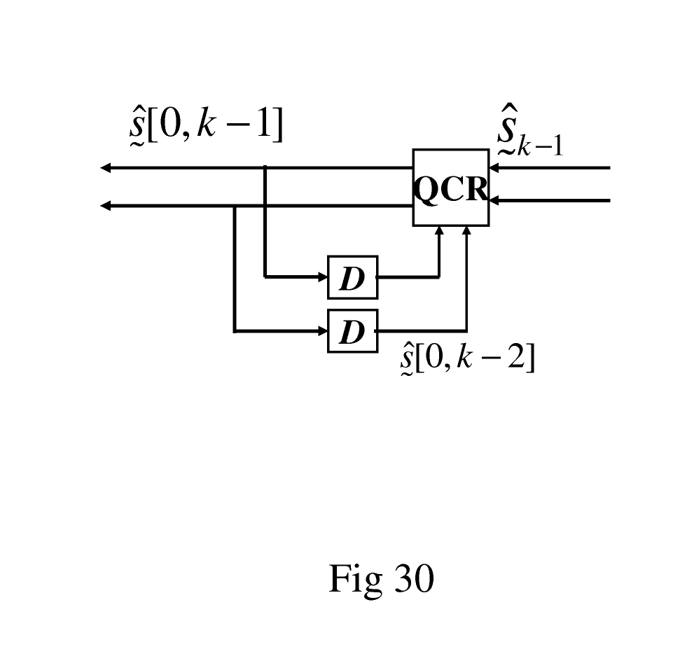

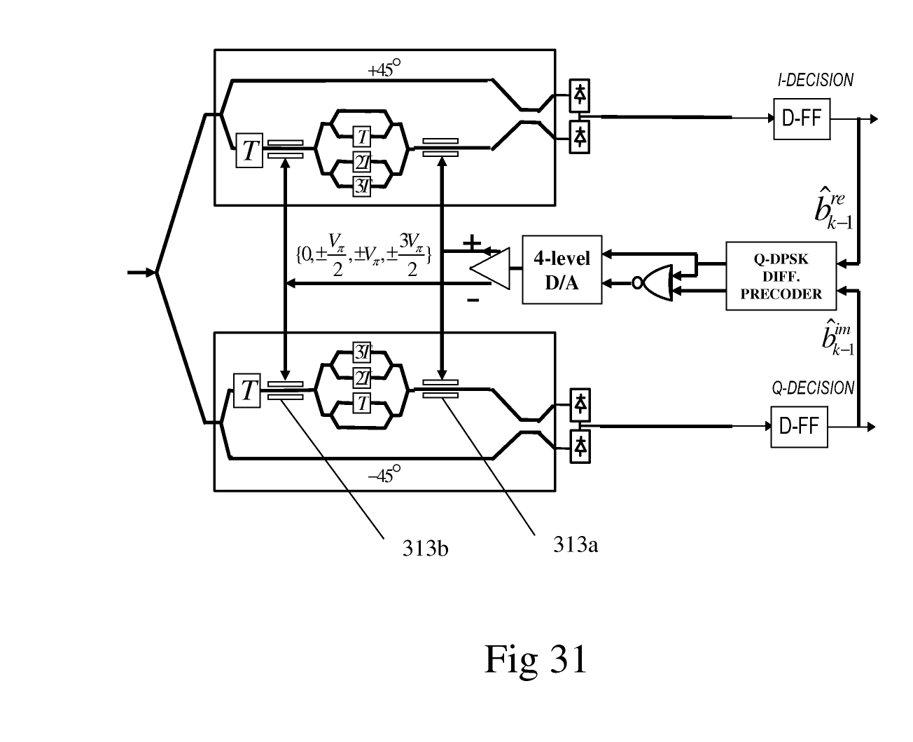

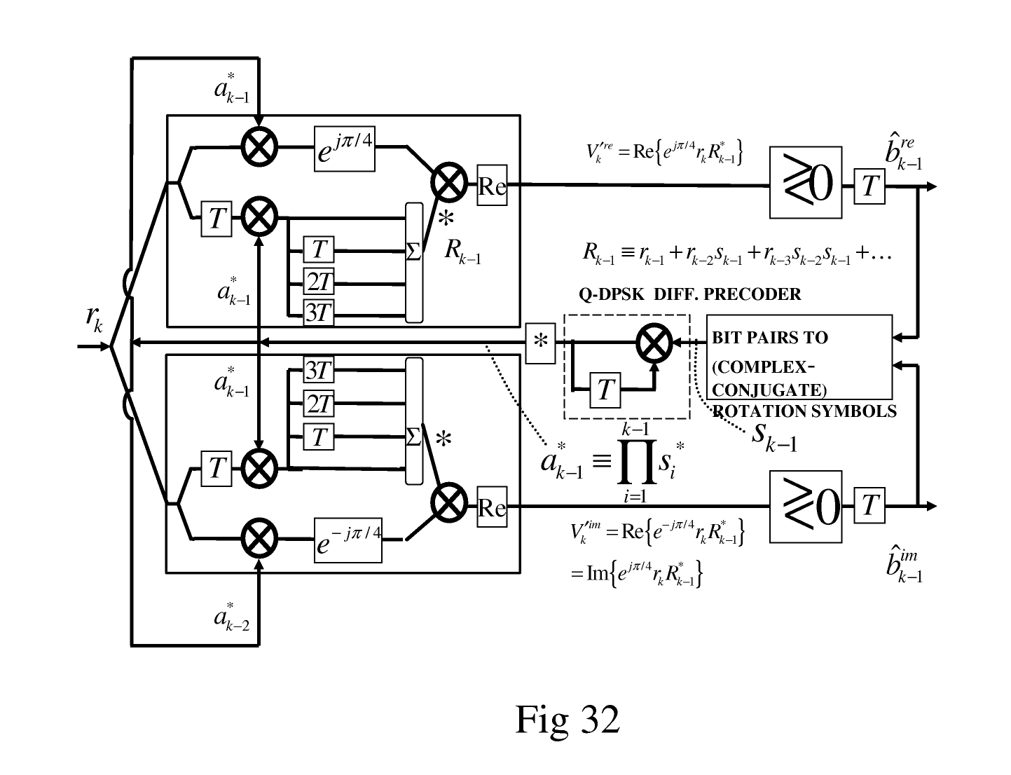

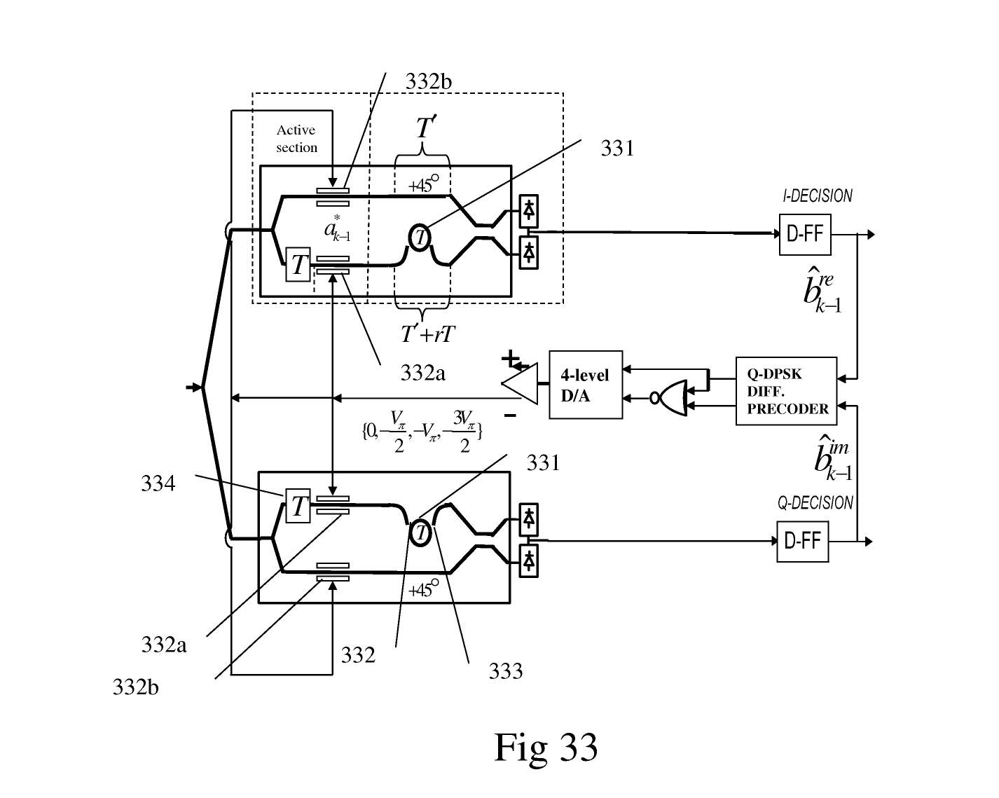

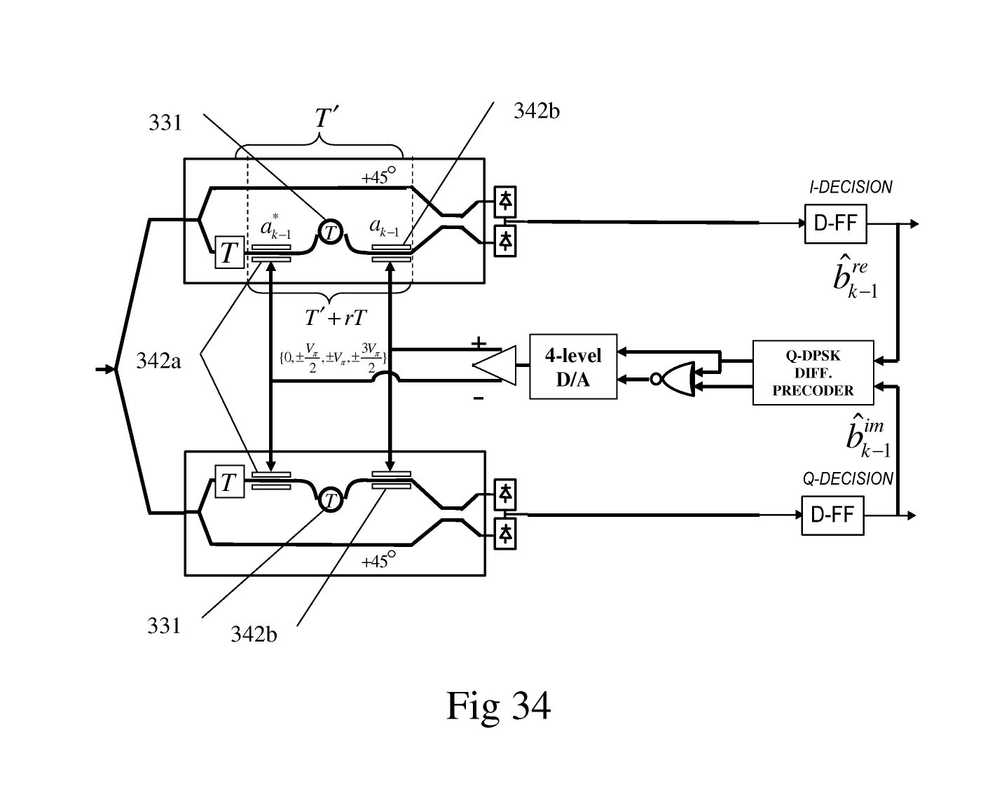

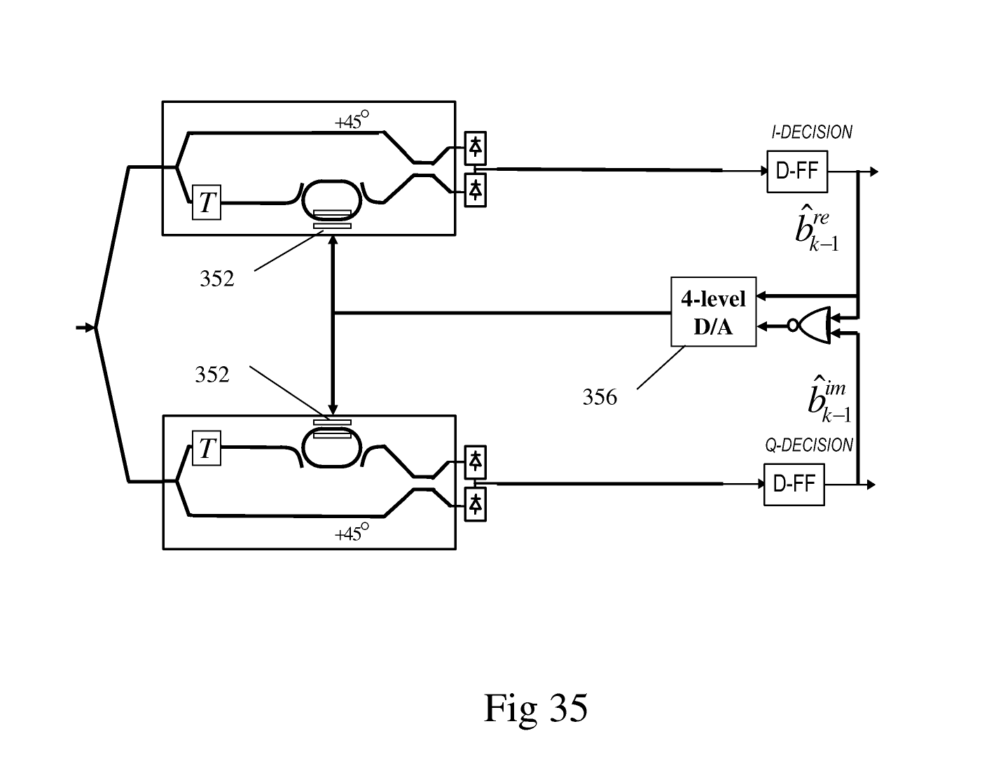

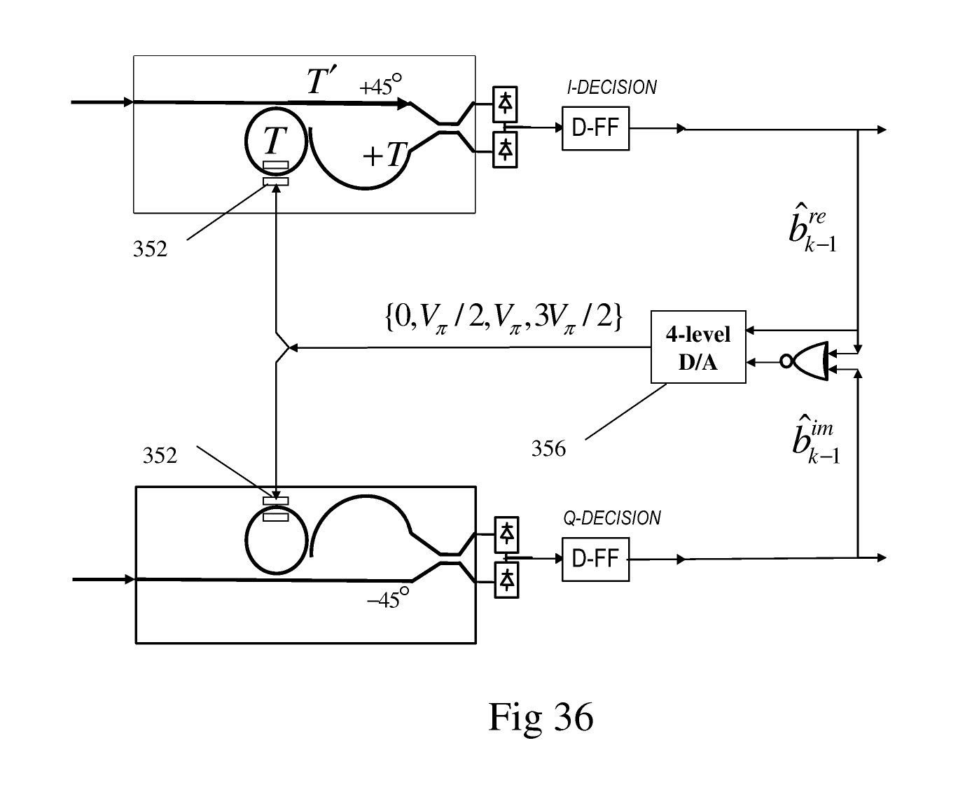

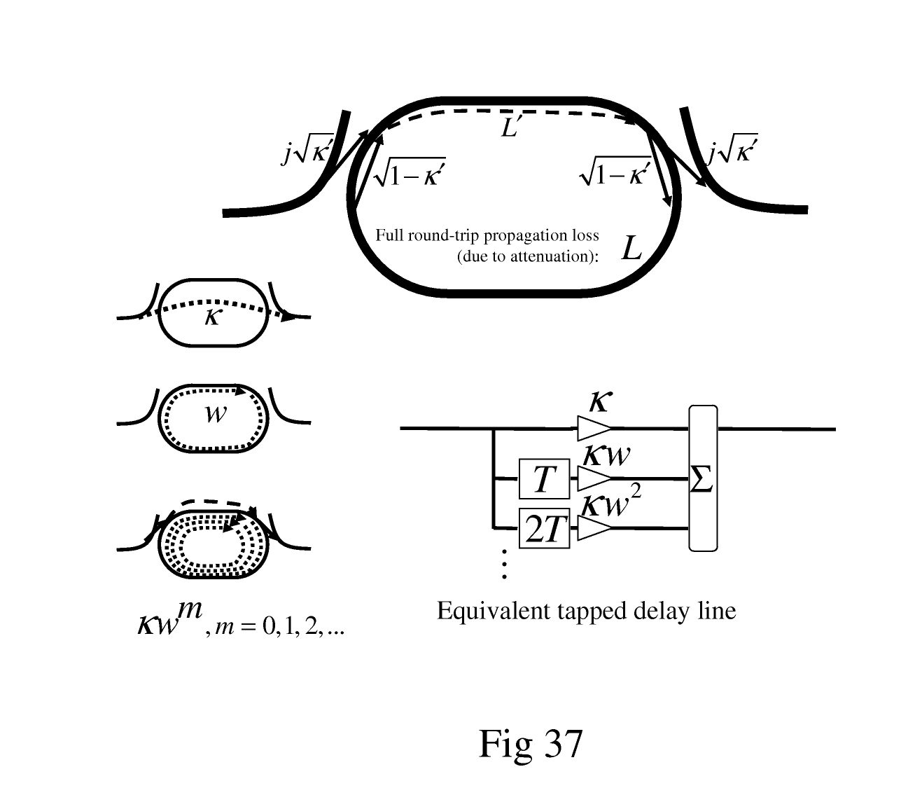

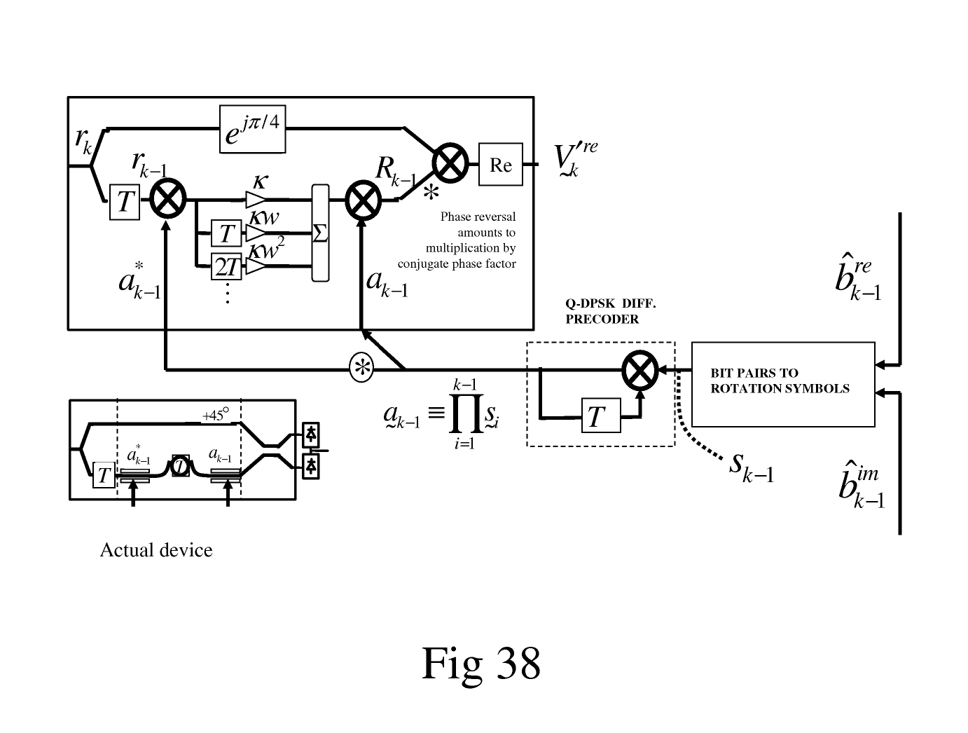

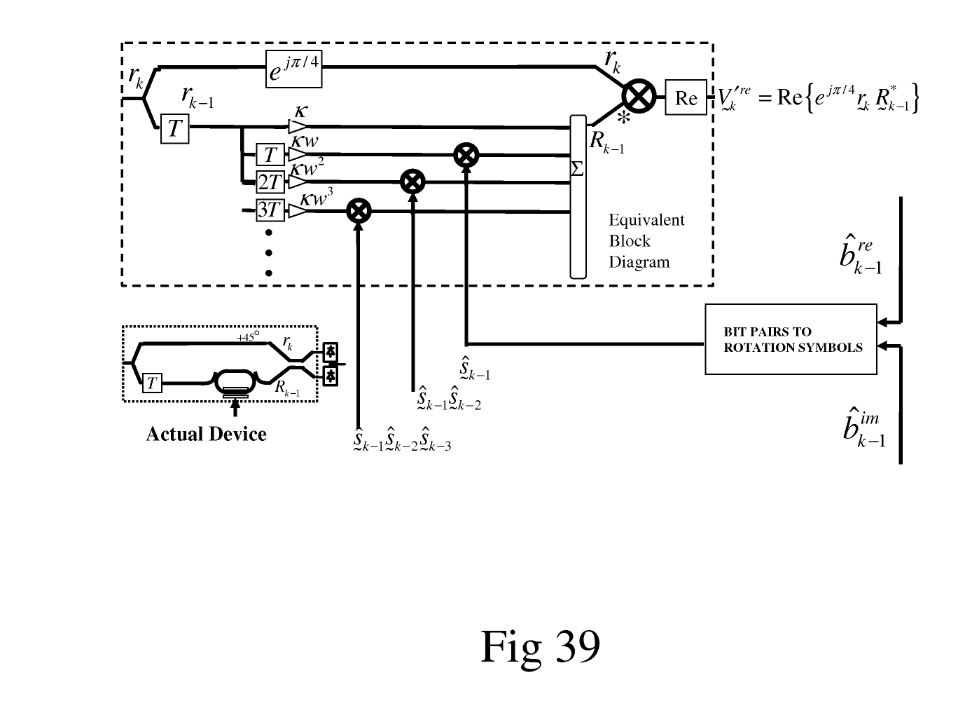

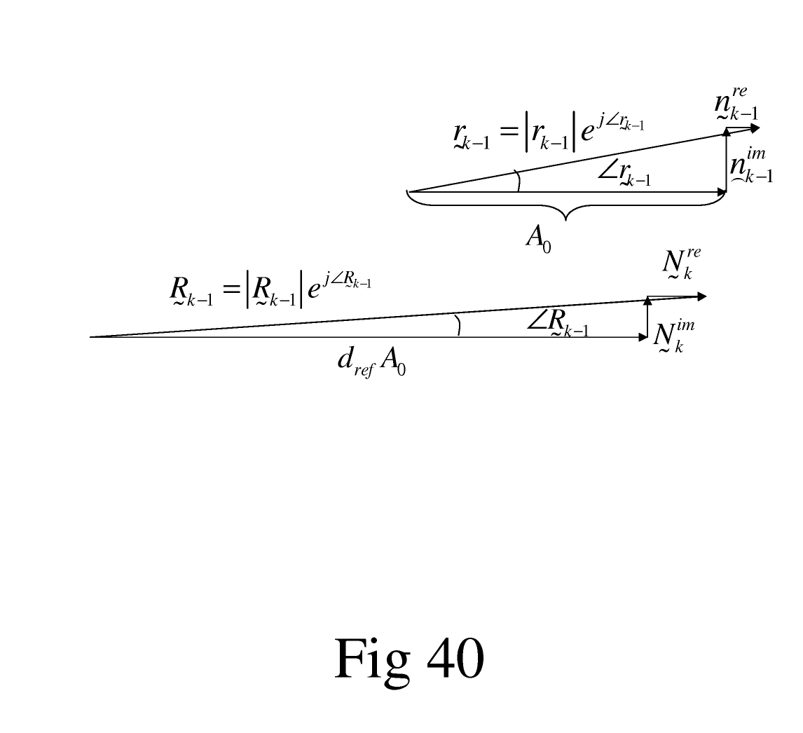

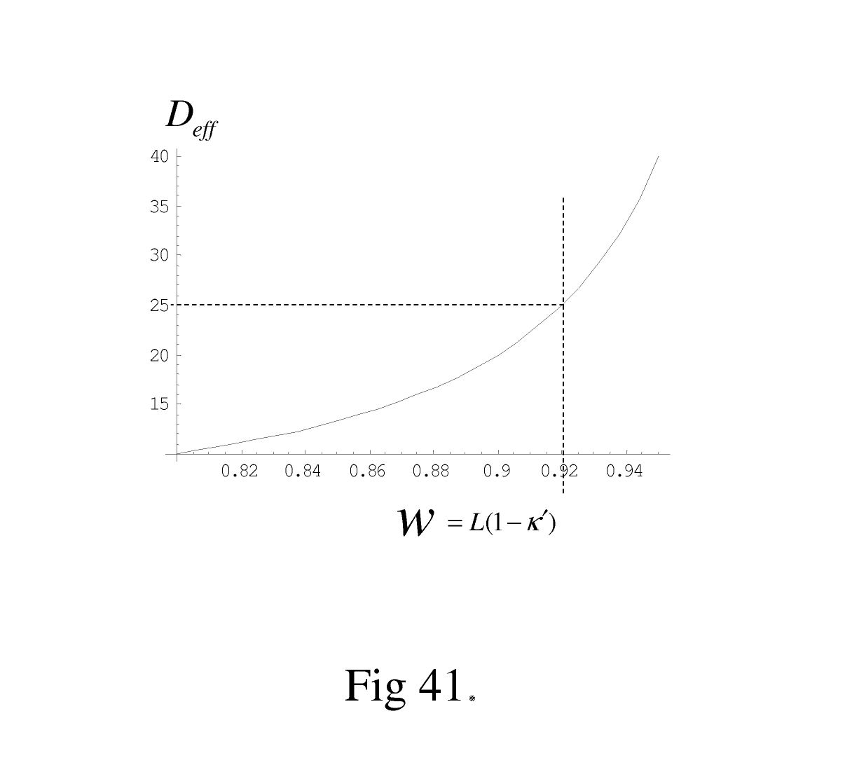

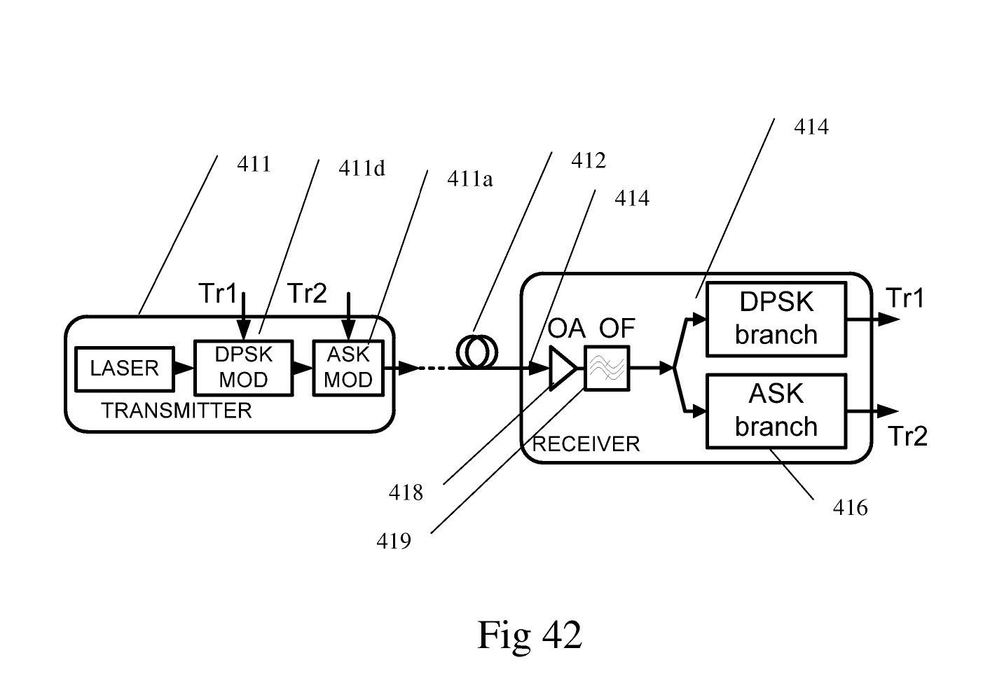

The results are displayed in FIG. 21, comparing the BER for standard 2-chip DPSK, 3-chip MC-DPSK (dashed) and DF-MC-DPSK with 3 and 4 chips (solid). It is apparent that 3 chip DF-MC-DPSK achieves essentially same performance as 3-chip MC-DPSK, albeit at a much reduced complexity. Note that DF MC-DPSK with perfect feedback improves the BER by a factor of 2 compared to MC-DPSK, which is precisely counteracted by the doubling of BER due to the error propagation penalty, overall yielding substantially identical BER performance for the original MC-DPSK format and for the reduced complexity DF scheme. Thus, both formats improve the BER by three orders of magnitude compared to standard DPSK detection. A 4-chip DF-MC-DPSK provides extra improvement of the BER by another order of magnitude (equivalent to 0.4 dB in Q-factor) while incurring just a modest increase in complexity. Similar Q factor improvements for 3 and 4 chip DF receivers were attained at a target BER of 10⁻⁴, as used in FEC-based systems.

### A SECOND FAMILY OF EMBODIMENTS

In this family of embodiments we attain further simplification of the analog soft-detection circuitry of MC-DPSK (specifically the SP) virtually eliminating the controlled inverters (CIs and CCIs) (or equivalently, eliminating the 180 deg hybrid plus switch 192 of FIGS. 19, 20) reducing the SP module to one (for B-DPSK) or two (for Q-DPSK) analog adder(s) used to sum the DI outputs. This is achieved at the expense of requiring more complex DI devices, incorporating active phase-modulating electrodes at the baud rate.

As the implementation of the electronic controlled inverters (CIs and CCIs) may be increasingly difficult at higher and higher speeds (e.g. 40/160 Gbps) while the electro-optic processing is known to be faster, the trade-off simplifying the SP, at the expense of requiring more complex DI devices in the IFE, may be worthwhile.

The SP complexity reduction in this second family of embodiments, relative to the first one, is enabled by the insight that the phase rotations requisite in DF may be generated electro-optically; using electro-optical phase modulators, rather than electronically. We introduce here Interferometric Decision Feedback (IDF) of the decisions into the DI-s themselves rather than into electronic controlled inverters, hence leading to their elimination. The IDF-aided ultimate simplification applies to any M, D parameter values, however for definiteness, the resulting systems are exemplified in FIGS. 22-24 to several representative formats, entailing either Binary or Quaternary phase modulation over 3 or 5 chips: FIG. 22 for 3-chip B-DPSK with (D,M)=(3,2); FIG. 24 for 5-chip B-DPSK with (D,M)=(5,2); and FIG. 23 for 3-chip Q-DPSK with (D,M)=(3,4).

Here, the same principle of operation as in the first family of embodiments is at work, namely that past reference chips are aligned by the feedback circuitry such that they add up collinearly, yielding a “cleaner” (higher SNR, lower phase noise) reference prior to beating with the current information chip. However, the implementation of the feedback is now achieved electro-optically.

In these embodiments the DFL is no longer digital, but is analog consisting of a drivers providing control voltages to the active DIs.

FIG. 22 illustrates the embodiment of a B-DPSK system for D=3 chips using interferometric feedback. The DFL now consists of a driver 221 generating the drive voltage V_{d}[k]ε{0,V_{π}} in response to the bit values 0, 1 for the \hat{b}ₖ₋₁ decision bit at the slicer output. The voltage V_{d} is applied to the electrode of phase retardation means 223 (marked with 0/180° to indicates the voltage controlled phase retardation) of the auxiliary DI 225 with 2T delay, the electrical balanced output of which is summed up and added to the output of the main DI 226 with delay T. Here V_{π} is the well-known switching voltage of a Mach-Zehnder DI, namely the voltage required to be applied to the active interferometer in order to fully switch the light from the lower to the upper arm (or vice versa). The voltage V_{π} then corresponds to a phase-shift of γ=π radians between the two-arms of the interferometer. This means that the feedback operation applies the following phase factor to the lower arm of the DI:
e^{jγ}ε{e^{jθ},e^{jπ}}={1,−1}

FIG. 23 illustrates the embodiment of a B-DPSK system for D=3 chips, using interferometric feedback. The DFL now consists of a driver generating the four-level drive voltage V_{d}[k]ε{0,V_{π}/2,V_{π},3V_{π}/2} in response to the pair of bit decisions \hat{b}ₖ₋₁^{re},\hat{b}ₖ₋₁^{re}, according to a Gray-code mapping:

00→0; 10→V_{π}/2; 11→V_{π}; 01→V_{π}

This is shown here as a four-level D/A 237 preferably followed by an amplifier 231 (shown as part of the IFE rather than the DFL for convenience of the drawing).

Since usually D/As traditionally yield their multiple voltage levels labeled according to a regular binary code rather than a Gray code, the pair of bits \hat{b}ₖ₋₁^{re},\hat{b}ₖ₋₁^{re} is applied to the D/A via the simple logic shown, consisting of a XOR gate, in order to convert from Gray to regular binary code.

The drive voltage V_{d}[k] is simultaneously applied to both the in-phase and quadrature auxiliary DIs of delays 2T. This means that the feedback operation applies the following phase factor to the non-delayed arm 232′ (233′) of each of the auxiliary DIs 232 (233) respectively:
e^{jγ}ε{e^{jθ},e^{jπ/2},e^{jπ},e^{j3π/2}}={1,j,−1,−j}

The electrical balanced outputs of the two in-phase DIs with delays T, and 2T are summed up and applied to the in-phase (I) D-FF decision device 234. Likewise, the electrical balanced outputs of the two in-quadrature DIs with delays T, and 2T are summed up and applied to the in-quadrature (Q) D-FF decision device 235. The outputs of the decision devices are applied to the DFL closing the loop.

FIG. 24 illustrates the embodiment of a B-DPSK system for D=5 chips using interferometric feedback. The DFL now consists of a driver generating three drive voltage V_{d}⁽¹⁾[k],V_{d}⁽²⁾[k],V_{d}⁽³⁾[k]ε{0,V_{π}} with drive voltage V_{d}^{(m)}[k] applied to the DI with delay mT, for m=2, 3, 4. Each amplifier 241 is essentially driven by a one-bit D/A (not shown either here or in the previous figures) yielding the respective voltages {0,V_{π}} in response to the bits {0,1} as generated by the DFL module, which has a structure identical to that disclosed for the DFL in the first family of embodiments (FIG. 16). The DFL module is driven by the decision bit \hat{b}ₖ₋₁.

These descriptions, plus the theory of operation below, suffice to comprehend the way in which these embodiments might be extended to arbitrary window size D, beyond the values D=3, 5 with which this second family of embodiments was exemplified in FIGS. 22-24.

Theory of Operation—for the Second Family of Embodiments

In an obvious extension of the prior art, eq. (2) the balanced output of a DI with delay mT may be expressed
iₖ∝Re{e^{jγ}{tilde under (r)}ₖ{tilde under (r)}ₖ₋ₘ*} (37)

The idea of the second family of embodiments is to make use of the phase-shift complex factor e^{jγ} in order to implement the required mathematical operations of multiplications by complex-rotation increments, as described in the section above on the theory of operation for the first family of embodiments.

For Q-BPSK we have seen in eq. (25) that an improved complex decision variable consists of the expression (repeated here for convenience)

$$\begin{matrix}{{V}_{∼}}_{k}^{′} ≡ {ⅇ}^{jπ / 4} {{r}_{∼}}_{k} {{R}_{∼}}_{k - 1}^{*} \\ = {ⅇ}^{jπ / 4} {{r}_{∼}}_{k} {\sum }_{m = 1}^{D - 1} {\hat{s}}^{*} [ k - m , k - 1 ] {{r}_{∼}}_{k - m}^{*} \\ = {\sum }_{m = 1}^{D - 1} {{s}_{∼}}^{*} [ k - m , k - 1 ] {ⅇ}^{jπ / 4} {{r}_{∼}}_{k} {{r}_{∼}}_{k - m}^{*}\end{matrix}$$

In fact we need the real and imaginary parts of this variable, for subsequent slicing processing (sign decisions on the real and imaginary parts).

$${{V}_{∼}}_{k}^{′re} ≡ {\sum }_{m = 1}^{D - 1} Re \{ {{s}_{∼}}^{*} [ k - m , k - 1 ] {ⅇ}^{jπ / 4} {{r}_{∼}}_{k} {{r}_{∼}}_{k - m}^{*} \}$$

$$\begin{matrix}{{V}_{∼}}_{k}^{′im} ≡ {\sum }_{m = 1}^{D - 1} Im \{ {{s}_{∼}}^{*} [ k - m , k - 1 ] {ⅇ}^{jπ / 4} {{r}_{∼}}_{k} {{r}_{∼}}_{k - m}^{*} \} \\ = {\sum }_{m = 1}^{D - 1} Re \{ {{s}_{∼}}^{*} [ k - m , k - 1 ] {ⅇ}^{- jπ / 4} {{r}_{∼}}_{k} {{r}_{∼}}_{k - m}^{*} \}\end{matrix}$$

Next, comparing the two terms Re{{tilde under (s)}*[k−m,k−1]e^{±jπ/4}{tilde under (r)}ₖ{tilde under (r)}ₖ₋ₘ*} in the last two equations, with eq. (37), and recalling that |{tilde under (s)}*[k−m,k−1]|=1, i.e. {tilde under (s)}*[k−m,k−1] is a phase-factor, (and so is {tilde under (s)}*[k−m,k−1]e^{±jπ/4}) it follows that {tilde under (s)}*[k−m,k−1]e^{±jπ/4} may be generated by active phase modulation to electrodes in the DI possibly in conjunction with a fixed phase bias (that is convenient though not necessary, to generate the phases ±π/4, using for these components the same techniques customary to generate these phases in conventional Q-DPSK DIs—an alternative would be to also generate these terms as biases of the drive voltage to the modulating electrodes).

In fact the phase factors {tilde under (s)}*[k−m,k−1] belong to the set {e^{j0},e^{jπ/2},e^{jπ},e^{j3π/2}}, therefore are generated as e^{jγ}, where the phase-shift is expressed as γ=V_{d}π/V_{π}. This means that the drive voltages must satisfy the condition V_{d}ε{0,V_{π}/2,V_{π},3V_{π}/2}, as described in the section above.

Similar, though simpler expressions are obtained for B-DPSK, in which case we may also directly provide more intuitive justification. In this case, we examine eq. (35) of the theory of operation section for the 1^{st} family of embodiments, repeated here for convenience:

$$\begin{matrix}{{V}_{∼}}_{k}^{re} = {\sum }_{m = 1}^{D - 1} \hat{s} [ k - m , k - 1 ] {q}_{mT}^{re} [ k ] \\ = {q}_{T} [ k ] + \hat{s} [ k - 2 , k - 1 ] {q}_{2 T}^{re} [ k ] + \hat{s} [ k - 3 , k - 1 ] {q}_{3 T}^{re} [ k ] + …\end{matrix}$$

Now,
ŝ[k−m,k−1]ε{1,−1}ε{e^{j0},e^{jπ}}
which is realized by applying drive voltages V_{d}ε{0,V_{π}} to the electrodes of the auxiliary DIs of delays 2T, 3 T, . . . , and summing up these DIs as indicated in FIGS. 22-24. In fact the last equation may simply be written as
{tilde under (V)}ₖ^{re}=q_{T}[k]±ŝ[k−2,k−1]q_{2T}^{re}[k]±ŝ[k−3,k−1]q_{3T}^{re}[k]+ . . . 38)
where the ± signs are determined by ŝ[k−m,k−1]=±1, as effected by the application of V_{d}ε{0,V_{π}}. In fact when the DI voltage is switched by V_{π}, the result is an effective exchange of the positions of the constructive (Σ) and destructive (Δ) ports, relative to the two DI output arms. The result is that for any given detection configuration, the balanced photo-current reverses polarity, effecting the sign changes requisite in eq. (38).

### A THIRD FAMILY OF EMBODIMENTS

In this family of embodiments, the remaining optical complexity of the IFE may be even further reduced by means of a novel Integrated Photonic Circuit (IPC) replacing the collection of DIs in the IFE by fewer devices that are somewhat more complex. According to the fifth family embodiments of the current invention, each DI comprises of at least three optical arms and at least one electronically controlled phase retardation modulator.

We mention that this level of optical integration is beyond the simple measure of just combining all the DIs onto a single optical substrate. In this family of embodiments various extended DI devices are shown in which the total number and complexity of devices integrated on each of the IPCs is reduced relative to a simple integration of the DIs disclosed in the previous families of embodiments.

FIG. 25 schematically depicts a system for detecting optical signal for D=3 chips Q-DPSK according to the third family of embodiments of the current invention.

FIG. 26 schematically depicts a details of IPC device for detection of D=5 chips optical signal according to the third family of embodiments of the current invention.

We commence with the pair of DI devices shown in FIG. 25, which replaces the four DI devices of FIG. 23, for D=3 chips Q-DPSK.

Here each IPC device is a 3-arm interferometer with relative delays 0, 2T, 3T.

The two IPC devices are biased with fixed phase γ=±π/4 on the combination 252 of the delayed two arms relative to the non-delayed arm using phase retardation means 251. The longest arm with relative delay 2T also contains an active electrodes 253, with the drive voltage V_{d}[k] 254 applied in an identical fashion to that described in FIG. 23.

The principle of operation of the device is now described.

The three-arm interferometers shown in both FIGS. 23 and 25 are used for detecting optical signal coded as 3-chip Q-DPSK (D=3).

From eq. (22), repeated here for convenience, the improved reference to be generated according to the teachings of this disclosure is
(D=3): {tilde under (R)}ₖ₋₁={tilde under (r)}ₖ₋₂{tilde under (ŝₖ₋₁+{tilde under (r)}ₖ₋₁ (39)

This equation is directly embodied in the combination of the two arms with delays T, and 2T of each device. Indeed, upon inputting a field sample {tilde under (r)}ₖ, the arm with delay T outputs at its end a field sample delayed by one discrete time unit, i.e. {tilde under (r)}ₖ₋₁, whereas the arm with delay 2T outputs at its end a field sample delayed by two discrete time units, multiplied by the phase-shift complex factor due to the voltage on the phase-shifting electrode. It is the role of the DFL driver to make this phase-shift complex factor equal to {tilde under (ŝₖ₋₁. Therefore the field sample at the end of the arm with 2T delay is {tilde under (r)}ₖ₋₂{tilde under (ŝₖ₋₁. The Y-junction combiner adds up these two outputs, yielding eq. (39) (the combining factor, ideally 1/\sqrt{2} and in fact any further losses equally affecting the two arms T and 2T, as well as the splitting loss of the splitter feeding the two arms, may be shown to be inconsequential and will therefore be omitted). Now, in the notation of eq. (1), the two fields at the input of the output directional coupler of the device are
{tilde under (u)}ₖ={tilde under (r)}ₖ,{tilde under (v)}ₖ={tilde under (R)}ₖ₋₁e^{±jπ/4}

Notice that the output field of the combined arms of delays T and 2T is further phase-shifted by static bias shifts of ±45° as indicated by element 251 in FIG. 25, hence the presence of the factor e^{±jπ/4} in the last equation. Applying eq. 1, the two balanced outputs of the two devices are
iₖ∝Re{tilde under (u)}ₖ{tilde under (v)}ₖ*=Re{tilde under (r)}ₖ{tilde under (R)}ₖ₋₁*e∓jπ/4

Let us denote the two respective balanced outputs of the two devices as
{tilde under (V)}′ₖ^{re}≡Re{tilde under (r)}ₖ{tilde under (R)}ₖ₋₁*e^{+jπ/4},{tilde under (V)}′ₖ^{im}≡Re{tilde under (r)}ₖ{tilde under (R)}ₖ₋₁*e^{-jπ/4}=Re{tilde under (r)}ₖ{tilde under (R)}ₖ₋₁*(−j)e^{+jπ/4}=Im{tilde under (r)}ₖ{tilde under (R)}ₖ₋₁*e^{+jπ/4}

Together, the two outputs form a complex sample
{tilde under (V)}′ₖ≡{tilde under (V)}′ₖ^{re}+j{tilde under (V)}′ₖ^{im}={tilde under (r)}ₖ{tilde under (R)}ₖ₋₁*e^{+jπ/4}

But we have retrieved eq. (25), which provided the proper form of the decision variable for Q-DPSK. The two balanced outputs, {tilde under (V)}′ₖ^{re}, {tilde under (V)}′ₖ^{im} are then sign detected, using the two D-FFs (same arrangement as in the other Q-DPSK embodiments seen so far) yielding in effect the decision algorithm of eq. (28), re-expressed here in the current notation as

$${{\hat{s}}_{∼}}_{k - 1}^{′} = \frac{1}{\sqrt{2}} ( sgn {{V}_{∼}}_{k}^{′re} + j sgn {{V}_{∼}}_{k}^{′im} )$$

Notice that there is a delay of one time unit via the D-FFs, and that the decision vector {tilde under (ŝ′ₖ₋₁ is one of the four states of the rotated QPSK constellation of FIG. 11a, digitally represented in terms of the two decision bits, [\hat{b}ₖ₋₁^{re},\hat{b}ₖ₋₁^{im}] according to the Gray code.
{tilde under (V)}′ₖ≡e^{jπ/4}{tilde under (r)}ₖ{tilde under (R)}ₖ₋₁* (40)

The structure of the DFL which acts on the decision bits to synthesize {tilde under (ŝₖ₋₁ is identical to that of FIG. 23, in effect generating the four drive voltage levels V_{d}[k]ε{0,V_{π}/2,V_{π},3V_{π}/2} corresponding to phase-shifts γε{0,π/2,π,3π/2}, such that the phase-factor induced by the electrodes in the devices equals e^{jγ}={tilde under (ŝₖ₋₁. According to this invention similar embodiments extending the same concept beyond D=3, are introduced for larger window sizes D=4, 5, 6, . . . .

E.g. from eq. (22) we have for D=5 the following expression for the reference:

$$\begin{matrix}{{R}_{∼}}_{k - 1} = \begin{matrix}{{r}_{∼}}_{k - 4} {{\hat{s}}_{∼}}_{k - 4} {{\hat{s}}_{∼}}_{k - 3} {{\hat{s}}_{∼}}_{k - 2} {{\hat{s}}_{∼}}_{k - 1} + {{r}_{∼}}_{k - 3} {{\hat{s}}_{∼}}_{k - 2} {{\hat{s}}_{∼}}_{k - 1} + \\ {{r}_{∼}}_{k - 2} {{\hat{s}}_{∼}}_{k - 1} + {{r}_{∼}}_{k - 1}\end{matrix} \\ = \begin{matrix}{{r}_{∼}}_{k - 4} \hat{s} [ k - 4 , k - 1 ] + {{r}_{∼}}_{k - 3} \hat{s} [ k - 3 , k - 1 ] + \\ {{r}_{∼}}_{k - 2} {\hat{s}}_{∼} [ k - 2 , k - 1 ] + {{r}_{∼}}_{k - 1}\end{matrix}\end{matrix} \qquad ( 41 )$$

This equation is electro-optically synthesized in the device of FIG. 26, a multi-arm interferometer with 5 arms with relative delays 0, T, 2T, 3T, 4T, wherein the three arms with delays 2T, 3T, 4T are equipped with phase-shifting electrodes 263. The heavy arrows in the figure indicate transmission lines connecting the phase-shifting electrodes with the electrical terminals 269 of the devices.

If drive voltages synthesize phase factors {tilde under (ŝ[k−4,k−1],{tilde under (ŝ[k−3,k−1],{tilde under (ŝ[k−2,k−1], coinciding with the complex rotation increments, are applied to the electrodes by means of an appropriate DFL driver, then it is apparent that this combination of delay lines T, 2T, 3T, 4T generates the reference {tilde under (R)}ₖ₋₁, which is phase-shifted ±45°, i.e. multiplied by e^{±jπ/4}, then mixed with the signal {tilde under (r)}ₖ in the upper arm 268 by means of the directional coupler 267 to yield a balanced photocurrent output Re{e^{±jπ/4}{tilde under (r)}ₖ{tilde under (R)}ₖ₋₁*}. As shown above for the case D=3, these two photocurrents together form the sufficient decision statistics for Q-DPSK detection. The resulting overall 5-chip Q-DPSK receiver, making use of the devices of FIG. 26 is shown in FIG. 27.

It should be noted that “reverse Y combiners” and “multiple input Y combiners” may be realized as a collection of “splitters-combiners” wherein idle outputs are preferably terminated with a beam dump. However, when “reverse Y combiner” structure is used, light radiates away into the substrate upon destructive interference. Other insertion losses may also reduce the efficiency of the combiner, however, the effect of these losses is inconsequential as signals are sign-detected in the slicer, so the inclusion of an attenuation factor c with the reference {tilde under (R)}ₖ₋₁ has no impact on the sign determination, i.e.
sgn[Re{{tilde under (r)}ₖ{tilde under (R)}ₖ₋₁*e^{jπ/4}}]=sgn[Re{{tilde under (r)}ₖ(c{tilde under (R)}ₖ₋₁)*e^{jπ/4}}]

This means that any common attenuation affecting the overall optical path generating the improved reference {tilde under (R)}ₖ₋₁, does not affect operation.

FIG. 27 schematically depicts a system for detection of D=5 chips Q-DPSK optical signal according to the third family of embodiments of the current invention.

In FIG. 27 the six arrows 271 emanating from the DFL block are the drive voltages corresponding to the rotation increments to be respectively connected to the two pairs of triplets of arrows leading to the electrical terminals 269 of each of the two IPC devices.

A similar system may be realized for B-DPSK, in fact the device of FIG. 26 also suits B-DPSK provided the bias phase of the lower input of the output directional coupler is set to 0° rather than +45° as used in Q-DPSK.

FIG. 28 schematically depicts a system for detection of D=5 chips B-DPSK optical signal according to the third family of embodiments of the current invention.

A five-chip B-DPSK system is shown in FIG. 28, requiring a single IPC device, and a DFL generating just three drive voltages 281, corresponding to the three rotation increments of eq. (41) for B-DPSK.

A disadvantage of these embodiments based on the integrated-optical device is in a complex electro-optic structure of the integrated optic circuit, requiring multiple optical splitting and combinations of waveguides, and complex multiple transmission line electrical structures, the more so for higher D. The number of independent active phase modulations for each device is D−2, which becomes prohibitive for large D (e.g. of the order of D=7) which is of interest in order to improve system performance.

This is addressed in the next family of embodiments, which discloses simplified devices.

It should be noted that voltage drivers may be calibrated to produce and/or maintain correct phase retardation caused by manufacturing inaccuracies and/or environmental changes such as temperature and aging.

### A FOURTH FAMILY OF EMBODIMENTS

Improved integrated-optic DI devices are introduced in this family of embodiments.

The fourth family of embodiments uses at least one voltage controlled phase retardation means (293b, 313b) in line with, and affecting all the delayed optical branches. A second voltage controlled phase retardation means (293a, 313a) may be in line with the non-delayed branch, as in FIG. 29; or in line with, but positioned after the delays as in FIG. 31.

A particular embodiment is shown in FIG. 29 for D=5, which exemplifies a Q-DPSK system, making use of two IPC′ devices 291 that are identical to each other; except for the ±45° static phase-shifts in the non-delayed arm 292. In each DI device, the layout of the optical waveguides is similar to that of FIG. 26—in the delayed (lower) branch the optical interferometric path of the device are also four paths with delays T, 2T, 3T, 4T. However, a common delay T 299 is singled out and applied upfront, such that relative delays 0, T, 2T, 3T remain in the four paths. The electrode structure here is different. In contrast to the embodiment of FIG. 26, this device requires just two phase-shifting electrodes 293a and 293b, one of which 293a is applied to the non-delayed (upper) arm (with delay 0) while the other, 293b) is applied to the common lower arm (in line with to the common delay T). In effect the electro-optic phase-shift applied by the lower electrodes modulates all four paths, albeit at different times.

The two-phase modulators incorporated in each DI device are nominally identical, i.e. have the same sensitivity, yielding phase-shift π in response to an applied voltage V_{π}.

All electrodes are driven in parallel by a common electrical drive signal,
V_{d}[k]ε{0,V_{π}/2,V_{π},3V_{π}/2} (42)
as generated by the DFL driver, which is here simpler than in the previous versions, consisting of a four-level D/A generating the analog drive voltage of eq. (42) (which is subsequently amplified with the proper gain 297) in response to a pair of bits encoding in Gray code the cumulative rotation increment

$$\hat{{s}_{∼}} [ 0 , k - 1 ] = {\prod }_{m = 1}^{k - 1} {\hat{{s}_{∼}}}_{m} . \qquad ( 43 )$$

The digital circuit to generate this rotation increment is shown in FIG. 30, in effect it coincides with the Q-DPSK differential pre-coder used in a conventional Q-DPSK transmitter, hence other implementations than that shown in FIG. 30 are possible. The concept behind the differential pre-coder realization of FIG. 30 is the recursive realization of eq. (43):
{tilde under (ŝ[0,k−1]={tilde under (ŝ[0,k−2]{tilde under (ŝₖ₋₁

The slicer in eq. 41 consists of two D-FF devices the decision bits of which feed the Q-DPSK differential pre-coder of the DFL.

This completes the description of this embodiment. Other similar embodiments of this family for different D values, just extend the optical structure of the DI devices described in FIG. 29, by including more arms with higher delays 0, T, 2T, . . . (D−2)T. For any order D, the electrodes and the external circuitry (DFL driver and Slicer) are the same.

A B-DPSK embodiment of the same principles would use just one device with fixed phase bias set to 0° rather than ±45°.

A related embodiment for Q-DPSK, equivalent to that of FIG. 29, is shown in FIG. 31.

In that system, the two sets of active electrodes 313a and 313b are both applied on the arm with the multiple delays: before (but in line with the common delay T) 313b; and after the multiple delays 313a. The two electrodes are driven by two antipodal (of opposite sign) voltages,

$$\{ 0 , \underline{+} \frac{{V}_{π}}{2} , \underline{+} {V}_{π} , \frac{3 {V}_{π}}{2} \}$$

with the +/− sign pertaining to the drive voltage applied to the right/left set of electrodes.

Again, a B-DPSK embodiment of the same principles would use just one device with fixed phase bias set to 0° rather than ±45°.

Theory of Operation for the Fourth Family of Embodiments

FIG. 32 presents an equivalent block diagram for the system of FIGS. 29-31, for analysis purposes. The phase-shifts induced by means of the active electrodes are represented as multiplications with phase factors, and the directional coupler followed by the balanced photo-detection is modeled according to eq. (1), repeated here, in the current notation for the two device outputs (labeled re/im):
{tilde under (V)}′ₖ^{re/im}=Re{tilde under (u)}ₖ{tilde under (v)}ₖ*, (44)

Here {tilde under (u)}ₖ being the output of the upper arm (in the upper device, or the lower arm in the mirror image lower device), expressible as
{tilde under (u)}ₖ={tilde under (r)}ₖ{tilde under (a)}ₖ₋₁*e^{±jπ/4} (45)
where we defined the “accumulated rotation increment” as the rotation increment from the beginning of time until time k−1:

$${{a}_{∼}}_{k - 1} ≡ {\hat{s}}_{∼} [ 0 , k - 1 ] = {\prod }_{m = 1}^{k - 1} {{\hat{s}}_{∼}}_{m}$$

This is in fact the output (at time k−1) of a Q-DPSK differential pre-coder, as described in FIG. 30. This output, as Gray encoded by the pair of bits, is applied to the 4-level D/A followed by a voltage inverter, as indicated in FIG. 29. With the voltage inverted prior to application to the active electrodes, the electro-optic phase-factor in the waveguides attached to the electrodes equals
e^{-jV}^{_{d}}^{[k]πV}^{_{π}}=e^{-jarg{tilde under (a)}}^{_{k−1}}=(e^{jarg{tilde under (a)}}^{_{k−1}})*={tilde under (a)}ₖ₋₁* (46)

It was this multiplicative factor that was applied to the input r, in eq. (45) in addition to the fixed ±45° phase factor.

As for the evaluation of {tilde under (v)}ₖ at the lower input of the directional coupler, we must propagate the input {tilde under (r)}ₖ through the delay T, the multiplier modeling the phase-shift (also a {tilde under (a)}ₖ₋₁* factor), and the multiple parallel delays and then sum up, yielding:

$${{v}_{∼}}_{k} = {\sum }_{m = 0}^{D - 2} {Delay}^{m} \{ {{r}_{∼}}_{k - 1} {{a}_{∼}}_{k - 1}^{*} \} = {\sum }_{m = 0}^{D - 2} \{ {{r}_{∼}}_{k - m - 1} {{a}_{∼}}_{k - m - 1}^{*} \} \qquad ( 47 )$$

where Delay denotes the one-unit delay operator (Delay{xₖ}=xₖ₋₁), and we extended the summation to the upper limit D−2, for a general, D, even though here D=5, so as to enable a more general treatment, valid for arbitrary D.

Substitution of eqs. (45), (47) into eq. (44) yields

$$\begin{matrix}{{V}_{\sim}}_{k}^{tre / im} = Re {{r}_{\sim}}_{k} {{a}_{\sim}}_{k - 1}^{*} {ⅇ}^{\pm j π / 4} {\{ {\sum }_{m = 0}^{D - 2} {{r}_{\sim}}_{k - m - 1} {{a}_{\sim}}_{k - m - 1}^{*} \}}^{*} \\ = Re {{r}_{\sim}}_{k} {\{ {\sum }_{m = 0}^{D - 2} {{r}_{\sim}}_{k - m - 1} {{a}_{\sim}}_{k - 1} {{a}_{\sim}}_{k - m - 1}^{*} \}}^{*} {ⅇ}^{\pm jπ / 4} \\ = Re {r}_{\sim} {\{ {\sum }_{m = 0}^{D - 2} {{r}_{\sim}}_{k - m - 1} {\hat{s}}_{\sim} [ k - m - 1 , k - 1 ] \}}^{*}\end{matrix} \qquad ( 48 )$$

where we recognized that the conjugate product of the accumulated rotations is actually a rotation increment over the time segment consisting of the ending times of the two accumulated rotations:
{tilde under (a)}ₖ₋₁{tilde under (a)}ₖ₋ₘ₋₁*={tilde under (ŝ[k−m−1,k−1]

Eq. (48) may be compactly expressed as
{tilde under (V)}′ₖ^{re/im}=Re{tilde under (r)}ₖ{tilde under (R)}ₖ₋₁*e^{±j/π/4} (49)

By introducing the reference consistent with eq. (20).

$${{R}_{\sim}}_{k - 1} = {\sum }_{m = 0}^{D - 2} {{r}_{\sim}}_{k - m - 1} {\hat{s}}_{\sim} [ k - m - 1 , k - 1 ] = {\sum }_{m = 1}^{D - 1} \hat{s} [ k - m , k - 1 ] {{r}_{\sim}}_{k - m}$$

Our output variables of eq. (49) is consistent with eq. (26), therefore, the system of FIG. 29 precisely provides in principle the same receiver functionality as provided in the other DF Q-DPSK embodiments, however the implementation of the current embodiment might be deemed more convenient.

As for the system of FIG. 31, its theory of operation is readily inferred from that of FIG. 29, as the application of a phase-shift factor e^{jγ} in the upper arm is equivalent to the application of the conjugate phase-shift factor e^{-jγ} in the lower arm.

This equivalence is readily established from eq. (44) by substituting once by substituting once the pair {tilde under (u)}ₖ={tilde under (u)}′ₖe^{jγ},{tilde under (v)}ₖ={tilde under (v)}′ₖ, and the second time by substituting {tilde under (u)}ₖ={tilde under (u)}′ₖ,{tilde under (v)}ₖ={tilde under (v)}′ₖe^{-jγ}

In both cases we get
{tilde under (V)}′ₖ^{re/im}=Re{tilde under (u)}ₖ{tilde under (v)}ₖ*=Re{tilde under (u)}′ₖ{tilde under (v)}′ₖ*e^{jγ}.

It then follows that a phase modulation may be moved from the upper to the lower arm provided the sign of its modulating voltage is flipped. Consistent with this rule the upper electrode (in the upper device) in FIG. 29 was moved to the lower path in FIG. 31, resulting now in two phase modulations on the same (lower) path, yielding an equivalence of the two schemes, i.e. the scheme of FIG. 31 is also a valid DF multi-chip Q-DPSK receiver.

Comparing the realizations of FIG. 29 and FIG. 31, they seem comparable, though one device may be preferred over the other from practical considerations, e.g. the geometry of the access to the electrodes, or the length of the device. One advantage of the device of FIG. 29 is that the active region 295 may be separated from the rest of the device, e.g. the active region may be implemented in a different material system, say LiNb0₃, whereas the rest of the device may be implemented in Silica over Silicon, with both pieces butt-coupled together. It should be noted that other means and methods for electronically controlling phase retardation are known in the art of electro-optics, for example using Liquid Crystals (LC), strain induced changes in index refraction, etc. Some of these methods may be used within the scope of the current invention.

One disadvantage of the current family of embodiments, as well as the third family of embodiments disclosed above, is that the optical waveguide structure remains complex, with multiple splits, delays and recombinations of the waveguides that might be hard to control and balance accurately (however, it may be shown that these devices are relatively robust to various imbalance imperfections). In the next family of embodiments we simplify the optical structure of the highly integrated DI devices.

### A FIFTH FAMILY OF EMBODIMENTS

FIG. 33 schematically depicts a system for detecting coded optical signal with an interferometer having a recirculation ring, acting as a recursive delay line” and two phase modulators, one in each branch of an interferometer, according to an embodiment of the current invention.

FIG. 34 schematically depicts a system for detecting coded optical signal with an interferometer having a recirculation ring and two phase modulators, both in line, yet one before and one after the recirculation ring, according to another embodiment of the current invention.

In accordance to the fifth family of embodiments according to the current invention, we introduce for multi-chip DF Q-DPSK the embodiments of FIGS. 33 and 34, comprising integrated-optic DIs that are based on recirculating delay lines, each comprising an optical coupled ring 331 wherein the light signal is coupled into the ring and performs multiple recirculations prior to getting coupled out. The optical coupled ring 331 is inserted in one of the two arms of the DI, and a pair of phase-modulating electrodes (332a, 332b and 342a, 342b in FIGS. 33 and 34 respectively) is also provided. The coupled ring serves as a recirculating delay line. Light is coupled into (and out of) the ring by means of directional couplers 333 (334), with a certain desired range of coupling ratios.

Compared with the embodiments of FIGS. 29 and 31, the embodiments of FIGS. 33 and 34, are quite similar, except for the insertion of the coupled ring 331, which replaces the delay lines with multiple (D−2) arms in FIGS. 29 and 31, in fact performing a similar function, shown in the theoretical part to be equivalent to a delay line with D−2 with an effective D determined by the parameters of the system. The other sub-systems in FIGS. 33 and 34; interacting with the two DIs, namely the DFL driver and the slicer are in fact identical to those of the respective FIGS. 29 and 31.

The specification of the optical delays inherent in the new devices is as follows:

The ring 331 round trip time (T) must equal to the chip (baud or symbol) period T. Moreover, as indicated in the two figures, considering the zeroth order recirculation of light through the ring, namely light gets coupled into the ring trough coupler 332, traverses the upper arc of ring 331 to the other directional coupler 333 and gets coupled out of the ring, as opposed to the m-th order recirculation which consists in light getting coupled into the ring then making m full revolutions around the ring, then traversing the upper arc to the output coupler, and getting coupled out of the ring. The total delay experienced in the delayed (lower) arm via the zeroth order recirculation should exceed the delay of arm without a ring (of the upper arm), precisely by T, as indicated by the delay block T 334 that was schematically inserted at the left hand side of lower arm.

For light performing m recirculations around the ring, the total delay in the lower arm is
T+T′+mT=(m+1)T+T′,m=0, 1, 2, 3, . . .
whereas for light in the upper arm the total delay is T′, hence the differential delay between the two arms is (m+1)Tε{T, 2T, 3T, . . . }.

Notice that the two systems of FIGS. 33 and 34 differ by the placements of the phase modulating electrodes 332 and 342 respectively. For FIG. 33, the two phase modulators are applied to the upper and lower arms, driven by voltages

$$\{ 0 , = - \frac{{V}_{π}}{2} , - {V}_{π} , - \frac{3 {V}_{π}}{2} \} .$$

In contrast, for FIG. 34, the two phase modulators are both applied to the lower arm, on both sides of the ring, however in this case the two phase modulators are driven by antipodal voltages,

$$\{ 0 , \pm \frac{{V}_{π}}{2} , \pm {V}_{π} , \pm \frac{3 {V}_{π}}{2} \} ,$$

with each sign corresponding to one of the drive voltages.

Yet another subclass of embodiment is shown in FIGS. 35 and 36.

FIGS. 35 and 36 schematically depicts a system for detecting coded optical signal with an interferometer having a recirculation ring and one phase modulator modulating light in the recirculation ring, according to another embodiment of the current invention.

In these figures the phase modulation is performed intra-ring, i.e. within the ring itself using phase modulator 352. The DFL driver does not use a differential encoder but rather just applies a drive voltage directly representing the last symbol recovered by the slicer using the four level D/A 356.

The two embodiments of FIGS. 35 and 36 differ in their details of how light is coupled in and out of the ring.

Additional related variants might also be possible, in all of them the light in one waveguide is coupled into multiple recirculations in a ring, and the ring (also of dimension T equal to the baud or chip period) is phase modulated in each chip interval by the last recovered complex rotation symbol {tilde under (ŝₖ₋₁.

While this embodiment looks simpler than the ones in FIGS. 33 and 34, as it only uses a single phase modulator and a simpler DFL driver, this embodiment will generally have inferior performance the higher the bit rate is, as the efficiency of phase modulation as measured by the V_{π} of the ring gets lower (V increases) with decreased dimension (smaller T, higher baud rate T⁻¹). Therefore, the embodiments of FIGS. 33 and 34, wherein the phase modulation is applied outside the ring, are preferable in that the length dimension of the phase modulators can be increased (as it is just the delay difference between the two arms that matters, not the absolute delay).

Theory of Operation for the Fifth Family of Embodiments

FIG. 38 represent a mathematical equivalent block diagram of embodiments of FIG. 33.

Similarly to the considerations used to demonstrate the equivalence of the embodiments of FIGS. 29 and 31, it is readily shown that the embodiments of FIGS. 33 and 34 are equivalent. Therefore we shall establish the principle of operation of just one of them, namely the embodiment of FIG. 34 with both phase modulators in the lower arm (for the upper device) and driven by antipodal voltages driven by an A/D in turn activated by a differential precoder implementing phase-shift complex factors respectively equal to {tilde under (a)}ₖ₋₁ and {tilde under (a)}ₖ₋₁* (with the complex conjugate accounted for in eq. (46), as a result of the sign inversion of the drive voltage).

FIG. 37 models the optically coupled ring and defines the pertinent parameters:

κ′, the power coupling coefficient into/out of the ring (the cross-over coefficient of the directional coupler);

L, the full round-trip propagation loss;

L′, the port-to-port propagation loss (along the upper arc of the ring, not counting the couplers);

κ=j\sqrt{κ′}L′j\sqrt{κ′}=−κ′L′, the port-to-port direct coupling (zeroth recirculation) coupling:

For clarity, we shall change the sign, taking κ=κ′L′.

The π phase-shift may be generated by maintaining a half-wave delay in the lower arm to offset the minus sign or just exchanging the roles of constructive/destructive ports

The round trip overall loss factor (propagation attenuation + losses due to the two coupler):
w=L\sqrt{1−κ′}\sqrt{1−κ′}=L(1−κ′) (50)
The port-to-port coupling factor of the m-th recirculation: κw^{m}, m=0, 1, 2, . . .

0-th recirculation is formally taken as the port-to-port direct path κ

The ring is then equivalent to the infinite tapped delay line with decaying tap weights shown in FIG. 37. We are now in a position to represent the embodiment of FIG. 34 by the equivalent block diagram of FIG. 38.

To analyze this block diagram, start with the lower path (the one that includes the equivalent tapped delay line) and work out the propagations through the delays 0, T, 2 T, . . . one by one:
{tilde under (a)}ₖ₋₁κ{tilde under (a)}ₖ₋₁*{tilde under (r)}ₖ₋₁=κ{tilde under (r)}ₖ₋₁
{tilde under (a)}ₖ₋₁κwDelay{{tilde under (r)}ₖ{tilde under (a)}ₖ₋₁*}=κw{tilde under (a)}ₖ₋₁{tilde under (a)}ₖ₋₂*{tilde under (r)}ₖ₋₂=κw{tilde under (ŝₖ₋₁{tilde under (r)}ₖ₋₂
{tilde under (a)}ₖ₋₁κw²Delay²{{tilde under (r)}ₖ₋₁{tilde under (a)}ₖ₋₁*}=κw²{tilde under (a)}ₖ₋₁{tilde under (a)}ₖ₋₃*{tilde under (r)}ₖ₋₃=κw²{tilde under (ŝₖ₋₁{tilde under (ŝₖ₋₂{tilde under (r)}ₖ₋₃
{tilde under (a)}ₖ₋₁κw³Delay³{{tilde under (r)}ₖ₋₁{tilde under (a)}ₖ₋₁*}=κw³{tilde under (a)}ₖ₋₁{tilde under (a)}ₖ₋₄*{tilde under (r)}ₖ₋₄=κw³{tilde under (ŝₖ₋₁{tilde under (ŝₖ₋₂{tilde under (ŝₖ₋₃{tilde under (r)}ₖ₋₄ (51)

Superposing all contributions synthesizes the improved reference:
{tilde under (R)}ₖ₋₁=κ({tilde under (r)}ₖ₋₁+w{tilde under (ŝₖ₋₁{tilde under (r)}ₖ₋₂+w²{tilde under (ŝₖ₋₁{tilde under (ŝₖ₋₂{tilde under (r)}ₖ₋₃+w³{tilde under (ŝₖ₋₁{tilde under (ŝₖ₋₂{tilde under (ŝₖ₋₃{tilde under (r)}ₖ₋₄ . . . ) (52)

The final action of the directional coupler is to mix the upper path signal {tilde under (r)}ₖe^{+jπ/4} and the reference {tilde under (R)}ₖ₋₁, yielding
{tilde under (V)}′ₖ^{re}=Re{tilde under (r)}ₖ{tilde under (R)}ₖ₋₁*e^{+jπ/4},{tilde under (V)}′ₖ^{im}=Re{tilde under (r)}ₖ{tilde under (R)}ₖ₋₁*e^{-jπ/4} (53)
with the second expression obtained by similarly analyzing the lower device with phase shift −45°.

FIG. 39 represent a mathematical equivalent block diagram of embodiments of FIG. 35.

We can analyze now the system of FIGS. 35 and 36 with intra-ring phase modulation, using the equivalent block diagram of FIG. 39.

At discrete time k, the applied modulating phase factor is {tilde under (ŝₖ₋₁. Consider a partial signal emerging out of the ring at the time k, after it performed m recirculations around the ring. This signal experienced m different phase modulations, those applied at intervening times. Therefore, we may say that: the zeroth recirculation experiences no phase modulation, i.e. emerges at time k as κ{tilde under (r)}ₖ₋₁ the one-time recirculation experiences phase modulation at time k−1, emerging at time k as κw{tilde under (ŝₖ₋₁{tilde under (r)}ₖ₋₂. The twice recirculating signal experiences phase modulation at times k−2,k−1 emerging at time k as κw²{tilde under (ŝₖ₋₁{tilde under (ŝₖ₋₂{tilde under (r)}ₖ₋₃.

The thrice recirculating signal experiences phase modulation at times k−3,k−2,k−1 emerging at time k as κw²{tilde under (ŝₖ₋₁{tilde under (ŝₖ₋₂{tilde under (r)}ₖ₋₃, etc.

The same pattern of partial contributions as in eq. (51) emerges, though the reasoning is different. Summing up all these contributions yields the same expression for the reference as in eq. (52), and as the coupler configuration is the same, eq. (53) also holds.

Notice that eq. (52) for the improved reference in the recirculating delay line case involves the summation of an infinite number of contributions from previous chips, with these contributions taken with decaying weight. This is different than the underlying structure of the improved reference obtained in the previous non-recursive embodiments (families I-IV) disclosed in this invention, wherein the reference was the superposition of a finite number of contributions from D−1 past chips, all with the same weight.

It remains to analyze the performance improvement attained with the current recursive scheme, demonstrating that the infinite number of chips with decaying memory is equivalent to a finite number of effective chips in the non-recursive case. We also determine the effective D value in terms of the optical parameters of the ring, demonstrating reasonably useful D values are practically attainable.

SNR Performance Analysis of the Recursive Scheme:

The received optical field sample is expressed as the signal plus noise:
{tilde under (r)}ₖ={tilde under (A)}ₖ+{tilde under (n)}ₖ

Taking the mean of eq. (52) for the reference, yields

$$〈 {{R}_{\sim}}_{k - 1} 〉 = κ ( \begin{matrix}{{A}_{\sim}}_{k - 1} + w {{\hat{s}}_{\sim}}_{k - 1} {{A}_{\sim}}_{k - 2} + {w}^{2} {{\hat{s}}_{\sim}}_{k - 1} {{\hat{s}}_{\sim}}_{k - 2} {{A}_{\sim}}_{k - 3} + \\ {w}^{3} {{\hat{s}}_{\sim}}_{k - 1} {{\hat{s}}_{\sim}}_{k - 2} {{\hat{s}}_{\sim}}_{k - 3} {{A}_{\sim}}_{k - 4} …\end{matrix} ) \\ = κ {{A}_{\sim}}_{k - 1} ( 1 + w + w + {w}^{3} … ) = κ {{A}_{\sim}}_{k - 1} \frac{1}{1 - w}$$

The reference may then be expressed as
{tilde under (R)}ₖ₋₁={tilde under (R)}ₖ₋₁+{tilde under (N)}ₖ₋₁
where the noise term in the reference is the sum of the individual noise contributions
{tilde under (N)}ₖ₋₁=κ({tilde under (n)}ₖ₋₁+w{tilde under (ŝₖ₋₁nₖ₋₂+w²{tilde under (ŝₖ₋₁{tilde under (ŝₖ₋₂nₖ₋₃+w³{tilde under (ŝₖ₋₁{tilde under (ŝₖ₋₂{tilde under (ŝₖ₋₃nₖ₋₄ . . . )

Introduce the variance of each received noise sample σₙ²≡ [symbol] |{tilde under (n)}ₖ|² [symbol] then the variance of the reference is expressed as

$$Var {{N}_{\sim}}_{k - 1} = 〈 {\vert {{N}_{\sim}}_{k - 1} \vert}^{2} 〉 = {κ}^{2} [ {σ}_{n}^{2} + ( {w}^{2} ) {{σ}_{n}^{2} ( {w}^{2} )}^{2} {σ}_{n}^{2} + {( {w}^{2} )}^{3} {σ}_{n}^{2} ... ] = \\ {κ}^{2} {σ}_{n}^{2} \frac{1}{1 - {w}^{2}}$$

Let A₀=|{tilde under (A)}ₖ| be the received amplitude for the constant envelope DPSK transmission.

The SNR of the reference may then be expressed as

$$SNR \{ {R}_{k - 1} \} = \frac{{\vert 〈 {{R}_{\sim}}_{k - 1} 〉 \vert}^{2}}{〈 \vert {{N}_{\sim}}_{k - 1} \vert 〉} = \frac{{\vert κ {A}_{k - 1} \frac{1}{1 - w} \vert}^{2}}{{κ}^{2} {σ}_{n}^{2} \frac{1}{1 - {w}^{2}}} = \frac{{A}_{0}^{2}}{{σ}_{n}^{2}} \frac{1 - {w}^{2}}{{( 1 - w )}^{2}} = \\ \frac{1 + w}{1 - w} SNR \{ {{r}_{\sim}}_{k - 1} \} \qquad ( 54 )$$

It is apparent that the recursive configuration has raised the SNR by a factor

$$\frac{1 + w}{1 - w} .$$

Considering the geometric relationships of FIG. 40, relating the phase-noise of the conventional reference {tilde under (r)}ₖ₋₁ (which is just the last received complex sample), vs. the improved reference {tilde under (R)}ₖ₋₁, it is apparent that the phase-noise may be expressed for relatively high SNR in both cases as the quadrature noise component over the length of the carrier:

$$∠ {{r}_{\sim}}_{k - 1} \approx \frac{{{n}_{\sim}}_{k - 1}^{im}}{\vert 〈 {{r}_{\sim}}_{k - 1} 〉 \vert} = \frac{{{n}_{\sim}}_{k - 1}^{im}}{{A}_{0}} , ∠ {{R}_{\sim}}_{k - 1} \approx \frac{{{N}_{\sim}}_{k - 1}^{im}}{\vert 〈 {{R}_{\sim}}_{k - 1} 〉 \vert}$$

The variance of the phase noise is the inverse of the SNR of the reference:

$$Var \{ ∠ {r}_{k - 1} \} \approx \frac{〈 {\vert {{n}_{\sim}}_{k - 1}^{im} \vert}^{2} 〉}{\vert 〈 {{r}_{\sim}}_{k - 1} 〉 \vert} = \frac{1}{SNR \{ {{r}_{\sim}}_{k - 1} \}} , \\ Var \{ ∠ {{R}_{\sim}}_{k - 1} \} \approx \frac{〈 {\vert {{N}_{\sim}}_{k - 1}^{im} \vert}^{2} 〉}{{\vert 〈 {{R}_{\sim}}_{k - 1} 〉 \vert}^{2}} = \frac{1}{SNR \{ {{R}_{\sim}}_{k - 1} \}}$$

For non-recursive D-chip DPSK, let us introduce d_{ref}, the reference reinforcement factor, defined as the mean value of the reference over the amplitude of the DPSK carrier:
d_{ref}≡|{tilde under (R)}ₖ₋₁|/A₀

For a conventional reference, {tilde under (r)}ₖ₋₁, we have d_{ref}=1, as | [symbol] {tilde under (r)}ₖ₋₁ [symbol] |=A₀.

For a non-recursive DF MC-DPSK system with a D-chip window, we have seen in eq. (23), repeated here, that

$$〈 {{R}_{\sim}}_{k - 1} 〉 = {\sum }_{m = 1}^{D - 1} {{A}_{\sim}}_{k - 1} = ( D - 1 ) {{A}_{\sim}}_{k - 1} .$$

Indeed all the chips except the current one, i.e. D−1 chips participate in forming the reference, and the application of rotation symbols gets them aligned collinearly to the reference, therefore in the non-recursive case
d_{ref}=D−1.

In the non-recursive case the phase noise quieting is derived as follows:

$$\frac{1}{SNR \{ {{R}_{\sim}}_{k - 1} \}} = 〈 {\vert ∠ {{R}_{\sim}}_{k - 1} \vert}^{2} 〉 \approx \frac{{d}_{ref} 〈 {\vert {{n}_{\sim}}_{k}^{im} \vert}^{2} 〉}{{( {d}_{ref} {A}_{0} )}^{2}} = \frac{{σ}_{n}^{2}}{{d}_{ref} {A}_{0}^{2}} = \frac{1}{{d}_{ref} \cdot SNR \{ {{r}_{\sim}}_{k - 1} \}} = \\ \frac{〈 {\vert ∠ {r}_{k - 1} \vert}^{2} 〉}{{d}_{ref}}$$

$$i . e . \\ {d}_{ref} = \frac{〈 {\vert ∠ {{r}_{\sim}}_{k - 1} \vert}^{2} 〉}{〈 {\vert ∠ {{R}_{\sim}}_{k - 1} \vert}^{2} 〉} = \frac{SNR \{ {{R}_{\sim}}_{k - 1} \}}{SNR \{ {{r}_{\sim}}_{k - 1} \}}$$

We then have a noise-quieting effect similar to that experienced in FM radio (where the length of the carrier, reduces the phase noise and hence the frequency noise). The noise quieting factor equals the reference reinforcement factor.

For the recursive scheme, we define an effective also in terms of the last equation.

The ratio of variances of the phase noises of the conventional and improved references is equal to the effective reference reinforcement factor. It follows from eq. (54) that for the recursive scheme we have

$${d}_{ref} = \frac{1 + w}{1 - w} ( recursive )$$

Compare this to
d_{ref}=D−1(non-recursive)

We may then define an effective number of chips for the recursive scheme (as the number of chips in a non-recursive scheme, attaining the same noise quieting factor).

From the last two equations it follows that

$${D}_{eff} = {d}_{ref} + 1 = \frac{1 + w}{1 - w} + 1 = \frac{2}{1 - w} \qquad ( 55 )$$

where w is the round-trip loss, expressed in terms of the ring optical parameters as in eq. (50), repeated here for convenience:
w=L\sqrt{1−κ′}\sqrt{1−κ′}=L(1−κ′)

Eq. (55) is plotted in FIG. 41, indicating that a high effective number of chips is attainable.

For high speed operation, e.g. 40 Gbps, the ring is very small (but not too small to radiate light out due to the bending) hence the loss L may be negligible, i.e. L≈1, yielding w≈1−κ′ or
D_{eff}≈2/κ′

This means that by decreasing the coupling into the ring we may achieve very high values of D_{eff}, in excess of 20, therefore this scheme operates very close to the coherent limit in which the noise of the reference (the local oscillator) tends to zero.

When the ring round trip loss L is not entirely negligible, we may still perform a proper design as follows:

κ′, the coupling coefficient into/out of the ring may be taken arbitrarily small

To attain a desired w, we must have L<w, e.g. w=0.92→L<0.7 dB, then design

$${κ}^{′} \leq 1 - \frac{w}{L}$$

### SIXTH FAMILY OF EMBODIMENTS

FIG. 41 depict aspects of the sixth exemplary embodiment according to the current invention.

Theory of Operation for the Sixth Family of Embodiments

In this family we combine all the decision feedback concepts disclosed in this invention for multi-chip DPSK, with the modulation format called DPASK (Differential Phase Amplitude Shift Keying), as reviewed in the prior art publication [16]. DPASK is a modulation format simultaneously combining DPSK and ASK (Amplitude Shift Keying).

A conventional DPASK optical transmitter 411 and transmission link 412 are shown in FIG. 41. Such systems apply DPSK modulator 411d and ASK modulator 411a in tandem, jumping every chip interval between M equi-spaced phase values (typically M=2,4) as well as independently selecting between two amplitude levels for each chip (chips are defined as the regularly spaced time-slots over which amplitude/phase stays constant).

The received optical signal 414 is split to feed two detection devices connected in parallel: a DPSK detector 415 and ASK detector 416. Optionally Optical Amplifier (OA) 418 and Optical Filter (OF) 419 are inserted in line with the signal input. The transmitted coded information Tr1 and Tr2 is thus recovered by the receiver.

The intuitive argument was advanced that the phase and amplitude modulations are able to coexist, as the phase-shift does not effect the amplitude detection, whereas the differential phase decoding, albeit degraded by the amplitude extinction, is still at work.

In this family of embodiments we replace the conventional DPSK receiver branch 415 by any of the DF DPSK receiver embodiments disclosed in this invention in the first to fifth families of embodiments.

The question arises whether the performance of the DPSK branch is degraded more or less relative to conventional DPSK. We submit that the process of constructing the reference by bringing the previous chip phasors in alignment with the last chip phasor, has a beneficial effect even in the wake of chips the amplitude of which varies due to the AM modulation. As discussed in [16] and references therein, the bottleneck of conventional DPASK performance is the transmission of the low-low amplitudes in tandem, as in this case the DPSK performance gets degraded. However, in our case we do not beat the current sample with the last one, but rather our reference is a superposition of the last sample and prior ones. Therefore, the probability of getting all the D−2 samples prior to the last one be in a “low” amplitude state is quite low, 2^{(D-2)}, therefore for D≧4 chips the prob. is ¼ or lower, i.e. we beat conventional DPASK. It is expected that the combination of Q-DPSK and two level ASK where the Q-DPSK detection is performed using any of the embodiments introduced above in this invention, should attain high performance relative to the trade-off between all three parameters of error-rate, transmission distance, capacity (bitrate).

It should be apparent that post processing electronics, for example such as disclosed in the background section; the references in the background section; and specifically ??? as disclosed in reference [8] and ??, may be used for further process output data from the detection system according to embodiments of the current invention. Such post processing may enhance the performance.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub combination.

Although the invention has been described in conjunction with specific embodiments thereof, it is evident that many alternatives, modifications and variations will be apparent to those skilled in the art.

Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A detector for detecting optical DPSK coded bitstream comprising:
at least a first optical interferometer interfering optical signal indicative of at least one detected bit with optical signal indicative of a preceding bit and generating electronic signal;
an electronic decision circuit receiving said electronic signal and determining a value of said at least one detected bit; and
a feedback circuit modifying said generated electronic signal in response to determined value of at least one bit preceding said detected bit.

2. The detector of claim 1 wherein said feedback circuit electronically modifies said generated electronic signal in response to determined value of at least one preceding detected bit.

3. The detector of claim 2 and further comprising at least second interferometer wherein said first and second interferometers interferes optical signals indicative of said at least one detected bit with light indicative of at least two different preceding bits.

4. The detector of claim 1 wherein said feedback circuit modifies said generated electronic signal by changing optical phase retardation in at least one arm of said first optical interferometer.

5. The detector of claim 4 wherein said optical interferometer comprises a controlled optical phase modulator receiving signal from said feedback circuit.

6. The detector of claim 5 wherein said interferometer interfering optical signals indicative of said at least one detected bit with light indicative of at least two different preceding bits.

7. The detector of claim 6 wherein said interferometer comprises:
at least three arms for interfering optical signals indicative of said at least one detected bit with light indicative of at least two different preceding bits; and
at least two controlled optical phase modulators, wherein said optical phase modulators are controlled in response to values of said at least two different preceding bits.

8. The detector of claim 5 wherein said optical interferometer comprises:
a first arm conducting optical signal indicative of said detected bit;
a second arm conducting optical signal indicative of optical signals of at least two different preceding bits;
a first controlled optical phase modulator receiving signal from said feedback circuit and modifying relative phase of optical signals between said first and second arms; and
a second controlled optical phase modulator receiving signal from said feedback circuit and modifying relative phase of optical signals of at least two different preceding bits.

9. The detector of claim 8 wherein said first and second controlled optical phase modulators are in said first and second arms respectively.

10. The detector of claim 8 wherein said first and second controlled optical phase modulators are in said second arm.

11. The detector of claim 5 comprising:
a first arm conducting optical signal indicative of said detected bit;
a second arm comprising a recursive delay line conducting optical signal indicative of bits preceding said detected bit.

12. The detector of claim 11 and further comprising:
a first controlled optical phase modulator receiving signal from said feedback circuit and modifying relative phase of optical signals between said first and second arms; and
a second controlled optical phase modulator receiving signal from said feedback circuit and modifying relative phase of optical signals of said bits preceding said detected bit.

13. The detector of claim 12 wherein said first and second controlled optical phase modulators are in said first and second arms respectively.

14. The detector of claim 13 wherein said first and second controlled optical phase modulators are in said second arm.

15. The detector of claim 11 and further comprising:
at controlled optical phase modulator receiving signal from said feedback circuit and modifying phase of optical signal in said recursive optical delay line.

16. A detection system for detecting optical DPASK coded bitstream comprising:
an ASK detector; and
a DPSK detector comprising:
at least a first optical interferometer interfering optical signal indicative of at least one detected bit and generating electronic signal;
an electronic decision circuit receiving said electronic signal and determining a value of said at least one detected bit; and
a feedback circuit modifying said generated electronic signal in response to determined value of at least one bit preceding said detected bit.

17. A method for detecting optical coded bitstream comprising
detecting optical DPSK coded bitstream comprising the steps of:
optically interfering signal indicative of at least one detected bit with optical signal indicative of a preceding bit, generating electronic signal indicative of said interference;
determining a value of said at least one detected bit based on said electronic signal; and
modifying said generated electronic signal in response to determined value of at least one bit preceding said detected bit.

18. The method of claim 17 wherein said step of modifying said generated electronic signal in response to determined value of at least one preceding detected bit is done electronically.

19. The method of claim 17 wherein said step of modifying said generated electronic signal in response to determined value of at least one preceding detected bit is done by modifying relative phase of said interfering optical signals.

20. The method of claim 17 and further comprising detecting ASK coded bitstream.
